(19) United States
(12) Patent Application Publication
(10) Pub. No.: US 2026/0072434 A1
(43) Pub. Date: Mar. 12, 2026

(54) System and Method for Joint Vehicle Positioning and Map Estimation using a Compound Probabilistic Filter

(71) Applicant: Mitsubishi Electric Research Laboratories, Inc., Cambridge, MA (US)

(72) Inventors: Karl Berntorp, Cambridge, MA (US); Marcus Greiff, Cambridge, MA (US); Stefano Di Cairano, Cambridge, MA (US); Pedro Miraldo, Cambridge, MA (US)

(21) Appl. No.: 18/188,760

(22) Filed: Mar. 23, 2023

(51) Int. Cl. G05D 1/246; G01S 19/39; G05D 1/248; G05D 1/644; G05D 109/20; G05D 111/10; G05D 111/67

(52) U.S. Cl. CPC G05D 1/246; G01S 19/393; G05D 1/248; G05D 1/644; G05D 2109/20; G05D 2111/10; G05D 2111/67

(57) ABSTRACT

The present disclosure discloses a system and a method for jointly controlling a vehicle and updating a map using multiple probabilistic filters. The method comprises collecting a sequence of measurements indicative of the state of the vehicle at different control steps. The method also comprises executing multiple probabilistic filters configured to jointly track a current state of the location of the vehicle represented by coordinates of the vehicle and a current state of the map represented by coefficients of a polynomial forming a spline fitting representation of the map. The method including determining the location of the vehicle based on a first weighted combination of current states of the location and updating the map based on a second weighted combination of current states of the map, such that the weights of the first weighted combination and the second weighted combination are different.

### TECHNICAL FIELD

This present disclosure relates generally to vehicle positioning and map update, and more particularly to a system and a method for joint vehicle localization and map estimation using a compound probabilistic filter.

### BACKGROUND

Various control methods use probabilistic filters to estimate a state of a device under control. A probabilistic filter, such as a Kalman filter, uses a series of measurements observed over time, including statistical noise and other inaccuracies, and produces estimates of unknown variables that tend to be more accurate than those based on a single measurement alone.

The probabilistic filters work by a two-phase process that includes a prediction phase and an update phase. For the prediction phase, the probabilistic filter produces estimates of current state variables, along with their uncertainties. To that end, the probabilistic filter employs a prediction model subject to process noise. An example of the prediction model is a motion model of the device under control. Further, an outcome of the next measurement (corrupted with some error, including random noise) is observed and the estimates of current state variables are updated using a weighted average of the measurements, with more weight being given to measurements with greater certainty. To that end, the probabilistic filter employs a measurement model subject to measurement noise. Both the process noise and the measurement noise can be represented by a probability density function (PDF) showing a likelihood of possible variations of the estimated state and/or the measurements.

Usually, the process noise and the measurement noise are predetermined to reflect understanding of an uncertainty of the motion model and reliability of the measurements. However, in several applications, it is impractical to predetermine the measurement noise. For example, in vehicle control applications where a vehicle is controlled based on a state of the vehicle tracked using measurements of a Global Navigation Satellite System (GNSS), the GNSS measurements have different reliabilities at different instances of time. For example, at different instances of time, different constellations of satellites can be in a line of sight of the GNSS receiver of the vehicle causing variations in the measurement noises. Additionally or alternatively, satellite signals can be subject to multipath adding significant noise to the GNSS measurements.

To that end, it is desired to adjust the measurement noise based on the state of the vehicle being tracked and control application. While it is possible to vary the measurement noise in the probabilistic filters, such as the Kalman filter, estimation of the measurement noise in real-time applications is computationally challenging and also can lead to divergence of the probabilistic filter. This challenge is in part due to difficulties in analysis of statistical properties of the measurements and assumptions underlying the operation of the probabilistic filter.

Further, in some application scenarios of vehicle tracking and control, such as in autonomous driving, a robust and high accuracy localization technology is required for accurate and reliable navigation. Typically, in any autonomous vehicle, many sensors are installed in the autonomous vehicle autonomous driving assistance and control functions, and main purpose of these sensors is object detection. However, these multiple sensors have not been leveraged sufficiently along with use of compound probabilistic filters, and therefore problems of data accuracy may persist.

Accordingly, there is a need for a system and a method for the autonomous driving systems, that can accommodate presence of multiple sensors and compound probabilistic filters for vehicle tracking and control related functions in autonomous driving applications.

### SUMMARY

Some embodiments are based on recognition that the multiple sensors associated with vehicles used in autonomous driving applications may be leveraged to extract feature data associated with one or more objects in an environment of the vehicle. The extracted feature data may be fused with Hardware Description Language (HDL) information of the objects to provide more accurate vehicle localization. To that end, some embodiments disclose systems and methods for vehicle localization and control by using multiple sensors installed in the vehicle.

Some embodiments are based on the realization that internal variables and/or calculations of a probabilistic filter, like a Kalman filter, can be used to evaluate the correctness of measurement noise. Specifically, a metric of evaluation of the correctness of the measurement noise can be a likelihood of the measurement noise to correlate a current measurement indicative of a state of a device with a state predicted by a prediction model of the probabilistic filter.

This correlation can be illustrated by the following example. A predicted state of the device, e.g., a predicted state of a vehicle, is transformed into a domain of measurements, e.g., in a GNSS measurement space. For example, such a transformation can be executed using a model of the measurements. Next, the measurement noise is centered on the transformed state to produce a probabilistic distribution of expected measurements. In case of Gaussian probabilistic distribution used by the probabilistic filter, a mean of the Gaussian probabilistic distribution of the expected measurements is determined by a state predicted by the Kalman filter and a variance is one of a predetermined measurement noises. When the measurements for updating the predicted state are received, the measurements can be mapped on the probabilistic distribution of the expected measurements to estimate the sought likelihood of the correlation.

In such a manner, the measurement noise is evaluated using internal variables and/or calculations of the probabilistic filter without a need for additional statistical analysis of the measurements outside of the performance of the probabilistic filter. It shall be noted that the abovementioned example not only illustrates principles of correlation between state estimation and the measurements but can also be used to implement the estimation of this correlation. However, different embodiments can use different techniques to evaluate this correlation. For example, some embodiments use an evaluation of Kalman gains determined by the Kalman filter to update the predicted state and a covariance of the predicted state, which for an unbiased estimator is a mean-square error (MSE). Such calculations are internal to the probabilistic filters, i.e., computed anyway to track the state of the device. Hence, calculations of these variables do not require additional resources.

However, some embodiments are based on the realization that while the usage of the internal variables and/or calculations of the probabilistic filter can reduce the computational requirements for the evaluation of the correctness of the selected measurement noise, the evaluation itself becomes corrupted by internal performance of the probabilistic filter. In other words, the correctness of the measurement noise is not necessarily the true correctness reflecting the measurements independent of the Kalman filter, but the correctness from the point of view of the probabilistic filter itself. To that end, it may be problematic to use this evaluation to adapt the measurement noise, but rather to use this evaluation to evaluate the performance of the probabilistic filter with the selected measurement noise.

To address this problem, some embodiments use multiple probabilistic filters with different measurements noises and determine the state of the device as a weighted combination of the states estimated by different filters with weights of each filter derived from the corresponding evaluation of the likelihood of the measurement noise to correlate the current measurement indicative of the state of the device with the state predicted by a prediction model of the probabilistic filter. In such a manner, different measurement noises can be considered without a need to analyze the statistical properties of the measurements.

Some embodiments are based on the realization that current methods of tracking a state of a vehicle based on satellite signals received from a global navigation satellite system (GNSS) are sensitive to satellite measurements being of high qualitative because otherwise, the tracking method cannot produce high-accuracy estimates. Other embodiments are based on the recognition that there is a necessity to combine various sensors to improve state tracking. The various sensors complement each other because such a combination is more likely to produce sensible estimates in a larger variety of conditions. For example, one embodiment combines a GNSS position measurement with a camera relative position measurement and a map of the road to track the state of the vehicle. Another embodiment combines a camera measuring a relative position of vehicles neighboring the own vehicle and a lidar measurement measuring the relative position of vehicles neighboring the own vehicle because such measurements complement each other due to the difference in construction of the camera and lidar, respectively.

Some embodiments utilize the probabilistic filter to fuse measurements and generate a state estimate. The probabilistic filters need a probabilistic description of the measurements, a measurement model. To this end, some embodiments recognize that measurement noise characteristics need to be determined for the measurement model to be used in the probabilistic filter. Some embodiments are based on the understanding that to use the probabilistic measurement model in a measurement update, an accuracy of the sensor measurements needs to be determined concurrently with the tracking of the state of the vehicle because the tracking is performed in real-time and the measurement model, therefore, may not be set before executing the recursive probabilistic filter. Some embodiments exploit this understanding to adapt the measurement noise used in the probabilistic measurement model as sensor measurements arrive at the compound probabilistic filter.

To that end, some embodiments jointly estimate the state of the vehicle and the measurement noise of the different sensors to determine the measurement noise that best describes the state of the vehicle according to the measurements. For example, one embodiment associates a first noise value with a first sensor and a second noise value with a first sensor, and additionally associates a first noise value with a second sensor and a second noise value with a second sensor and executes multiple probabilistic filters for each combination of noise values and sensors to determine which one of them best describes the state of the vehicle. In other embodiments, the multiple probabilistic filters are unified into a compound probabilistic filter that weighs together the multiple probabilistic filters as a weighted combination of the multiple filters.

Some embodiments are based on the understanding that if a probabilistic filter using a particular combination of noise values for various sensors gave the best fit at a previous time step, it is likely to also produce a good fit for the next time step. For example, if a GNSS position measurement was unreliable in a previous time step due to, e.g., multipath in an urban environment, it is likely to be prone to multipath also in the next time step. However, it also has a chance of producing a reliable measurement if the unreliability of the measurement is not an effect of multipath but due to some other unmodeled disturbance. Some embodiments use this understanding to integrate and weight the multiple probabilistic filters at each time step of control such that the probabilistic filters are given different weightings based on their weights at previous time steps.

Some embodiments are based on the understanding that the computational complexity of the multiple probabilistic filters grows unfavorably with a number of hypotheses of noise values and the number of sensors. For instance, one embodiment understands that using different possible noise values can be interpreted as gridding of a continuous space of possible noise values such that there is an exponential complexity in the number of possible combinations of noise values and therefore the number of probabilistic filters employed in the estimation.

Some embodiments realize that in automotive applications the computational power of automotive-grade electronic control units is limited and using a large number of probabilistic filters is not computationally feasible. One embodiment remedies this by selecting a subset of the probabilistic filters to be used in the estimation. For instance, one embodiment selects probabilistic filters corresponding to values of noise levels close to those that were well represented the state at the previous time step. Doing in such a manner enables the subset of probabilistic filters chosen at each time step to follow the evolution of the sensor quality.

Accordingly, one embodiment discloses a system for joint localization of a vehicle moving in an environment and estimation of a map of the environment by fusing measurements of different sensors including measurements of a Global Navigation Satellite System (GNSS) indicative of a location of the vehicle with respect to GNSS satellites and measurements of a camera indicative of a location of the vehicle with respect to the map of the environment. The system includes at least one processor, and at least one memory having instructions stored thereon that, when executed by the at least one processor, causes the system to: collect a sequence of measurements including the GNSS measurements and the camera measurements indicative of locations of the vehicle at different control steps. The system is further caused to execute a plurality of probabilistic filters parameterized on a state of a location of the vehicle and a state of the map, wherein each of the probabilistic filters is configured to jointly track a current state of the location of the vehicle represented by coordinates of the vehicle and a current state of the map represented by coefficients of polynomials forming a spline fitting representation of the map using a prediction model subject to prediction noise and a measurement model fusing the GNSS measurements subject to GNSS measurement noise and the camera measurements subject to camera measurement noise, wherein different probabilistic filters use different GNSS measurement noises, different camera measurement noises, or both. The system is further caused to determine the location of the vehicle based on a first weighted combination of the current states of the location tracked by the plurality of probabilistic filters. Additionally, the system is caused to update the map of the environment based on a second weighted combination of the current states of the map tracked by the plurality of probabilistic filters, wherein weights of the first weighted combination differ from weights of the second weighted combination.

Accordingly, another embodiment discloses a method for joint localization of a vehicle moving in an environment and estimation of a map of the environment by fusing measurements of different sensors including measurements of a Global Navigation Satellite System (GNSS) indicative of a location of the vehicle with respect to GNSS satellites and measurements of a camera indicative of a location of the vehicle with respect to the map of the environment. The method comprising collecting a sequence of measurements including the GNSS measurements and the camera measurements indicative of locations of the vehicle at different control steps. The method further comprising executing a plurality of probabilistic filters parameterized on a state of a location of the vehicle and a state of the map, wherein each of the probabilistic filters is configured to jointly track a current state of the location of the vehicle represented by coordinates of the vehicle and a current state of the map represented by coefficients of polynomial forming a spline fitting representation of the map using a prediction model subject to prediction noise and a measurement model fusing the GNSS measurements subject to GNSS measurement noise and the camera measurements subject to camera measurement noise, wherein different probabilistic filters use different GNSS measurement noises, different camera measurement noises, or both. The method further comprising determining the location of the vehicle based on a first weighted combination of the current states of the location tracked by the plurality of probabilistic filters. The method further comprising updating the map of the environment based on a second weighted combination of the current states of the map tracked by the plurality of probabilistic filters, wherein weights of the first weighted combination differ from weights of the second weighted combination.

Accordingly, yet another embodiment discloses non-transitory computer-readable storage medium embodied thereon a program executable by a processor for performing a method for joint localization of a vehicle moving in an environment and estimation of a map of the environment by fusing measurements of different sensors including measurements of a Global Navigation Satellite System (GNSS) indicative of a location of the vehicle with respect to GNSS satellites and measurements of a camera indicative of a location of the vehicle with respect to the map of the environment. The method comprising collecting a sequence of measurements including the GNSS measurements and the camera measurements indicative of locations of the vehicle at different control steps. The method further comprising executing a plurality of probabilistic filters parameterized on a state of a location of the vehicle and a state of the map, wherein each of the probabilistic filters is configured to jointly track a current state of the location of the vehicle represented by coordinates of the vehicle and a current state of the map represented by coefficients of polynomial forming a spline fitting representation of the map using a prediction model subject to prediction noise and a measurement model fusing the GNSS measurements subject to GNSS measurement noise and the camera measurements subject to camera measurement noise, wherein different probabilistic filters use different GNSS measurement noises, different camera measurement noises, or both. The method further comprising determining the location of the vehicle based on a first weighted combination of the current states of the location tracked by the plurality of probabilistic filters. The method further comprising updating the map of the environment based on a second weighted combination of the current states of the map tracked by the plurality of probabilistic filters, wherein weights of the first weighted combination differ from weights of the second weighted combination.

Accordingly, some embodiments disclose a controller for controlling a movement of a vehicle based on joint localization of the vehicle moving in an environment and estimation of a map of the environment by fusing measurements of different sensors including measurements of a Global Navigation Satellite System (GNSS) indicative of a location of the vehicle with respect to GNSS satellites and measurements of a camera indicative of a location of the vehicle with respect to the map of the environment. The controller comprising at least one processor and at least one memory having instructions stored thereon that, when executed by the at least one processor, causes the controller to: collect a sequence of measurements including the GNSS measurements and the camera measurements indicative of locations of the vehicle at different control steps; execute a plurality of probabilistic filters parameterized on a state of a location of the vehicle and a state of the map, wherein each of the probabilistic filters is configured to jointly track a current state of the location of the vehicle represented by coordinates of the vehicle and a current state of the map represented by coefficients of polynomial forming a spline fitting representation of the map using a prediction model subject to prediction noise and a measurement model fusing the GNSS measurements subject to GNSS measurement noise and the camera measurements subject to camera measurement noise, wherein different probabilistic filters use different GNSS measurement noises, different camera measurement noises, or both; determine the location of the vehicle based on a first weighted combination of the current states of the location tracked by the plurality of probabilistic filters; and update the map of the environment based on a second weighted combination of the current states of the map tracked by the plurality of probabilistic filters, wherein weights of the first weighted combination differ from weights of the second weighted combination.

### BRIEF DESCRIPTION OF THE DRAWINGS

The presently disclosed embodiments will be further explained with reference to the attached drawings. The drawings shown are not necessarily to scale, with emphasis instead generally being placed upon illustrating the principles of the presently disclosed embodiments.

FIG. 1A illustrates a block diagram of system for controlling a movement of a vehicle, according to an embodiment of the present disclosure.

FIG. 1B illustrates the system configured for fusing information from the different sensors, according to some embodiments of the present disclosure.

FIG. 1C illustrates an exemplar sensor suite used to localize a vehicle and estimate a map of an environment, according to some embodiments of the present disclosure.

FIG. 1D illustrates an exemplar scenario of operation of the system of FIG. 1A, according to some embodiments of the present disclosure.

FIG. 1E illustrates a schematic diagram of representation of a map, according to some embodiments of the present disclosure.

FIG. 1F illustrates a schematic diagram of a polynomial for a spline representation of a map, according to some embodiments of the present disclosure.

FIG. 1G illustrates a schematic diagram of continuous spline representation of a map, according to some embodiments of the present disclosure.

FIG. 1H illustrates an exemplar scenario of operation of the system of FIG. 1A, according to some embodiments of the present disclosure.

FIG. 1I illustrates another exemplar scenario of operation of the system of FIG. 1A, according to some embodiments of the present disclosure.

FIG. 2A illustrates a general flowchart of a probabilistic fusion mechanism, according to some embodiments of the present disclosure.

FIG. 2B illustrates schematic diagram of different hypothesis distributions, according to some embodiments of the present disclosure.

FIG. 3A illustrates an example of a distribution, according to some embodiments of the present disclosure.

FIG. 3B illustrates a process of determining the correction of a state using a measurement, according to some embodiments of the present disclosure.

FIG. 3C illustrates Gaussian distributions with different variances, according to some embodiments of the present disclosure.

FIG. 3D illustrates a schematic for updating a joint distribution the state of the vehicle and the state of the map, according to some embodiments of the present disclosure.

FIG. 3E illustrates a schematic of parametrization of a spline enforcing continuity implicitly, according to an embodiment of the present disclosure.

FIG. 4A illustrates a block diagram of a system for joint localization of a vehicle moving in an environment and estimation of a map, according to an embodiment of the present disclosure.

FIG. 4B illustrates a schematic of a method executed by the localization system, according to some embodiments of the present disclosure.

FIG. 4C and FIG. 4D collectively illustrate an exemplar evaluation of the correctness of the measurement noise, according to some embodiments of the present disclosure.

FIG. 4E and FIG. 4F collectively illustrates exemplar state transformation scenarios, according to some embodiments of the present disclosure.

FIG. 4G illustrates a schematic showing weighting mechanisms, according to some embodiments of the present disclosure.

FIG. 5A illustrates a schematic of a GNSS, according to some embodiments of the present disclosure.

FIG. 5B illustrates a scenario where multipath disturbs the signals for a GNSS receiver, according to some embodiments of the present disclosure.

FIG. 6A illustrates a block diagram of a method for estimating the state of the vehicle and the state of the map, according to some embodiments of the present disclosure.

FIG. 6B illustrates a block diagram of functions executed by the compound probabilistic filter in an iteration, according to some embodiments of the present disclosure.

FIG. 6C illustrates a block diagram of a process for producing a weighted combination, according to some embodiments of the present disclosure.

FIG. 6D illustrates a block diagram of a process for producing the weighted combination, according to an alternate embodiment of the present disclosure.

FIG. 6E illustrates a schematic for determining the weighted combination using stored historic weights, according to some embodiments of the present disclosure.

FIG. 6F illustrates a flowchart of a method for determining a spline representing the map, according to some embodiments of the present disclosure.

FIG. 6G illustrates a flowchart of a method for determining the spline parameters according some embodiments of the present disclosure.

FIG. 7A illustrates a schematic for estimating the state of the vehicle and the state of the map jointly, according to some embodiments of the present disclosure.

FIG. 7B illustrates different sensor measurements collected according to various embodiments of the present disclosure.

FIG. 7C illustrates a schematic showing comparison of an estimated measurement with a collected measurement, according to some embodiments of the present disclosure.

FIG. 7D illustrates process of how different estimations of the probabilistic filters are assigned different weights and forms a compound distribution, according to various embodiments of the present disclosure.

FIG. 7E illustrates a process of how different sensors get different weighting and are defined on different measurement spaces, according to various embodiments of the present disclosure.

FIG. 7F illustrates a process of how measurements defined on different measurement spaces are transformed to the same measurement space for comparing each other, according to various embodiments of the present disclosure.

FIG. 8 illustrates a block diagram of a method for controlling a vehicle based on an estimated joint state, according to various embodiments of the present disclosure.

FIG. 9A illustrates a motion model employed in the compound probabilistic filter, according to some embodiments of the present disclosure.

FIG. 9B illustrates a scenario of modeling of camera measurements, according to some embodiments of the present disclosure.

FIG. 9C illustrates a scenario for sample the polynomial function, according to some embodiments of the present disclosure.

FIG. 10 illustrates a block diagram of a controller for controlling the movement of a vehicle based on a joint state tracked using the GNSS and camera measurements, according to some embodiments of the present disclosure.

FIG. 11A illustrates a schematic of the vehicle including the controller, according to some embodiments of the present disclosure.

FIG. 11B illustrates a schematic of interaction between the controller of FIG. 11A and controllers of the vehicle, according to some embodiments of the present disclosure.

FIG. 12A illustrates a traffic scenario illustrating a scenario, according to some embodiments of the present disclosure.

FIG. 12B and FIG. 12C collectively illustrate a scenario of a remote server for tracking a map, according to some embodiments of the present disclosure.

FIG. 12D illustrates a use case related to synchronization message exchange, according to some embodiments of the present disclosure.

FIG. 13 illustrates an example of a vehicle-to-vehicle (V2V) communication and planning based on state estimation according to one embodiment.

FIG. 14 illustrates a schematic of a multi-vehicle platoon shaping for accident-avoidance scenario according to one embodiment.

FIG. 15A and FIG. 15B collectively illustrate a use case of an unmanned aerial vehicle (UAV) control using the system of FIG. 1A, according to some embodiments of the present disclosure.

FIG. 16 illustrates a block diagram of a system for direct and indirect control of mixed-autonomy vehicles, in accordance with some embodiments of the present disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatuses and methods are shown in block diagram form only in order to avoid obscuring the present disclosure.

As used in this specification and claims, the terms “for example,” “for instance,” and “such as,” and the verbs “comprising,” “having,” “including,” and their other verb forms, when used in conjunction with a listing of one or more components or other items, are each to be construed as open ended, meaning that the listing is not to be considered as excluding other, additional components or items. The term “based on” means at least partially based on. Further, it is to be understood that the phraseology and terminology employed herein are for the purpose of the description and should not be regarded as limiting. Any heading utilized within this description is for convenience only and has no legal or limiting effect.

It is the object of some embodiments to provide a system and method for joint localization of a vehicle moving in an environment and estimation of a map of the environment by fusing measurements of different sensors having measurements indicative of a state of a vehicle and a state of the map of the environment of the vehicle. Herein, a state of a vehicle includes a position and heading of said vehicle. Additionally, a state can include a velocity and a heading rate of a vehicle. A state of a map of the environment includes parameters parametrizing the map of the environment.

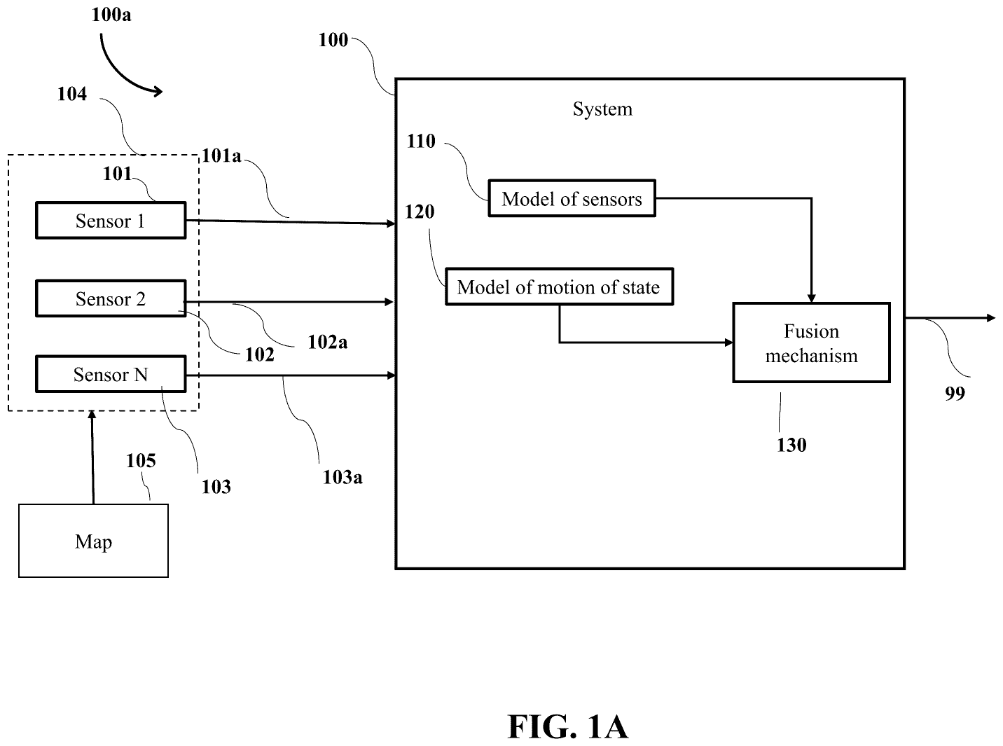

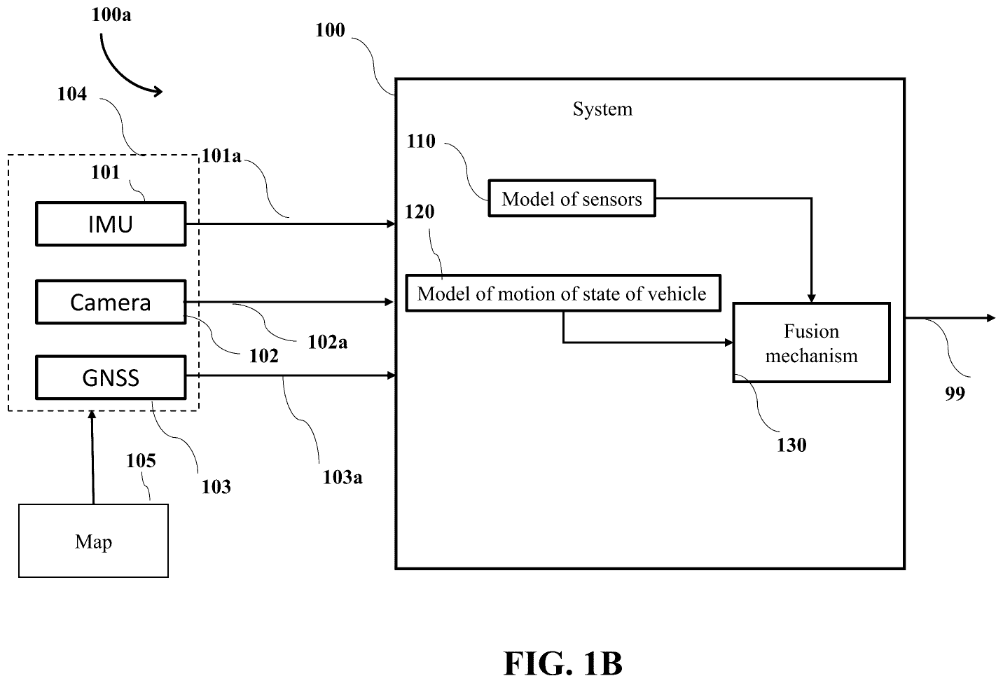

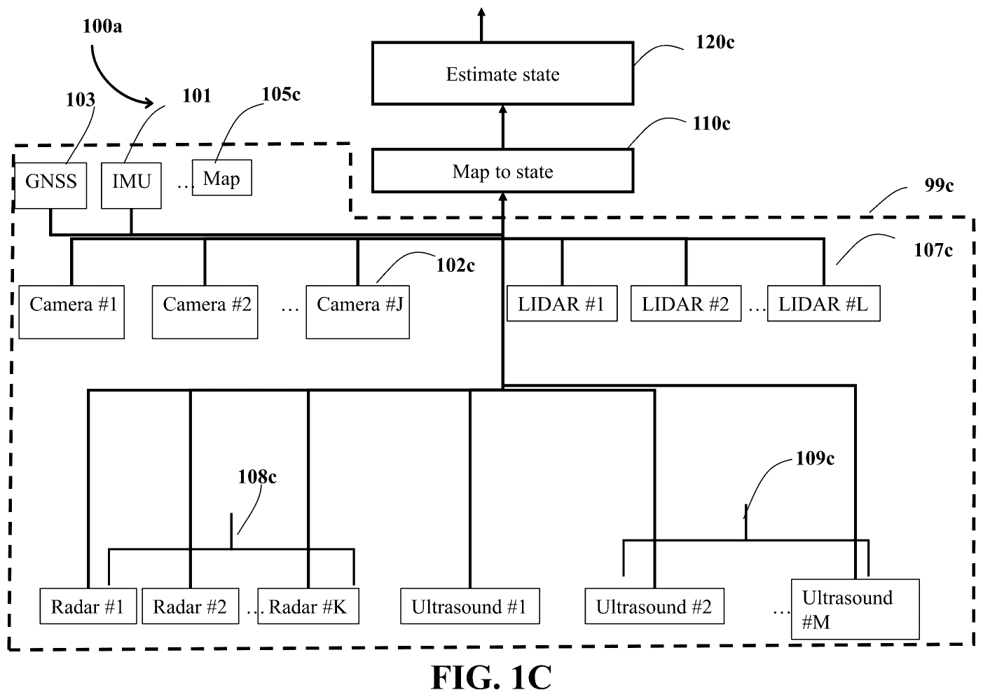

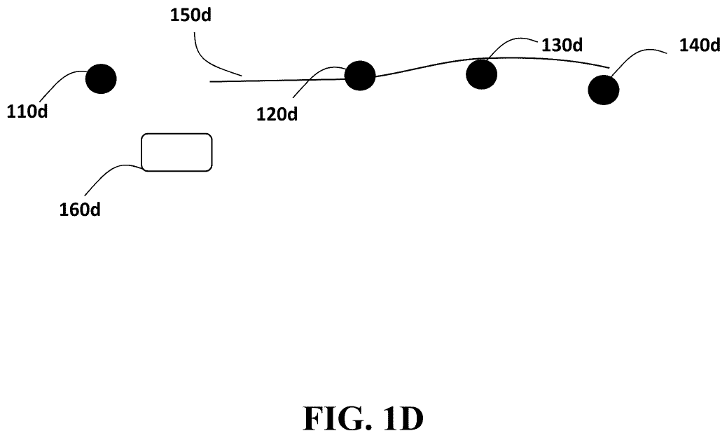

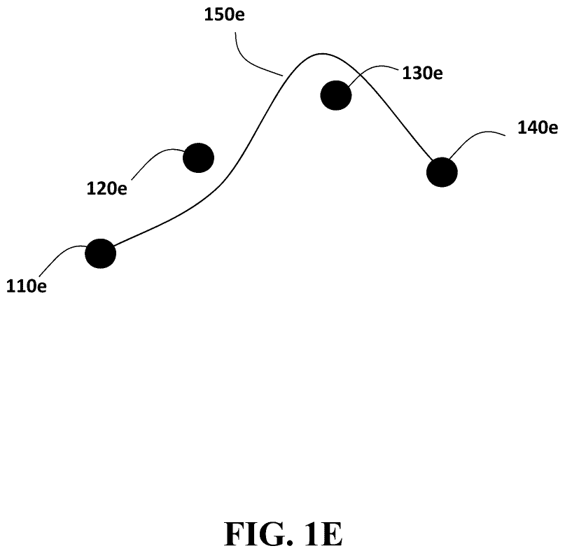

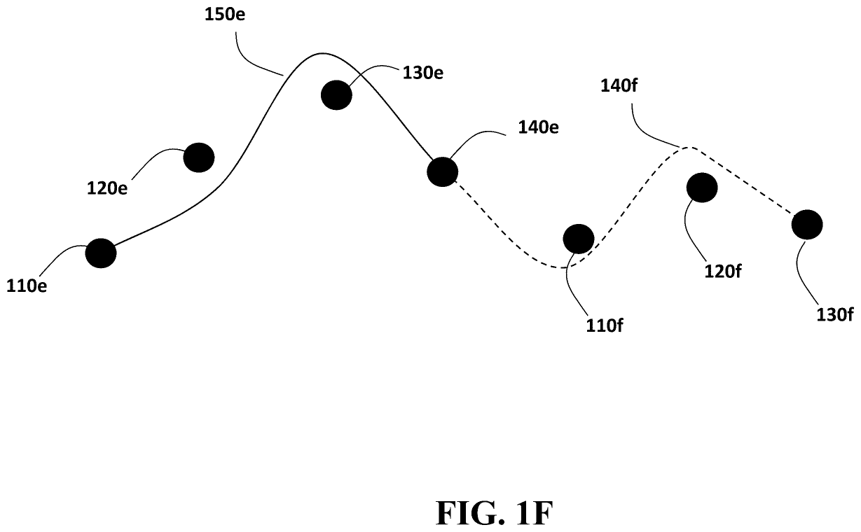

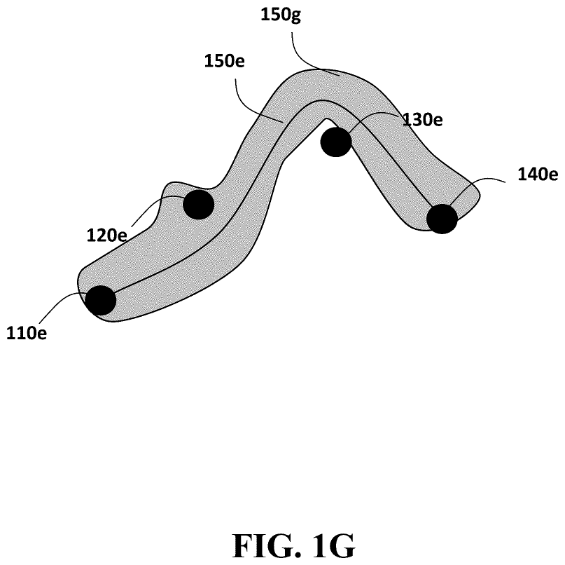

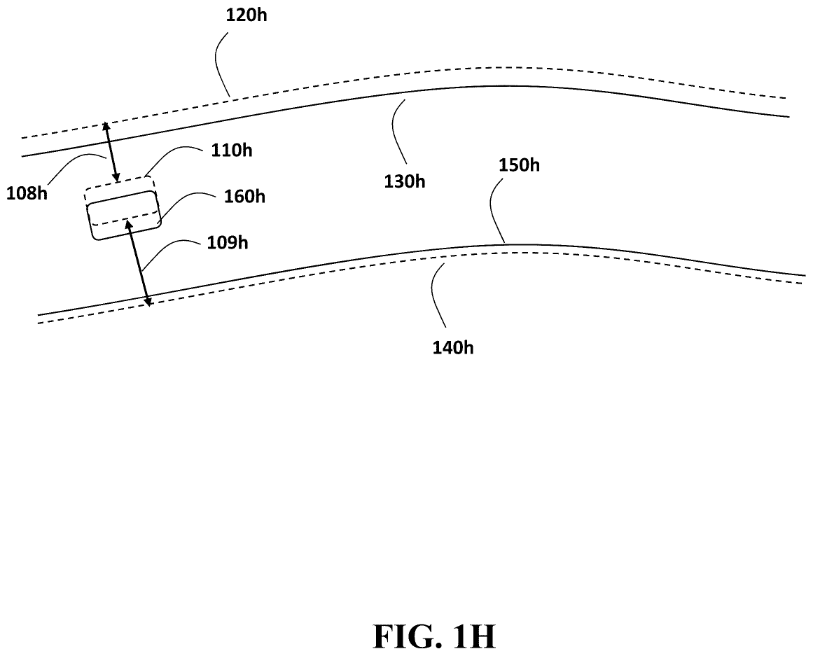

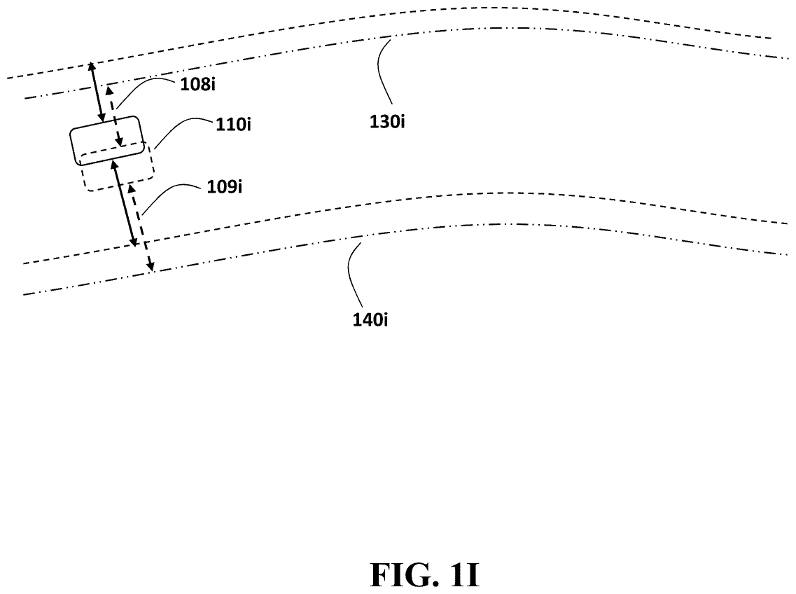

To this end, FIG. 1A illustrates a general schematic of a system 100 according to some embodiments. As used herein, the system 100 together with information from different sensors—a sensor 101, a sensor 102 and a sensor 103 (herein after collectively referred to as sensors 101-103) to provide an estimate 99 of a state implicitly or explicitly measured by the sensors 101-103. For example, the system 100 receives information, such as information 101a from the sensor 101, information 102a from the sensor 102, and information 103a from the sensor 103. By using a model 110 of the sensors 101-103, for example, a probabilistic model or a deterministic model, and potentially additionally a model 120 of the motion of the state measured implicitly or explicitly of the sensors 101-103, a fusion mechanism 130 merges the information (herein after collectively referred to as information 101a-103a) to produce the state estimate 99. The state estimate 99 generated by the fusion mechanism 130 of the system 100 configures the system 100 to perform joint localization of a device 104 associated with the different sensors 101-103.

In an example, the device 104 is a vehicle moving in an environment 100a which is represented by a map 105 (hereinafter, the device 104 is referred to as the vehicle for brevity of explanation). The information of 101a-103a of the different sensors 101-103 is represented by measurements, including measurements of a Global Navigation Satellite System (GNSS) indicative of a location of the vehicle 104 with respect to the GNSS. Additionally, at least one of the sensors 101-103 is a camera, and the information 101a-103a from the sensors includes measurements of the camera indicative of a location of the vehicle 104 with respect to the map 105 of the environment 100a.

The system 100 may be a computing system, a navigation unit, an advanced driver assistance system (ADAS), an autonomous navigation unit, and the like. To that end, the system 100 includes at least one processor and at least one memory having instructions stored thereon that, when executed by the at least one processor, causes the system to perform functions related to perform joint localization of the vehicle 104 and update of the map 105. The functions include collecting a sequence of measurements including the GNSS measurements and the camera measurements. The sequence of measurement are thus represented as the information 101a-103a from the sensors and are indicative of locations of the vehicle 104 at different control steps of the system 100.

The functions further include execute a plurality of probabilistic filters by the fusion mechanism 130. The plurality of probabilistic filters are parameterized on a state of a location of the vehicle provided by the model of motion of state 120, and a state of the map 105 provided by the model of sensors 110. In operation, each of the probabilistic filters of the fusion mechanism 130 is configured to jointly track a current state of the location of the vehicle 104 represented by coordinates of the vehicle and a current state of the map 105 represented by coefficients of polynomial forming a spline fitting representation of the map 105 using a prediction model subject to prediction noise and a measurement model fusing the GNSS measurements subject to GNSS measurement noise and the camera measurements subject to camera measurement noise. The different probabilistic filters use different GNSS measurement noises, different camera measurement noises, or both, in an example.

The system 100 is further configured to perform the functions to determine the location of the vehicle 104 based on a first weighted combination of the current states of the location tracked by the plurality of probabilistic filters. Also, the system 100 is further configured to perform the functions to update the map 105 of the environment 100a based on a second weighted combination of the current states of the map 105 tracked by the plurality of probabilistic filters. To that end, weights of the first weighted combination differ from weights of the second weighted combination.

Some embodiments are based on recognition that because there are different types of uncertainties involved in the estimation, e.g., the estimation uncertainty of the state of the vehicle 104, the uncertainty of the state of the map 105, and the uncertainty of the measurements 101a-103a. Some embodiments are based on realization that the different types of uncertainties can be expressed as probabilistic, e.g., as a Gaussian distribution of an uncertainty of a measurement. Other embodiments are based on the realization that for a successful joint estimation of a state of the vehicle 104 and a state of the map 105, the different uncertainties need to be identified as separate quantities and not merged as a joint uncertainty. For example, the fusion mechanism 130 needs to assign uncertainties to the estimation of the state of the vehicle 104 and uncertainties of the state of the map 105, as well as determine what measurements cause what level of uncertainty. That is, the fusion mechanism 130 needs to separate uncertainties from different sensors 101-103 in order to determine separate uncertainties of the state of the vehicle 104 and the state of the map 105. To this end, some embodiments use a probabilistic fusion as the fusion mechanism 130 for disambiguating uncertainties of the different sensors 101-103 in order to effectuate the system 100 to perform its functions. The functions as already discussed, include jointly estimating the vehicle state and the map parameters to consider possibilities of either the map 105 or the vehicle state, or both being estimated with errors.

The functions of the system 100 will be further described in various embodiments discussed below.

FIG. 1B illustrates the system 100 configured for fusing information 101a-103a from the different sensors 101-103. In an embodiment of the disclosure, of the different sensors 101-103, the included sensor 101 is an inertial measurement unit (IMU) (hereinafter referred to as the IMU 101) outputting the acceleration and rotation rates as the information 101a from the IMU 101, the sensor 102 is a camera 102 (hereinafter referred to as the camera 102) outputting pixels of an image as the information or the camera measurements 102a from the camera 102, and the sensor 103 is a global navigation satellite system (GNSS) receiver (hereinafter referred to as the GNSS receiver 103) for example, using GPS, outputting GNSS measurements corresponding to the position of the receiver as the information 103a or GNSS measurements 103a from the GNSS 103. The sensors 101-103 are attached to the vehicle 104 in an example.

Additionally, the IMU 101 can also output the magnetic field. As an exemplar mounting, the IMU 101 can be mounted inside the vehicle 104 and the IMU 101 therefore measures the information 101a regarding the acceleration and rotation rate of the vehicle 104. Likewise, the camera 102 can be mounted on the front of the vehicle 104 and connected to the at least one processor of the system 100 executing instructions for identifying objects on a road in front of the vehicle 104. For instance, the camera 102 can output the coordinates or a polynomial representation of the lane markings in front of the vehicle 104. The GNSS receiver 103 receives code and carrier phase measurements from several satellites using one or several satellite constellations, for example, GPS, GALILEO, and QZS, and determines the position of the GNSS receiver 103. For example, having the GNSS receiver 103 mounted inside the vehicle 104, the GNSS receiver 103 effectively measures the position of the vehicle 104.

FIG. 1C illustrates an exemplar sensor suite 99c used to localize a vehicle and estimate a map of the environment 100a. For example, the sensor suite 99c can include several cameras 102c mounted on different places of the vehicle, it can include one or several lidars 107c or radars 108c determining point clouds of the environment 100a, and the IMU 101. Using radar or lidar in combination with camera 102 is beneficial since they are complementary. For instance, both radar and camera give measurements of the environment 100a indicative of the vehicle's location relative to the environment 100a, but they are susceptible to different error sources. As a further compliment, the sensor suite 99c can include ultrasound sensors 109c, which adds yet an alternative way to measure objects in the environment that can be used for localization.

Some embodiments leverage a prior map 105c stored in memory and used as an additional source of information that can be used for localization. For instance, by having the camera 102 measuring a lane marker of a road that is included in the map representation, the camera 102 can give global positioning information to complement the GNSS 103.

Using the information from the sensor suite 99c, and the model 110 of the sensor information, the fusion mechanism 130 maps 110c the sensor information 101a-103a to the state and estimates 120c the state according to principles described by other embodiments of this disclosure.

Some embodiments use a map of the environment 100a including lane markings of one or several lanes on a road, wherein the map has been constructed using a mobile mapping system (MMS). In some embodiments, the MMS is stored in a memory represented as discrete points. Other embodiments understand that as a vehicle moves on a road and a camera measures the lane markings of a road, the discrete points determined by the MMS may not well represent the camera measurements when using the camera to jointly localize the vehicle and align with the map.

To illustrate, FIG. 1D illustrates a scenario where a vehicle 160d drives close to a lane edge represented by lane markers. The map 105 is represented by points 110d-140d. A camera mounted on the vehicle 160d is equipped with a computer-vision (CV) algorithm for determining a polynomial representation 150d of the lane markings detected by the CV algorithm. The vehicle 160d is located between two points of the map 105 such that the polynomial representation 150d is initialized between two points 110d and 120d. Hence, it is difficult to understand how to compare the camera measurement of the polynomial representation 150d with the map 105 to localize the vehicle 160d.

Some embodiments recognize that to use the map 105 in the update, a continuous representation is advantageous. FIG. 1E shows an illustration of how to represent the map 105 according to some embodiments. Specifically, a continuous map representation 150e is constructed by fitting polynomials as a spline representation 150e to the map points 110e, 120e, 130e, and 140e from the MMS. A spline is a set of piecewise polynomials defined by control points. For instance, the points 110e through 140e can be the control points and the spline can be fitted to best represent a polynomial defined by such points to give the spline representation 150e.

In some embodiments the state to be estimated is the state of the vehicle 104 and the state of the map 105, wherein the state of the map 105 includes the coefficients of the one or several polynomials forming one or several splines. Using a spline representation enables to sample points from the spline that can arbitrary well align with the camera measurements and thus gives a straightforward way to compare various measurements, e.g., camera measurements, GNSS measurements, and the map.

A spline consists of a set of polynomials that are connected. Because the representation of a map is continuous, e.g., the lane markings of a lane of a road are continuous, the polynomials included in the spline are enforced continuity, either implicitly or explicitly.

FIG. 1F shows an illustration where a polynomial 150e is defined by the points 110e through 140e, and another polynomial 140f is defined by the points 140e, 110f, 120f, and 130f. Some embodiments enforce continuity in the spatial location at the endpoint 140e of polynomial 150e and start point 140e of polynomial 140f. Other embodiments enforce continuity also along the velocity of the along the spline, wherein the parametrization to accomplish such continuity is described by other embodiments of the disclosure.

In one embodiment, the map from the MMS is outputted recursively as the vehicle traverses a road. For instance, the map points are outputted for a given horizon around the vehicle 104 with a fixed output rate. To this end, the discrete points are given in batches recursively, whereby continuity between splines are enforced similarly as between polynomials within a spline, as described by other embodiments of the disclosure.

Some embodiments are based on the understanding that the map 105, or the representation of the map 105, may be uncertain, because of several reasons.

For instance, an MMS maps the roads using high-cost sensors such as high-performance camera and lidar. However, even with such high-cost sensors there are inevitable imperfections that cause a certain loss of precision that incurs an uncertainty of the actual map location in world coordinates.

For instance, an MMS maps the streets in cities with a certain update rate, e.g., weeks or months. However, between such mapping instances there may have been changes to the roads that are not captured in the streets, e.g., due to resurfaced roads leading to new lane markings ending up in slightly different locations or temporary road constructions leading to changed lanes or rerouted streets.

FIG. 1G illustrates a situation where the map points 110e through 140e have been transformed to a continuous spline representation 150e according to some embodiments. Because of previously mentioned imperfections, some embodiments transfer the uncertainty of the map 105 to an uncertainty of the continuous spline representation 150e, leading to an uncertainty distribution 150g. In some embodiments, such uncertainty distribution 150g is used to balance the map update with the vehicle position update.

FIG. 1H shows an illustration of a scenario where a vehicle 110h travels on a road with lane markings 120h and 140h. However, the map stored in memory indicates that the lane markings are located at positions 130h and 150h, which are different from 120h and 140h. The camera measures the distance 108h and 109h to the lane markings 120h and 140h. However, as the map stored in memory differs from the true map, the camera measurements 108h and 109h corresponds to that the vehicle 110h is located at a different place 160h. Correspondingly, if the map update is trusted as a ground truth, the estimated vehicle position will be wrong.

FIG. 1I shows an illustration of a scenario where the same vehicle, 110h in FIG. 1H, travels on the same road. In this scenario the estimated position 110i is different from the true position. Consequently, with the measurements 108h and 109h, because the estimation believes the vehicle is located at 110i, the measurements 108h and 109h are interpreted as being 108i and 109i, measured between the vehicle position 110i and lane markings 130i and 140i. Consequently, if the map is to be updated, it will lead to the map being erroneously estimated at locations 130i and 140i.

To this end and from FIG. 1H and FIG. 1I, some embodiments jointly estimate the vehicle state and the map parameters to consider possibilities of either the map or the vehicle state, or both being estimated with errors. In other words, by including a map the vehicle localization can be improved, and by including a vehicle state the online estimation of the map can be improved.

Some embodiments leverage that a probabilistic fusion of map and vehicle state is advantageous as by incorporating uncertainty, a degree of confidence can be leveraged to update the vehicle state and the state of the map. Doing in such a manner means that the fusion of information can balance between the relying on various sensors, the estimation of the state of the map, and the estimation of the state of the vehicle.

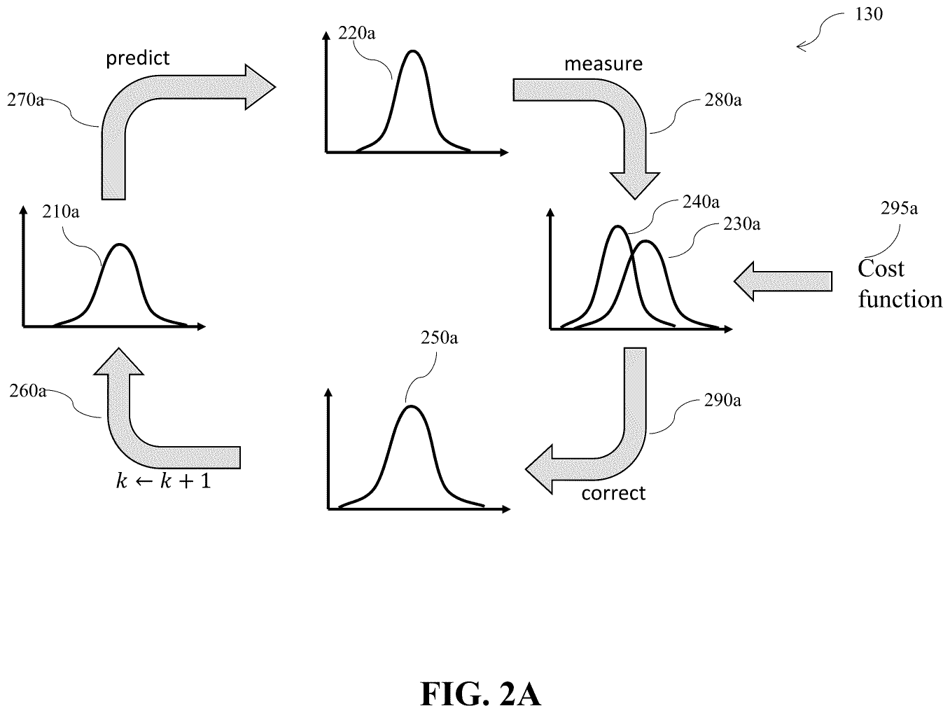

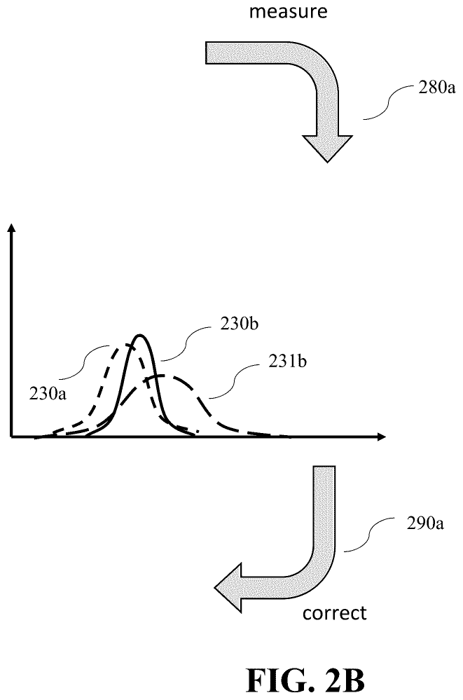

FIG. 2A shows a general flowchart of a probabilistic fusion mechanism 130 according to some embodiments. Using an initial estimate of the state of the map 105, the state of the vehicle 104, and the associated estimation of uncertainty together forming an estimated joint distribution 210a of a joint state including the state of the vehicle and the state of the map, the fusion mechanism 130 predicts 270a the estimation to a predicted distribution 220a, wherein the prediction, i.e., time propagation, typically leverages the motion model 120 of the state of the vehicle 104. In some embodiments, the prediction 210a of the state of the vehicle 104 and the state of the map 105 can be determined independently from each other, because the time propagation of the state of the vehicle 104 depends on the vehicle-exclusive properties, such as the steering of the vehicle and the acceleration of the vehicle. Next, the probabilistic fusion mechanism 130 measures 280a an aggregated state of the vehicle 104 and the map 105, wherein the sensing has probabilistic uncertainties, leading to a measured distribution 230a. Next, using a cost function 295a, the fusion mechanism 130 corrects 290a the predicted distribution 220a transformed 240a to the measured state space, using the measured distribution 230a, to achieve an estimated distribution 250a wherein the correction 290a is based on a cost function to minimize within the fusion mechanism 130. For the next time step, 260a, the procedure is repeated until a termination condition is met.

The fusion mechanism 130 may be implemented in order to determine the correction policy minimizing a joint cost function of the state of the vehicle 104 and the state of the map 104. The joint cost function 295a may include a deviation of the joint predicted state from the measurement values, a magnitude of the correction, and so on. The joint cost function 29a may include the states of the vehicle 104 and the map 105 at the current time instance provided by the current estimation. Additionally or alternatively, the joint cost function 295a may include predicted future states or historic deviations of the states from historic measurements. For instance, the cost function may use a squared 2-norm,

$$\begin{matrix}cost function = {‖ {h}_{ref} - h ( x ( t ) , u ( t ) ) ‖}_{Q}^{2} \\ = {( {h}_{ref} - h ( x ( t ) , u ( t ) ) )}^{T} Q ( {h}_{ref} - h ( x ( t ) , u ( t ) ) )\end{matrix} \qquad ( 1 )$$

where x(t) may represent the predicted state, u(t) may represent the control inputs, e.g., the steering angle and acceleration of the vehicle, and Q may be a positive definite matrix.

The predicted future states of the vehicle may be obtained using the motion model Error! Reference source not found.20 and the control policy, u(t),

$$0 = {f}_{sim} ( x ( t ) , u ( t ) , t ) \qquad ( 2 )$$

where the measured states of the vehicle, x₀ may be used in order to initialize the predicted future states of the vehicle at time zero, x(0)=x₀.

The optimization-based procedure illustrated in FIG. 2A may be implemented in order to minimize the cost function (1) subject to constraints that define a simulation model and the states of the vehicle Error! Reference source not found.04 over a certain time horizon Tₕₒᵣ,

$$min {‖ {h}_{ref} - h ( x ( t ) , u ( t ) ) ‖}_{Q}^{2} s . t . 0 = f ( x ( t ) , u ( t ) , t ) , t ∈ [ 0 , {T}_{hor} ] x ( 0 ) = {x}_{0} \qquad ( 3 )$$

For a quadratic cost function and for a linear motion model, (3) can be implemented in the form of a Kalman filter according to some embodiments, and for a nonlinear motion model, (3) can be approximated by various nonlinear versions of the Kalman filter, e.g., the unscented Kalman filter or more generally linear-regression Kalman filters.

Some embodiments are based on recognition that the measured distribution 230a is by itself uncertain, because a single measurement only tells one sample from the distribution of the measurement variations. While a measurement distribution can be determined under nominal conditions, at runtime it will vary because of numerous factors. For instance, a GNSS measurement may sometimes be reliable, which means a small variance of the distribution, and sometimes, e.g., because of multipath or few line-of-sight satellites, a GNSS measurement may be unreliable, implying a large variance. To this end, some embodiments model each measurement using different hypotheses of distributions from which the measurements could originate from.

For instance, referring to FIG. 2B, a camera measurement can have a distribution such as a first hypothesis 230a, a second hypothesis 230b, and a third hypothesis 231b. In some embodiments such different possibilities of distributions are used in a compound probabilistic filter including a plurality of probabilistic filters, to disambiguate the different types of uncertainties, e.g., GNSS uncertainties, camera uncertainties, and map uncertainties. One embodiment uses multiple possible mean and variance of the different types of measurements when updating the state of the vehicle 104 and the state of the map 105 according to the joint cost function 295a, to determine which of the uncertainties—of the first hypothesis 230a, the second hypothesis 230b, and the third hypothesis 231b gives the best cost function.

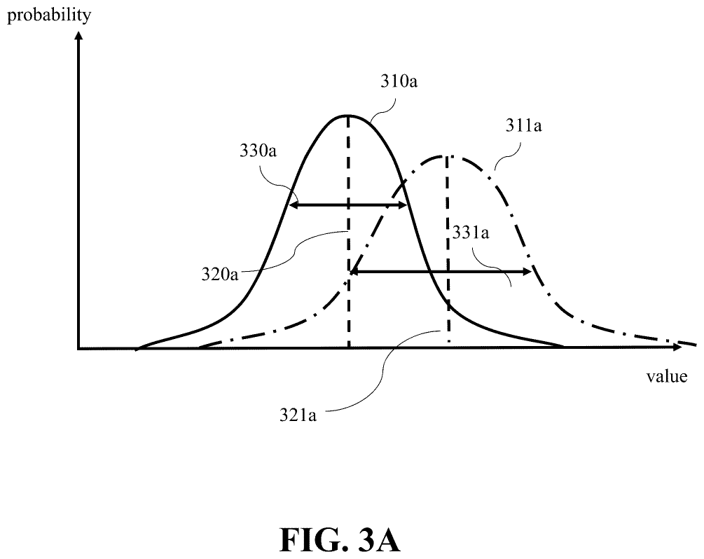

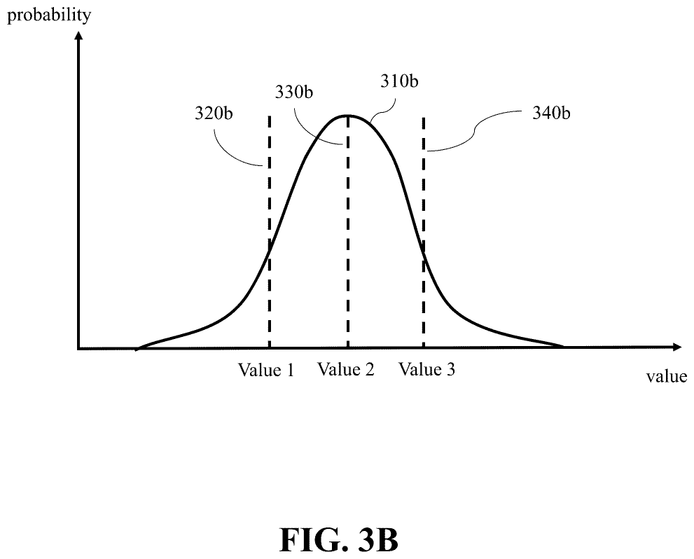

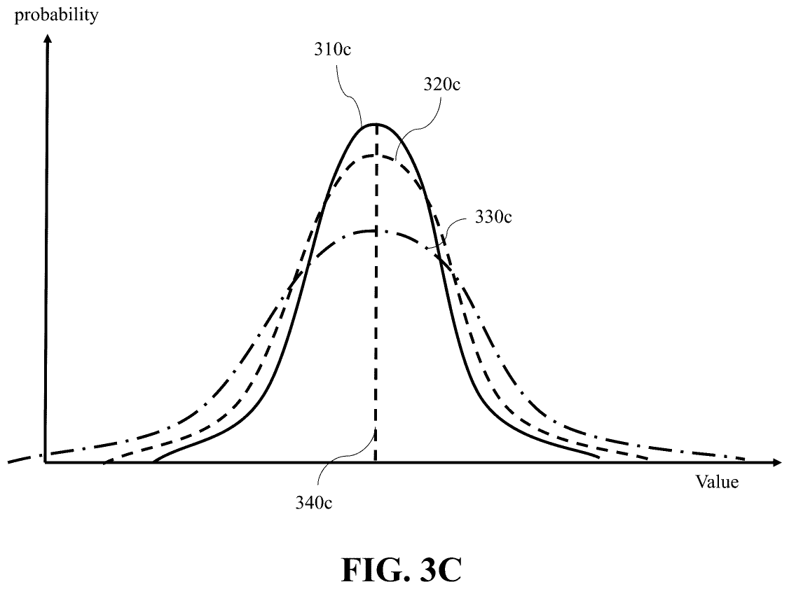

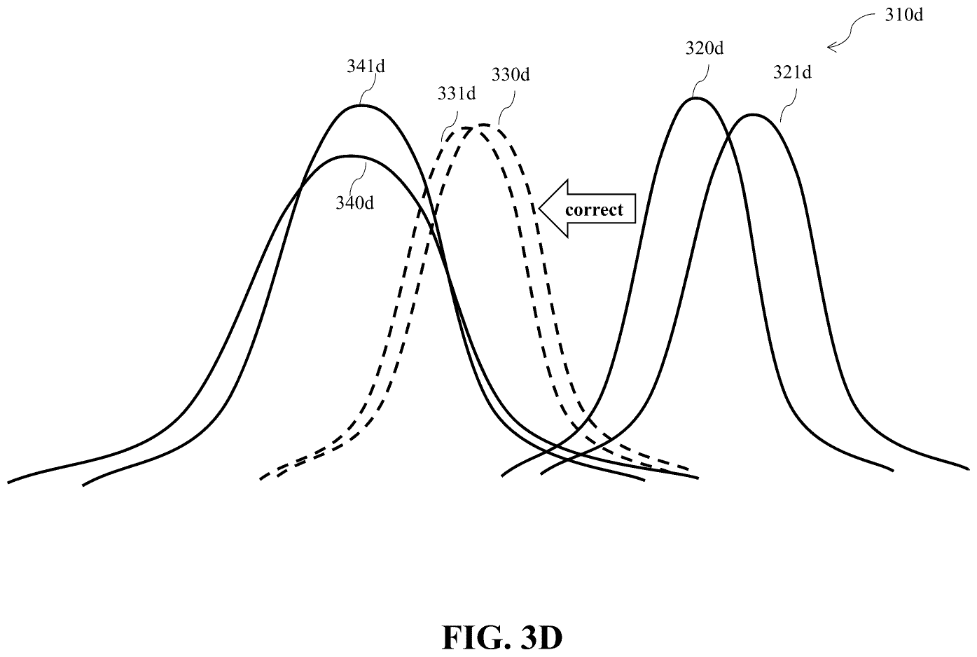

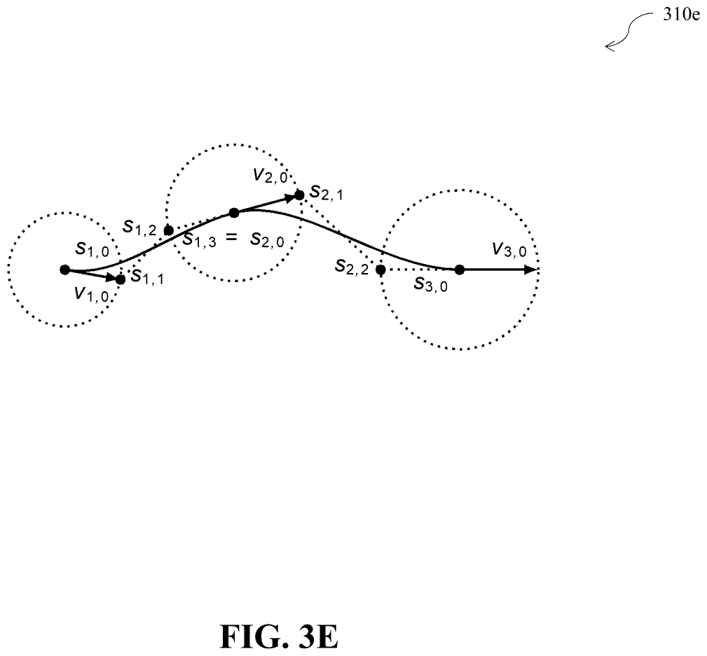

FIG. 3A illustrates an example of a distribution Error! Reference source not found.10a, according to some embodiments of the present disclosure. FIG. Error! Reference source not found.A is explained in conjunction with FIG. 2A. The distribution Error! Reference source not found.10a may be the predicted joint distribution Error! Reference source not found.20a of the state and the map. For instance, the distribution Error! Reference source not found.10a may correspond to a Gaussian distribution. The Gaussian distribution Error! Reference source not found.10a may be defined by a mean Error! Reference source not found.20a and a variance Error! Reference source not found.30a, where the mean Error! Reference source not found.20a defines a center position of the distribution Error! Reference source not found.10a and the variance Error! Reference source not found.30a defines a spread (or a width) of the distribution Error! Reference source not found.10a. FIG. 3A also includes an example of a second distribution 311a according to some embodiments, defined by a different mean 321a and variance 331a. In some embodiments, such different distributions are different estimations of the mean and variance of the joint state, i.e., the state of the vehicle and the state of the map, used in conjunction with different measurement distribution hypotheses to disambiguate the different types of uncertainties.

FIG. 3B illustrates the procedure of how the joint distribution of the state, i.e., the distribution defining the augmented state including the state of the vehicle 104 and the state of the map 105 may be used to determine the correction of the state using the measurement. FIG. 3B is explained in conjunction with FIG. 2A. A distribution 310b may correspond to the predicted joint distribution Error!Reference source not found.20a of the state of the vehicle and the map, i.e., it may correspond to the distribution 310a or the second distribution 311a. The distribution 310b may define a certain number of estimations given different hypothesis of uncertainty of the motion model of the state. For example, the distribution 310b may provide three state hypotheses relating to three different uncertainties, or control actions due to the uncertainties. The three state hypotheses may be given by a first state 320b, a second state 330b, and a third state 340b. The procedure may then be accompanied with the measurement 280a and evaluate the estimation performances using the three different states with the measurement and the measurement distribution 230a. For instance, the distribution 310b may be a Gaussian distribution with a mean x and a variance σ². In this example, the first state 320b may be given by x_1=x−σ, the second state 330b may be given by x_2=x, and the third state 340b may be given by x_3=x+σ.

The results of the prediction resulting in the three states may then be used in order to determine the corrected joint distribution Error! Reference source not found.50a of the joint state in the correction step Error! Reference source not found.90a. For instance, the joint distribution may be updated using a weighted average of the three hypotheses in combination with the measurement distribution 230a, where the weights may be chosen according to the joint cost function Error! Reference source not found.95a,

$$x = {w}_{1} {x}_{1} + {w}_{2} {x}_{2} + {w}_{3} {x}_{3} and \qquad ( 4 )$$

$${w}_{1} = \frac{{c}_{2} + {c}_{3}}{{c}_{1} + {c}_{2} + {c}_{3}} , \\ and \qquad ( 5 )$$

$${w}_{2} = \frac{{c}_{1} + {c}_{3}}{{c}_{1} + {c}_{2} + {c}_{3}} , \\ and \qquad ( 6 )$$

$${w}_{3} = \frac{{c}_{1} + {c}_{2}}{{c}_{1} + {c}_{2} + {c}_{3}} , \qquad ( 7 )$$

where cᵢ is the evaluated cost function of the estimation associated with the state xᵢ. The joint distribution may be combined with other measurement distributions, leading to different weights. In an example, the evaluation of the weights may be chosen using a different measured distribution 230b.

FIG. 3C illustrates Gaussian distributions—a first Gaussian distribution 310c, a second Gaussian distribution 320c, and a third Gaussian distribution 330c (collectively referred to hereinafter as Gaussian distributions 310c, 320c, and 330c) with different variances, according to some embodiments of the present disclosure. FIG. 3C is explained in conjunction with FIG. 2A. The Gaussian distributions 310c, 320c, and 330c may be different hypotheses of the distribution of the measurements 230a, for instance, they may be the distributions 230a, 230b, and 231b in FIG. 2B. Each of these Gaussian distributions 310c, 320c, and 330c may have a different variance with respect to each other, but a mean 340c of the Gaussian distributions 310c, 320c, and 330c may be the same. A Gaussian distribution with a small variance and the mean 340c having a highest probability among other Gaussian distributions may be more certain about the correct measurement defining the distribution.

FIG. 3D illustrates a schematic 310d for updating the joint distribution Error! Reference source not found.20a of the state of the vehicle 104 and the state of the map 105 in the correction step Error! Reference source not found.90a, according to some embodiments of the present disclosure. FIG. 3D is explained in conjunction with FIG. 2A. The schematic 310d includes a predicted Gaussian distribution 320d, a Gaussian distribution 340d defining the uncertainty of the measurement, and a corrected Gaussian distribution 330d. For instance, the predicted Gaussian distribution 320d may be the predicted joint distribution Error! Reference source not found.20a of the one or multiple parameters. For instance, the Gaussian distribution 340d defining the uncertainty of the measurement may be one of the distributions in FIG. 3C, determined from prior experiments measuring the variance of said measurements. For instance, the corrected Gaussian distribution 330d may be the corrected joint distribution Error! Reference source not found.50a of the state of the vehicle 104 and the state of the map 105. The schematic 310d also includes another predicted Gaussian distribution 321d, another Gaussian distribution 341d defining another uncertainty of the measurement, and a corrected Gaussian distribution 331d resulting using the distributions 321d and 341d. In some embodiments the two corrected Gaussian distributions 341d and 340d are weighted together to form the corrected joint distribution Error! Reference source not found.50a of the state of the vehicle 104 and the state of the map 105.

One embodiment is based on the realization that a map prior, represented by the splines with a probabilistic distribution over the spline parameters, needs to be regressed to a map that may be given as a set of connected points distributed in two- or three-dimensional space, so called map points. One embodiment does this by associating the map points to a specific spline segment, and formulating a regression to minimize a measure of total squared total variation error of the regressed road map with respect to the map points, as the L2-norm

$$TV ( p ) = {‖ B ( λ : 𝒫 ) - d ( λ ) ‖}_{{ℒ}_{2} ( [ 0 , 1 ] )}^{2}$$

which can be approximated by Riemann summation as

$$TV ( p ) \approx {\sum }_{i = 1}^{N} {( ( α ( λ ) ⊗ {I}_{d} ) p - {d}_{i} )}^{T} ( {Δ}_{i} {I}_{d} ) ( ( α ( λ ) ⊗ {I}_{d} ) p - {d}_{i} ) = {p}^{T} Hp + {f}^{T} p + c \\ where$$

$${Δ}_{i} = \{ \begin{matrix}{λ}_{i + 1} - {λ}_{i} & if i = 1 \\ {λ}_{i} - {λ}_{i - 1} & if i = N \\ \frac{1}{2} ( {λ}_{i + 1} - {λ}_{i - 1} ) & otherwise\end{matrix}$$

Such a cost function can be minimized analytically when posed without inequality constraints by inverting a linear system. This holds for any square integrable curve that is linear in the parameters used to represent the curve. As an example, but without loss of generality, for a Bezier curve in d-dimensional space,

$$H {=}^{Δ} {A}^{T} NA , f {=}^{Δ} - 2 {A}^{T} ND , c {=}^{Δ} {D}^{T} ND , \\ N = diag ( {Δ}_{1} , … , {Δ}_{N} ) ⊗ {I}_{d} , A = [ \begin{matrix}α ( {λ}_{1} ) \\ ⋮ \\ α ( {λ}_{N} )\end{matrix} ] ⊗ {I}_{d} , D = [ \begin{matrix}{d}_{1} \\ ⋮ \\ {d}_{N}\end{matrix} ]$$

with a solution

$$\hat{p} = arg {min}_{p} TV ( p ) = {( {A}^{T} NA )}^{- 1} {A}^{T} ND .$$

A feature of such a regression is that any uncertainty in the map points encoded as homogenous Gaussian noise on the sampled measurement from the road map can be propagated directly to an uncertainty in the spline parameters, i.e., in the parameters making up the state of the map 105. Again, without loss of generality, using the Bezier curve as an example, we obtain the following expression for the covariance matrix of the spline coefficients

$$Cov [ \hat{p} ] = {( 2 H )}^{- 1} {ANN}^{T} {A}^{T} {( 2 H )}^{- T} {σ}^{2}$$

Where the last factor in the product is the variance of the noise associated with the map points. In other words, by having a prior measure of uncertainty of the map points, the spline parameters, i.e., the state of the map, naturally obtains an uncertainty prior.

Some embodiments are based on the realization that continuity constraints in the velocity can be enforced in the map, which will ensure that there is a one-to-one mapping between the Bezier curve as represented above with an implicitly continuous Bezier curve representation used in the estimator estimating the joint distribution of the state of the map 105 and the state of the vehicle 104. One embodiment expresses a surjective nonlinear map, F, mapping a representation of the control points in the regression to the variables in the splines representing the map 105 in the filter. Indeed, the distribution over the former can be mapped to the distribution of the latter through a first-order expansion, resulting in the approximate relationship

$$\begin{matrix}𝔼 [ {p}_{implicit} ] \approx F ( \hat{p} ) \\ Cov [ {p}_{implicit} ] \approx ( \frac{\partial }{\partial \hat{p}} F ( \hat{p} ) ) Cov [ \hat{p} ] {( \frac{\partial }{\partial \hat{p}} F ( \hat{p} ) )}^{T}\end{matrix}$$

for assigning a prior uncertainty of the map 105.

FIG. 3E shows an illustration of a parametrization 310e process for spline parameters of a spline enforcing continuity implicitly, i.e., by construction in the parametrization. To explain FIG. 3E, consider an arbitrary polynomial [symbol] ᵢ: [0,1]× [symbol] ^{m}^{ᵢ}→ [symbol] ^{d} parametrized in λᵢ∈[0,1] and defined by a parameter vector γᵢ∈ [symbol] ^{m}^{ᵢ}. Some embodiments consider d=3, where the first two elements of the vector-valued polynomial is the Cartesian planar position and where the third element is a lane width. One embodiment constructs a spline S according to S: [0, N]× [symbol] ^{m}^{ᵢ}→ [symbol] ^{d}, S(s;γ₁, . . . , γ_{N})= [symbol] ᵢ(λᵢ;γᵢ), i=┌s┐, λᵢ=s−i−1 and introduce uncertainty in the map by assigning a Gaussian prior on γᵢ∈ [symbol] ^{m}^{ᵢ}. Some embodiments consider polynomials in the form of Bezier curves

$${𝒫}_{i} ( {λ}_{i} ; {γ}_{i} ) = {\sum }_{j = 0}^{{M}_{i}} {\underbrace{( \begin{matrix}{M}_{i} \\ j\end{matrix} ) {( 1 - {λ}_{i} )}^{{M}_{i} - j} {( {λ}_{i} )}^{j}}}_{{b}_{i , {M}_{i} , j}} {s}_{i , j} .$$

Consequently, referring to FIG. 3E, one embodiment enforces continuity of order n by considering polynomials of

$${s}_{i , k} = {s}_{i , 0} + {v}_{i , k} , ∀ k = 1 , ¨ , n ,$$

order 2n+1 and let s_{i,k}=s_{i,M}−v_{i,k}, ∀k=n+1, . . . , 2n+1, for a vector v. Hence, continuity is enforced by letting v_{i,k}=−v_{i,M-k}, ∀k=1, . . . , n and continuity can be made implicit by including v_{i,k} in the parametrization, i.e., in γᵢ∈ [symbol] ^{m}^{ᵢ}.

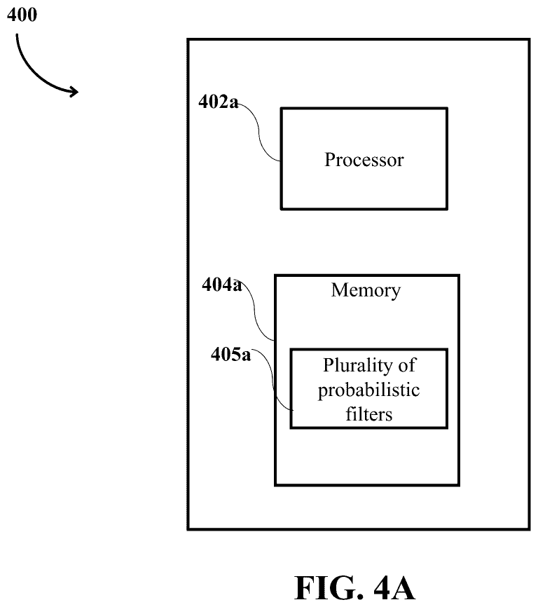

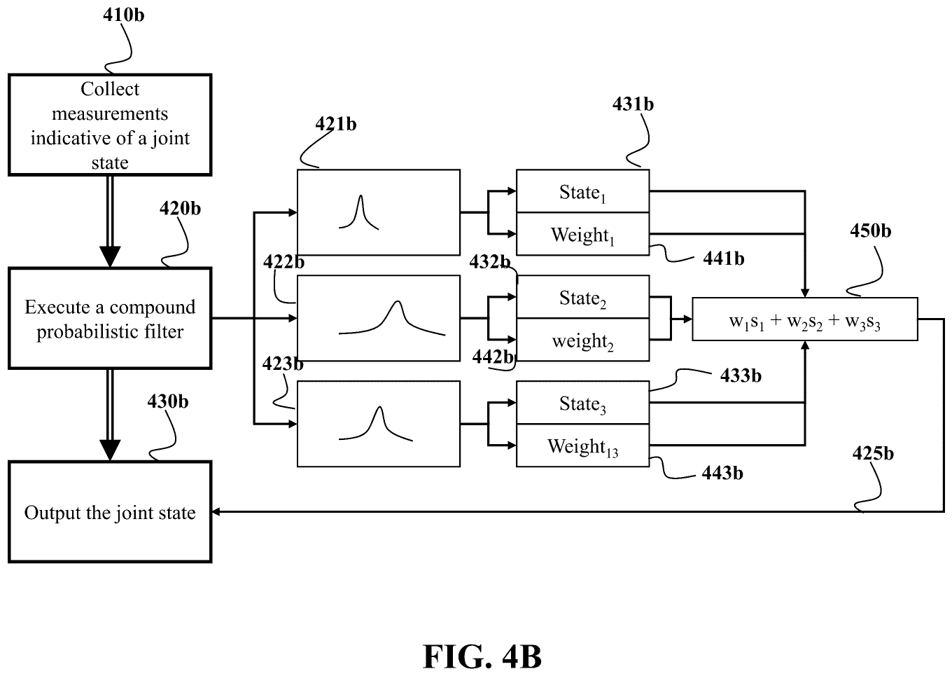

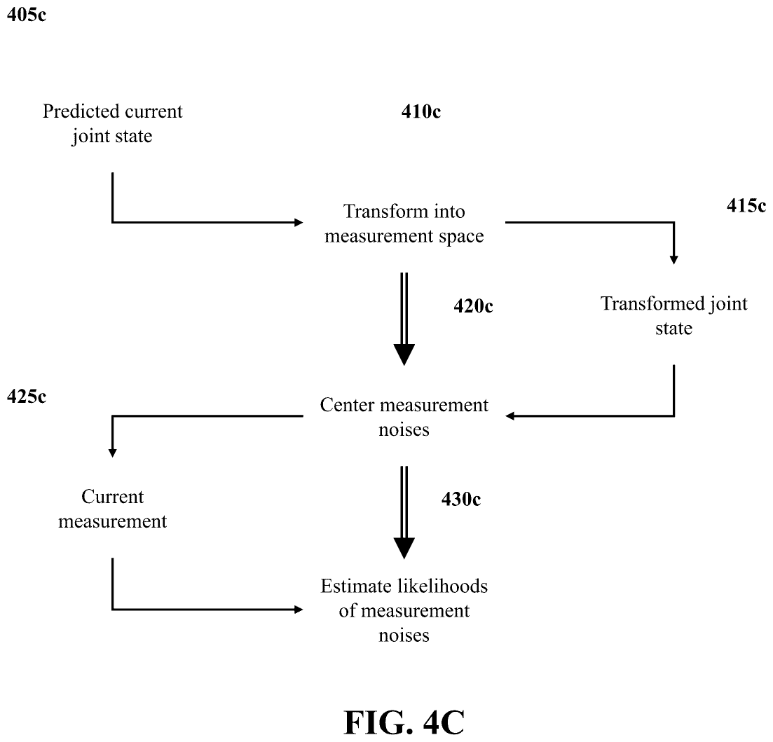

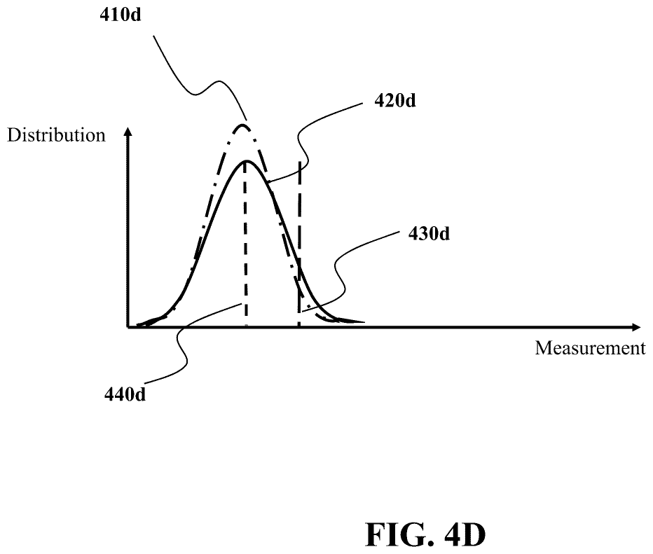

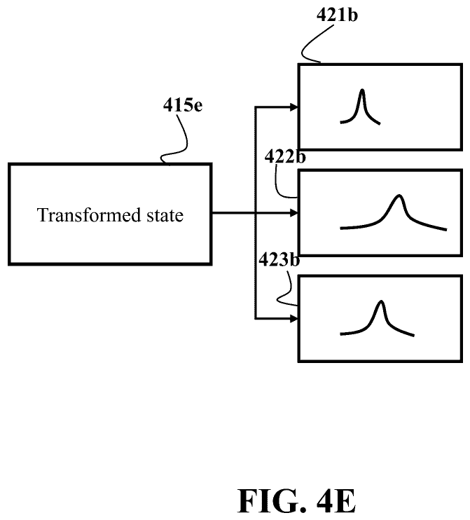

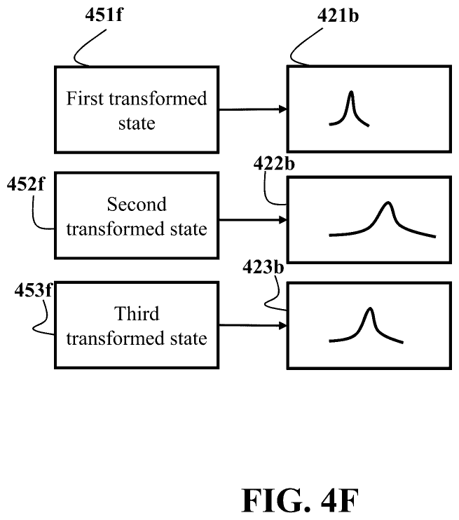

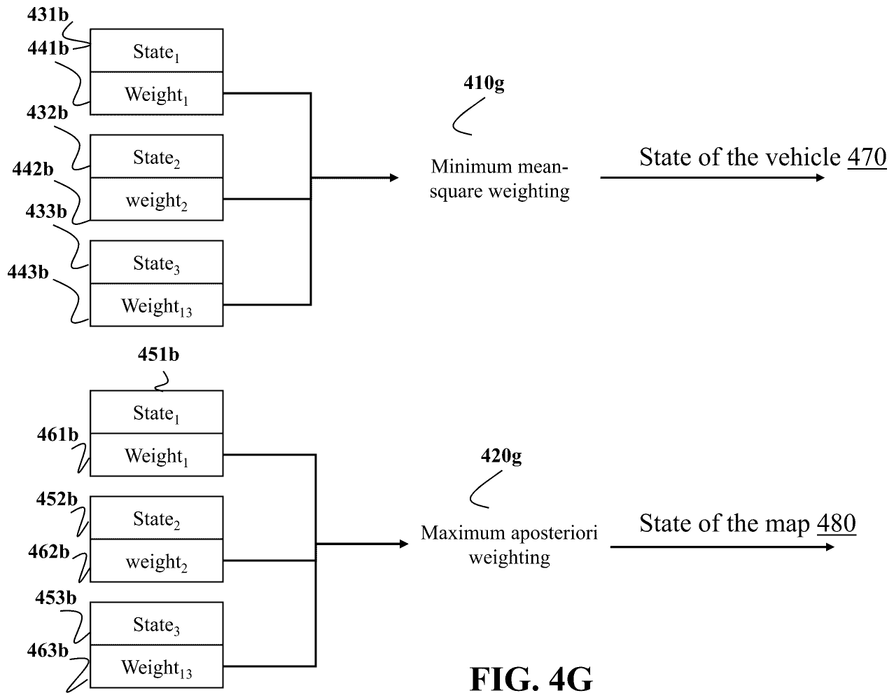

FIG. 4A illustrates a block diagram of a system 400 for joint localization of a vehicle moving in an environment and estimation of a map, according to an embodiment of the present disclosure. The system 400 is equivalent to the system 100, the vehicle is the vehicle 104 and the map is the map 105, as shown in FIG. 1A.

The localization system 400 includes a processor 402a and a memory 404a. The processor 402a may be a single core processor, a multi-core processor, a computing cluster, or any number of other configurations. The memory 404a may include random access memory (RAM), read only memory (ROM), flash memory, or any other suitable memory systems. Additionally, in some embodiments, the memory 404a may be implemented using a hard drive, an optical drive, a thumb drive, an array of drives, or any combinations thereof. In an embodiment, the memory 404a stores a plurality probabilistic filters 405a. The plurality of probabilistic filters 405a is explained in detail in FIG. 4B. Throughout this description, the plurality of probabilistic filters 405a will be referred to as a compound probabilistic filter 405a, without deviating from the scope of the present disclosure. In one embodiment, the localization system 400 may be communicatively coupled to the vehicle 104.

FIG. 4B illustrates a schematic of a method executed by the localization system 400 according to some embodiments of the present disclosure. The localization system 400 tracks the vehicle using measurements indicative of the state of the vehicle 104 and the state of the map 105. For example, the measurements may include one or a combination of a position of the vehicle, a heading angle of the vehicle, a velocity of the vehicle, and the measurements of a camera indicative of a location of the vehicle with respect to a map of the environment. In one embodiment, the measurements indicative of the state of the vehicle 104 may correspond to the sensor measurements 101a-103a shown in FIG. 1A and FIG. 1B. In other words, the measurements indicative of the state of the vehicle 104 may be obtained from one or more sensors 101-103. For instance, measurements indicative of a speed of the vehicle 104 may be obtained from a speed sensor of the vehicle 104. In some embodiments, the measurements of a camera are post-processed such that they output features of the environment, such as the environment 100a, e.g., the lane markings of a road. Such lane marking is composing the map 105 using a spline representation of the map 105 according to some embodiments.

The localization system 400, at first, collects 410b a sequence of measurements indicative of the state of the vehicle 104 at different control steps. For example, the sequence of measurements includes the GNSS measurements 103a and the camera measurements 102a, shown earlier in FIG. 1B. Collectively, the GNSS measurements 103a and the camera measurements 102a are indicative of locations of the vehicle 104 at different control steps of the localization system 400. Further, the localization system 400 executes 420b iteratively the compound probabilistic filter 405a including a plurality of probabilistic filters that are parameterized on a state of a location of the vehicle 104 and a state of the map 105. The compound probabilistic filter configured to jointly track the state of the vehicle 104 and the state of the map 105 at each of the different control steps using the sequence of measurements to produce a joint sequence of states 425b of the vehicle 104 and the map 105 corresponding to the sequence of measurements. Further, the localization system 400 outputs 430b the joint state of the vehicle 104 and the state of the map 105, i.e., the joint state, tracked by the compound probabilistic filter 405a.

To perform an iteration for a current control step using a current measurement, the compound probabilistic filter 405a is configured to execute a plurality of probabilistic filters—a probabilistic filter 421b, a probabilistic filter 422b, and a probabilistic filter 423b (collectively referred to hereinafter as the plurality of probabilistic filters 421b-423b) parameterized on the state of the location of the vehicle 104 and the state of the map 105, jointly, and different measurement distributions, to produce multiple estimates of the joint state for the current control step. For example, the probabilistic filter 421b produces a state 431b, the probabilistic 422b produces a state 432b, and the probabilistic filter 423b produces a state 433b.

Each of the plurality of probabilistic filters 421b-423b is a probabilistic filter that iteratively predicts a current joint state using a prediction model subject to process noise and updates the predicted current joint state based on the current measurement using a measurement model subject to measurement noise, wherein two different filters 421b and 422b have different measurement noise.

To that end, the compound probabilistic filter 405a executes the plurality of probabilistic filters 421b-423b having different measurement noises causing variations in the multiple estimates of the joint state of the location of the vehicle 104 and the state of the map 105, e.g., the states 431b, 432b, and 433b. Next, the compound probabilistic filter 405a estimates, for each of the plurality of probabilistic filters 421b-423b, a likelihood of corresponding measurement noise to correlate the current measurement with the predicted current state and combines 450b the multiple estimates of the joint state of the location of the vehicle 104 and the state of the map 105 into a weighted combination with normalized weights—a weight 441b for the state 431b, a weight 442b for the state 432b, and a weight 443b for the state 433b (herein after referred to as the weights 441b-443b) derived from the likelihoods estimated for corresponding probabilistic filters. Hence, the joint state tracked by the compound probabilistic filter 405a for the current control step is based on the weighted combination 450b.

In such a manner, the measurement noise is evaluated using internal variables and/or calculations of the probabilistic filter without a need for additional statistical analysis of the measurements outside of performance of the probabilistic filter. It should be noted that the abovementioned example not only illustrates the principles of correlation between state estimation and the measurements but can also be used to implement the estimation of the correlation. However, different embodiments can use different techniques to evaluate the correlation. For example, some embodiments use the evaluation of Kalman gains determined by the Kalman filter to update the predicted current state and covariance of the state estimate, which for an unbiased estimator is the mean-square error (MSE). For instance, one embodiment determines the Kalman gain for each Kalman filter in the compound probabilistic filter, determines the updated predicted current state and the updated covariance of the state estimate using the Kalman gain, and determines a likelihood of the measurement noise based on the updated state and covariance based on the Kalman gain. Such calculations are internal to the probabilistic filters, i.e., computed anyway to track the state of the device. Hence, calculations of these variables do not require additional resources.

However, some embodiments are based on the realization that while the usage of the internal variables and/or calculations of the probabilistic filter can reduce the computational requirements for the evaluation of the correctness of the measurement noise, the evaluation itself becomes corrupted by internal performance of the probabilistic filter. In other words, the correctness of the measurement noise is not necessarily the true correctness reflecting the measurements independent of the probabilistic filter, but the correctness from the point of view of the probabilistic filter itself. To that end, it may be problematic to use this evaluation to adapt the measurement noise, but rather to use this evaluation to evaluate the performance of the probabilistic filter with the selected measurement noise.

To address this problem, some embodiments use multiple probabilistic filters with different measurement noises and determine the joint state as a weighted combination of the states estimated by the plurality of probabilistic filters 421b-423b with weights of each filter derived from the corresponding evaluation of the likelihood of the measurement noise to correlate the current measurement indicative of the joint state with the state predicted by the prediction model of the filter. In such a manner, different measurement noises can be considered without a need to analyze the statistical properties of the measurements.

In some embodiments, at each time step, each of the plurality of probabilistic filters 421b-423b, is initialized based on the weighted combination 450b.

The weighted combination can be determined in several ways. One embodiment determines a weighted combination by weighting using the measurement likelihood wherein each likelihood contains a different measurement distribution, wherein the joint state is inserted into the measurement likelihood. Another embodiment determines different weighted combinations for the state of the vehicle and the state of the map.

Due to the probabilistic nature of tracking, selection of the measurement noise affects the state 431b and the associated weight 441b. To that end, the selection of the measurement noise affects the estimation of the state 431b, and thereby the correctness of the selection of the measurement noise can be beneficial to the operation of the probabilistic filter.

Similarly, the selection of a prior map uncertainty affects the update. In some embodiments, different map prior noises are used for different probabilistic filters. In other embodiments, the map prior noises are determined by already mentioned embodiments of the disclosure.

Some embodiments are based on the realization that internal variables and/or calculations of the probabilistic filter, like a Kalman filter, can be used to evaluate correctness of the measurement noise used in the plurality of probabilistic filters 421b-423b. Specifically, a metric of evaluation of the correctness of the measurement noise can be a likelihood of the measurement noise to correlate the current measurement indicative of the joint state with the joint state predicted by the prediction model.

FIG. 4C and FIG. 4D show illustrations of an exemplar evaluation of the correctness of the measurement noise according to some embodiments of the present disclosure. A predicted current joint state 405c of the vehicle 104 and the map 105 is transformed 410c into a domain of the measurements (i.e., measurement space) to obtain a transformed joint state 415c. An example of a transformed state is 440d shown in FIG. 4D. Such a transformation, for example, can be executed using a model of the measurements. Next, different measurement noise characteristics, e.g., noise covariances, are centered 420c on the transformed state 440d to estimate likelihoods of different measurement noises 410d and 420d shown in FIG. 4D. In one embodiment, each of the plurality of probabilistic filters 421b-423b is a nonlinear Kalman filter with the process noise and the measurement noise defined by corresponding Gaussian probabilistic distributions, such that the estimation of the predicted current joint state transformed into the measurement space is a mean of the Gaussian probabilistic distributions and the different measurement noises define different variances of the corresponding Gaussian probabilistic distributions.

Further, when a current measurement 425c for updating the predicted current state 405c is received, the measurements can be mapped 430d on probabilistic distributions to estimate the sought likelihood of the correlation. For example, as can be seen in FIG. 4D, the likelihood of the measurement noise 420d is greater than the likelihood of the measurement noise 410d at the mapped measurement 430d.

In some embodiments, at each time step, each of the multiple probabilistic filters 421b-423b, is initialized based on the weighted combination 425b. For example, referring to FIG. 4E, in one embodiment, a transformed state 415e is used to initialize each of the plurality of probabilistic filters 421b-423b and the predicted joint state of the compound probabilistic filter 450a is updated differently by virtue of having different measurement noise covariances internally in each probabilistic filter. To that end, the estimation of the predicted current joint state transformed into the measurement space (i.e., transformed state 415e) is common for the plurality of probabilistic filters 421b-423b.

In some other embodiments, the plurality of probabilistic filters 421b-423b run in parallel using internal state estimates, wherein the weighted combination 425b is only used as an output of the compound probabilistic filter 405a. For example, referring to FIG. 4F, a first transformed state 451f is obtained for the probabilistic filter 421b by transforming the predicted current state of the probabilistic filter 421b into the measurement space. A second transformed state 452f is obtained for the probabilistic filter 422b by transforming the predicted current state of the probabilistic filter 422b into the measurement space. A third transformed state 453f is obtained for the probabilistic filter 423b by transforming the predicted current state of the probabilistic filter 423b into the measurement space. The plurality of probabilistic filters 421b-423b are configured to update their internal state estimate using the first transformed state 451f, the second transformed state 452f, and the third transformed state 453f, respectively, in the next iteration. In other words, the estimation of the predicted current joint state transformed into the measurement space is different for different probabilistic filters.

Some embodiments are based on the recognition that when having the same transformed state estimate initializing each probabilistic filter at each time step of control may cause a lack of diversity in the state estimates, because each probabilistic filter has only one time step to diversify. Some other embodiments are based on the understanding that, to have the plurality of probabilistic filters 421b-423b run independently from each other, can cause depletion, meaning that after a few time steps only one of the plurality probabilistic filters 421b-423b may have nonzero weight.

To resolve the aforementioned issues, some embodiments initialize the state estimates together at each time step of control by mixing of the estimates, where the mixing for each probabilistic filter is determined by the weights 441b, 442b, and 443b, and a relation to the other weights.

Some embodiments use different weighted combinations 450b to weigh the state of the vehicle and the state of the map, respectively. Such different weighting can be beneficial when different metrics, i.e., cost functions, are associated with different entities. For instance, some applications may require a weighting focusing on smooth vehicle position estimates because they are to be used in a control context where fast variations in the position estimation can be detrimental to control performance, while other applications may require a weighting focusing on providing the best possible estimate of the map, because such map is used for routing systems.

FIG. 4G illustrates two examples of weightings—a first weighting 410g and a second weighting 420g according to some embodiments, where the first weighting 410g is used to weight together the state of the vehicle 104 from the different probabilistic filters to produce a weighted state of the vehicle 470 and the second weighting 420g is used to weight together the state of the map 105 from the different probabilistic filters to produce a weighted state of the map 480. For instance, the first weighting 410g of the state of the vehicle 104 is done in the mean-square sense, because such weighting is known to produce smoother estimates. For instance, the second weighting 420g of the state of the map 105 is done in the maximum aposteriori sense, because such weighting, while known to produce estimates that vary more, is also known to produce estimates that are more likely.

To that end, the state 431b of the vehicle 104 has the corresponding weight 441b, the state 432b of the vehicle 104 has the corresponding weight 442b, and the state 433b of the vehicle 104 has the corresponding weight 443b. All these states and weights are combined by the first weighting 410g, which is minimum mean-square weighting, to generate the weighted state of the vehicle 470. The generated weighted state of the vehicle 470 is a combination of the current states 431b-433b of the locations tracked by the plurality of probabilistic filters 421b-423b. The combination is the first weighting 410g combination.

To that end, a state 451b of the map 105 has a corresponding weight 461b, a state 452b of the map 105 has a corresponding weight 452b, and a state 453b of the map 105 has a corresponding weight 463b. All these states and weights are combined by the second weighting 420g, which is maximum aposteriori weighting, to generate the weighted state of the map 480. The generated weighted state of the map 480 is a combination of the current states 461b-463b of the map tracked by the plurality of probabilistic filters 421b-423b. The combination is the second weighting 420g combination. Also, the weights 441b-443b are different from the weights 461b-463b.

Different weighted combinations each have their pros and cons, and by producing different weights between the state of the map and the state of the vehicle that are independent from each other, different objectives with a weighting can be obtained. While other types of weighted combinations are possible, it is to be understood that 410g and 420g provide two such specific examples of possible weighted combinations.

Some embodiments are based on the realization that the compound probabilistic filter framework described in FIG. 4A and FIG. 4B can be applied for measurements of a Global Navigation Satellite System (GNSS). For instance, the compound probabilistic filter 405a may be configured to track the state of the vehicle 104 at the different control steps using the GNSS measurements 103a to produce a sequence of states of the vehicle, such as the states 431-433b, corresponding to the GNSS measurements 103a.

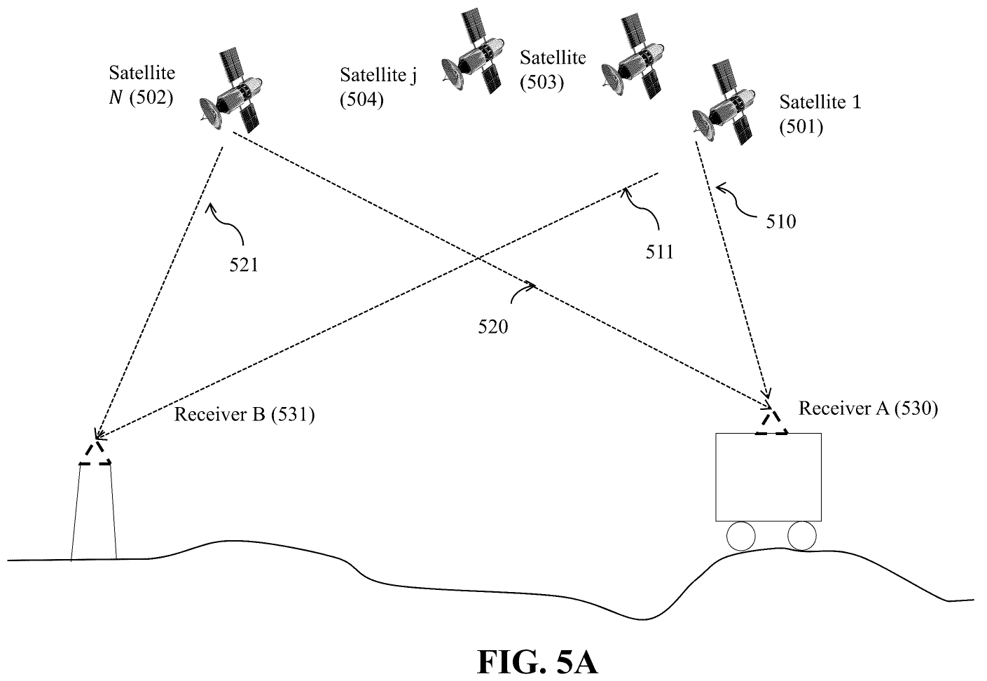

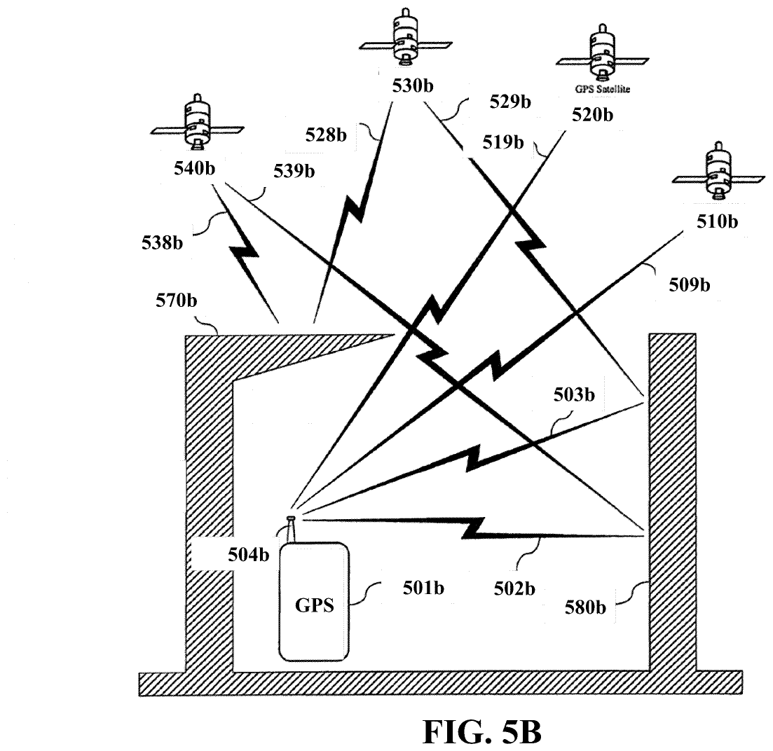

A GNSS is a system of satellites that can be used for determining a geographic location of a mobile receiver with respect to earth. The GNSS may include GPS, Galileo, Glonass, QZSS, and BeiDou. An example of the GNSS is explained in detail in FIG. 5A. FIG. 5A shows a schematic of the GNSS, according to some embodiments. For instance, Nth satellite 502 transmits 520 and 521 code and carrier phase measurements to a set of receivers 530 and 531. For example, the receiver 530 is positioned to receive signals 510, 520, from N satellites 501, 503, 504, and 502. Similarly, the receiver 531 is positioned to receive signal 521 and 511 from the N satellites 501, 503, 504, and 502.

In various embodiments, the GNSS receiver 530 and 531 can be of different types. For example, in the exemplar embodiment of FIG. 5A, the receiver 531 is a base receiver, whose position is known. For instance, the receiver 531 can be a receiver mounted on the ground. In contrast, the receiver 530 is a mobile receiver configured to move. For instance, the receiver 530 is mounted in a vehicle, such as the vehicle 104. In some implementations, the second receiver 531 is optional and can be used to remove, or at least decrease, uncertainties and errors due to various sources, such as atmospheric effects and errors in internal clocks of the receivers and satellites. In some embodiments, there are multiple GNSS receivers receiving code and carrier phase signals.

It is an objective of some embodiments to disclose a system and method for improving the satellite-based tracking of a state of the vehicle 104, wherein the vehicle is equipped with a GNSS receiver. It is another objective to provide such a system and method using unsynchronized cooperation of information received from satellite signals. It is yet another objective of some embodiments to provide such a system and method that is probabilistic, i.e., it accounts for probabilistic disturbances and error sources. It is an objective of other embodiments to track the state of a vehicle using different information from different sources, and not only rely on satellite signals. For example, in some embodiments the state of the vehicle is tracked using GNSS signals received from satellites using a GNSS receiver and a first and second moment of the probabilistic distribution of the state of the vehicle received from a remote server using a radio frequency (RF) receiver.

In certain scenarios, e.g., deep urban canyons, there are multiple distortions of satellite signals such that the information content in the code and carrier phase signals makes it difficult to perform high-precision state estimation. For instance, FIG. 5B shows an illustration of a scenario where multipath disturbs the signals for the receiver 501b. The receiver 501b receives various signals 509b and 519b from satellites 510b and 520b. There are other satellites 530b and 540b that transmits signals 528b, 529b, 538b, 539b, but due to an obstruction 570b, for instance, a building in urban areas, these signals are not directly transmitted to the receiver.

Previously, the signal 538b sent from the satellite 540b was not available, but suddenly the satellite signal 539b reaches the receiver after a multipath event 502b. Such scenario can severely detriment the performance of the probabilistic filter in tracking the state of the vehicle, because the probabilistic filter locks on to the wrong ambiguity estimate, causing a large estimation error.

Additionally, some embodiments are based on the realization that to perform certain advanced driver-assistance systems (ADAS) tasks, such as adaptive cruise control or short-term lane changes, it is sufficient to know the relative position and velocity to other vehicles, which can be measured by, e.g., ultrasound, radar, or camera. However, in many applications surrounding more advanced ADAS and vehicles with autonomous driving (AD) capabilities, it is not enough to know the relative position to surrounding vehicles that can be measured directly, but it is also critical to know state information relative to objects not even visible at a given time step from the vehicle having the AD capabilities. For example, in a route planning or multi-agent motion planning and coordination task, a control problem to be solved is to optimally coordinate vehicles toward different goals, with varying road surface quality, each passenger of a given vehicle with different priorities, e.g., related to driver comfort and other performance metrics. To identify which timed path a particular vehicle should take depends on the location of the own vehicle, timed paths of the other vehicles, and the environment setting for the road of interest.

Some embodiments are based on the realization that while the camera can be used to detect the relative motion to the road and surrounding objects in immediate vicinity of the vehicle with AD capabilities, the camera cannot provide a global position of the vehicle. Also, while distance sensors such as radar, lidar, and ultrasound, can detect relative motion similar to the camera, it cannot be used as a sole sensor to position vehicles globally, unless accompanied with a map relating the sensor measurements to a location in the map with the vehicle.

Further, some embodiments are based on the recognition that GNSSs are prone to various disturbances and occlusion, e.g., from tall buildings in urban canyons. Some embodiments therefore complement the GNSS with additional sensing. For example, GNSS combined with additional sensing such as camera and lidar, can accomplish global positioning, as well as relative to an uncertain map and other objects, because the GNSSs provide the global positioning, and the additional sensing provides the relative positioning. Thus, in several localization estimation methods a multitude of sensors are used together to achieve vehicle localization with an aim of improving performance relative to what a sensor alone can provide.

To this end, various methods fuse GNSS measurements and measurements of a plurality of sensors, such as the sensors 101-103 of different types indicative of the state of the vehicle 104 with respect to the map 105 of the environment 100g, to estimate the state of the vehicle 104 and the state of the map 105. The plurality of sensors may include one or a combination of a camera, a radar, a lidar, and the like. Additionally or alternatively, the plurality of sensors may include one or a combination of a camera producing color images, a depth sensor producing depth images, and a roadside unit (RSU) producing fused measurements of multiple remote sensors.

Using the measurements of the plurality of sensors is beneficial. For example, different sensors can complement each other, e.g., GNSS is dependent on whether the environment is urban or rural but not weather dependent, whereas the camera is independent on whether the environment is rural or urban but is sensitive to weather conditions and quality of the road to detect lane markings.

Various estimation methods that fuse the measurements of the plurality of sensors assume that the measurement noise of such sensors is determined a priori. However, in practice the measurement noise is time varying because it varies with driving conditions, the environment, and filtering and computer vision algorithms that generated such sensor measurements. For instance, a camera is used together with a computer vision algorithm to generate lane marking measurements of lanes neighboring the lane the vehicle is driving in. Depending on the weather conditions, the road quality, and the specific computer vision algorithm used, the lane markings are sometimes accurately detected, sometimes detected with an error, and sometimes other parts of the road, e.g., cracks in the road, are detected as lane markings. Depending on such detection results, the characteristics of the measurement noise will vary accordingly.

Accordingly, there is a need for tracking the state of the vehicle and the state of the map by fusing the measurements of the plurality of sensors while adapting to the varying measurement noises. According to some embodiments, the localization system 400 may be operatively connected to the plurality of sensors using wired, wireless, or both communication links, and thus the localization system 400 can collect measurements of the plurality of sensors indicative of the state of the vehicle 104 and the state of the map 105. Further, the measurement model of the plurality of probabilistic filters 421b-423b of the compound probabilistic filter 405a fuses the measurements of the plurality of sensors 101-103 to produce corresponding estimations of the state of the vehicle 104 and the state of the map 105.

In the following part of the present disclosure, a method for estimating the state of the vehicle and the state of the map using the GNSS measurements and camera measurements, and to control the vehicle based on such estimation, is described. Next, a method for estimating the state of the vehicle and the state of the map using the measurements of the plurality of sensors, is described.

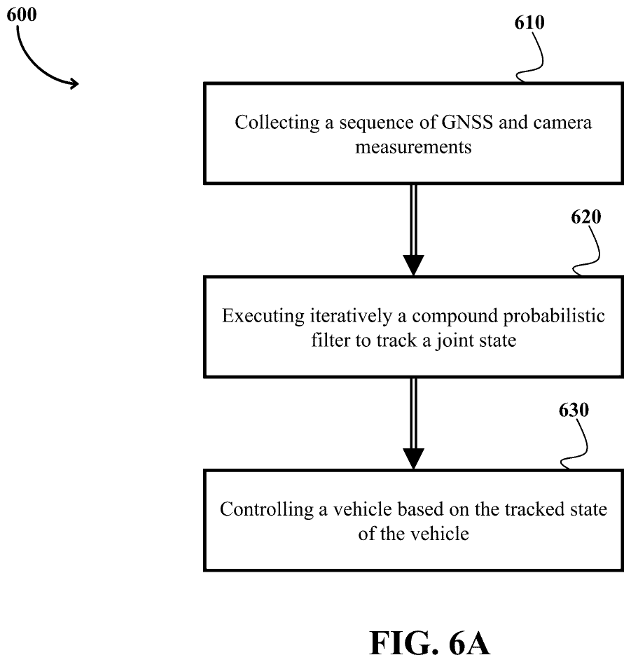

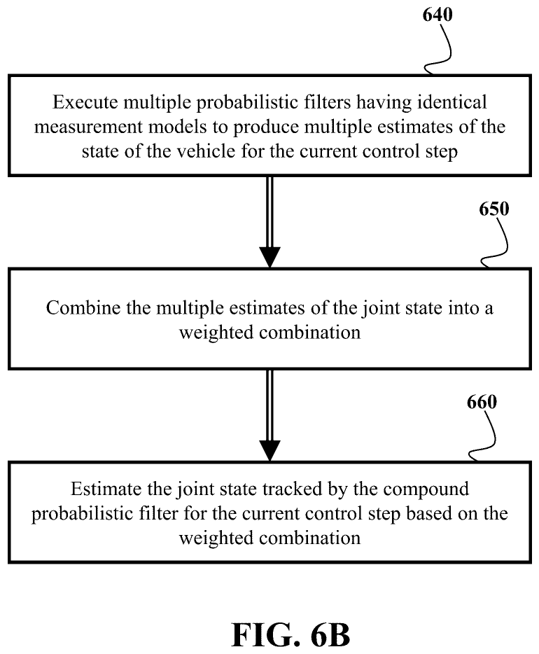

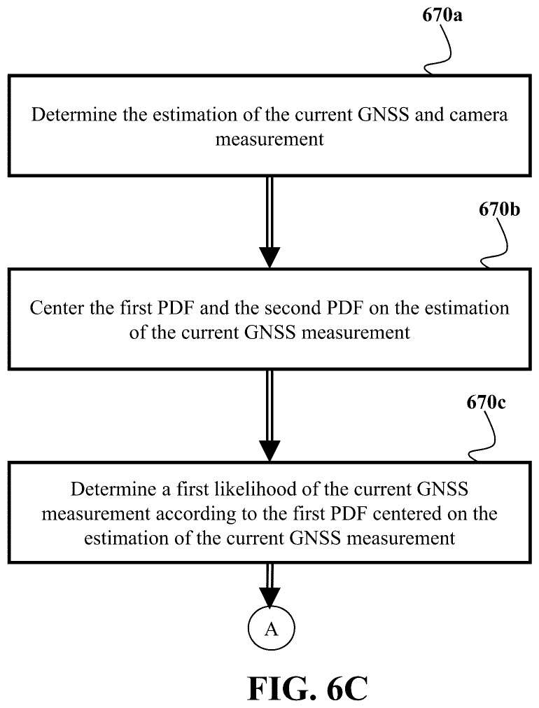

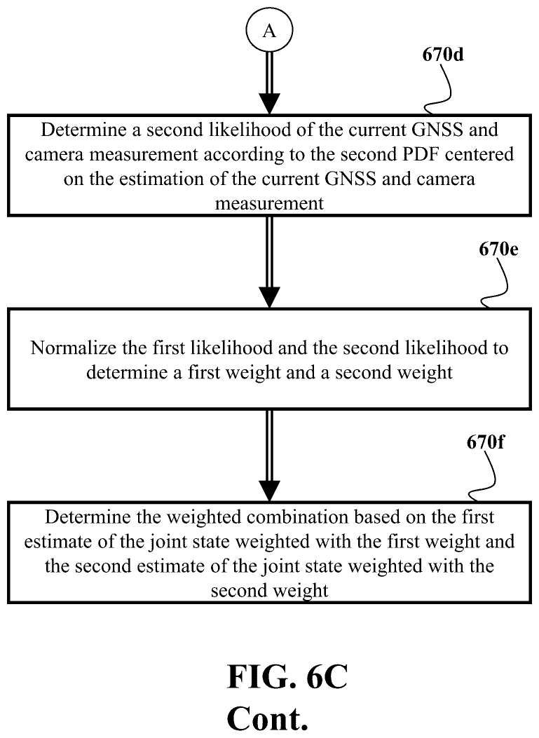

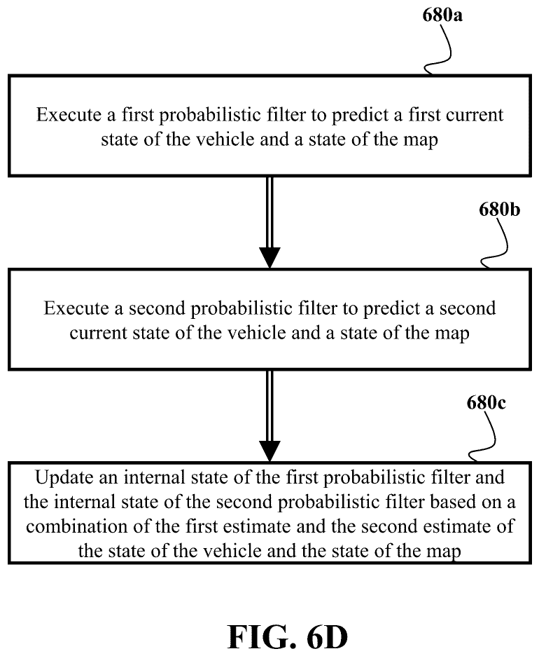

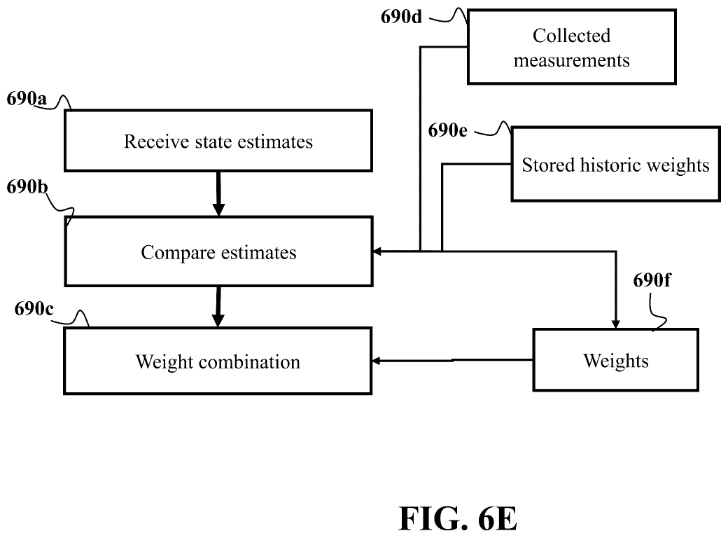

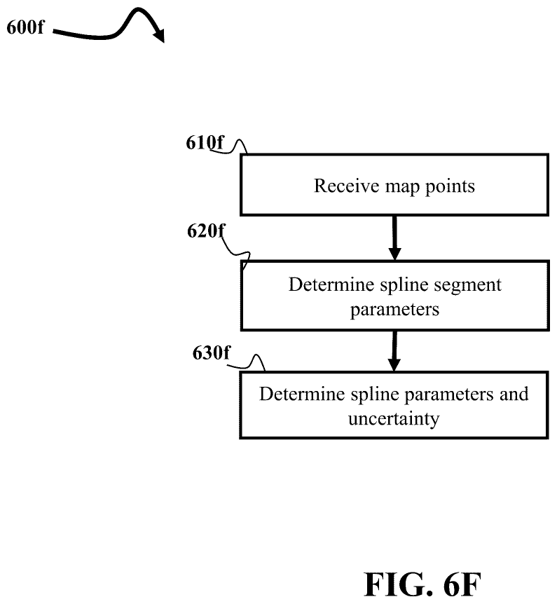

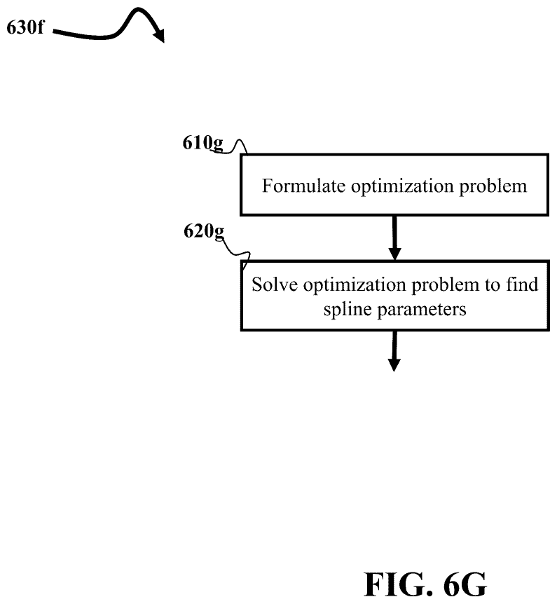

FIG. 6A shows a block diagram of a method 600 for estimating the state of the vehicle 104 and the state of the map 105, the joint state, using the GNSS measurements 103a and camera measurements 102a, and for controlling the vehicle 104 based on the estimated joint state, according to some embodiments of the present disclosure. As used herein, the vehicle 104 can be any type of moving entity, such as a passenger car, a tractor-trailer, a bus, or the like. In some embodiments, the method 600 uses the compound probabilistic filter 405a parametrized on the state of the vehicle, the state of the map, and the plurality of measurement distributions, wherein the state of the vehicle includes a position of the vehicle and an orientation of the vehicle. At block 610, the method 600 includes collecting a sequence of GNSS measurements 103a and camera measurements 102a indicative of the joint state at different control steps. At block 620 the method 600 includes executing iteratively the compound probabilistic filter 405a configured to track the joint state at the different control steps using the sequence of GNSS and camera measurements to produce a sequence of states of the vehicle and a sequence of states of the map corresponding to the sequence of GNSS and camera measurements. For example, as explained in conjunction FIG. 4A, FIG. 4B, FIG. 4C, FIG. 4D, FIG. 4E, and FIG. 4F, the joint state of the vehicle 104 and the map 105 may be obtained as weighted combinations of states of the vehicle and the states of the map.

In some embodiments, the sequence of GNSS and camera measurements are accompanied with measurements of the steering wheel angle of the vehicle 104 and the velocity of the vehicle 104, e.g., obtained from the rotation rates of the wheels. In other embodiments, the measurements include a heading rate of the vehicle 104 and an acceleration of the vehicle 104. In one embodiment, such additional measurements are used to predict the motion forward of the vehicle 104 in time. This is advantageous for several reasons. For instance, the measurements of GNSS typically arrive with one or a few Herts update rate, and the camera 102 in combination with a computer vision algorithm also has limited update rates. However, accelerations and heading rates from an inertial measurement unit, and wheel rotation rates and steering wheel angles, are typically measured at much higher frequency, say 100 Hz or even more. Hence, such additional measurements can be used to update the vehicle location between measurements of GNSS 103 and/or camera 102.

In other embodiments, the camera and GNSS measurements are accompanied with a prior map constructed according to other embodiments, to relate the camera measurement with a global position in the map 105.

At block 630, the method 600 includes controlling the vehicle based on the tracked joint state. For example, controlling the vehicle 104 may be done in accordance with AD/ADAS operations.

To perform an iteration for a current control step using a current GNSS measurement and a camera measurement, the compound probabilistic filter 405a executes the functions described in FIG. 6B.

FIG. 6B shows a block diagram of functions executed by the compound probabilistic filter 405a in an iteration, according to some embodiments of the present disclosure. At block 640, the compound probabilistic filter 405a executes multiple probabilistic filters, such as the plurality of probabilistic filters 421b-423b, having identical measurement models, except for the different distributions of the noise of the measurements, relating the current GNSS measurement 103a and camera measurement 102a with a current estimation of the state of the vehicle 104 and the state of the map 105 to produce multiple estimates of the state of the vehicle and the state of the map for the current control step. The multiple probabilistic filters are subject to different measurement noises causing variations among the multiple estimates of the state of the vehicle. In some implementations, the multiple probabilistic filters include a first probabilistic filter configured to produce a first estimate of the joint state subject to a first measurement noise defined by a first probability density function (PDF) and a second probabilistic filter configured to produce a second estimate of the joint state subject to a second measurement noise defined by a second PDF different from the first PDF. In some embodiments, the uncertainty of the map prior is the same for all probabilistic filters, because such uncertainty can be deduced from data a priori. In other embodiments, the map prior uncertainty is also different for the different probabilistic filters. For example, this can be advantageous when the knowledge about map uncertainty is not known a priori.

At block 650, the compound probabilistic filter 405a combines the multiple estimates of the state of the vehicle into a weighted combination with weights derived from likelihoods of the current set of measurements according to different measurement noises centered on an estimation of the current set of measurements predicted by one or a combination of the multiple probabilistic filters. At block 660, the compound probabilistic filter 405a estimates the joint state tracked by the compound probabilistic filter 405a for the current control step based on the weighted combination. For example, FIG. 4G illustrates generating such a weighted combination.

FIG. 6C shows a block diagram of a process for producing the weighted combination 650, according to some embodiments of the present disclosure. At block 670a, the compound probabilistic filter 405a determines the estimation of the current GNSS measurement and camera measurement by transforming a prediction of the current state of the vehicle and the state of the map from a state space to a measurement space. Such a transformation is shown in FIG. 4E and FIG. 4F. At block 670b, the compound probabilistic filter 405a centers the first PDF and the second PDF on the estimation of the current GNSS and camera measurement.

At block 670c, the compound probabilistic filter 405a determines a first likelihood of the current GNSS and camera measurement according to the first PDF centered on the estimation of the current GNSS and camera measurement. At block 670d, the compound probabilistic filter 405a determines a second likelihood of the current GNSS and camera measurement according to the second PDF centered on the estimation of the current GNSS and camera measurement. At block 670e, the compound probabilistic filter 405a normalizes the first likelihood and the second likelihood to determine a first weight for weighting the first estimate of the joint state and a second weight for weighting the second estimate of the joint state.

At block 670f, the compound probabilistic filter 405a determines the weighted combination based on the first estimate of the joint state weighted with the first weight and the second estimate of the joint state weighted with the second weight.

FIG. 6D shows a block diagram of a process for producing the weighted combination 650, according to an alternate embodiment of the present disclosure. At block 680a, the compound probabilistic filter 405a executes the first probabilistic filter to predict a first current state of the vehicle and a state of the map based on an internal state of the first probabilistic filter and updates the first current state of the vehicle and a first current state of a map. The first current state of the vehicle and the map is updated using the measurement model processing the current GNSS and camera measurement according to a gain of the first probabilistic filter to produce the first estimate of the state of the vehicle and the state of the map.

At block 680b, the compound probabilistic filter 405a executes the second probabilistic filter to predict a second current state of the vehicle and the map based on an internal state of the second probabilistic filter and updates the second current state of the vehicle and state of the map. The second current state of the vehicle and the map is updated using the measurement model processing the current GNSS and camera measurement according to a gain of the second probabilistic filter to produce the second estimate of the state of the vehicle and the state of the map.

At block 680c, the compound probabilistic filter 405a updates the internal state of the first probabilistic filter and the internal state of the second probabilistic filter based on a combination of the first predicted current state estimate and the second predicted current state estimate of the joint state produced by the first probabilistic filter and the second probabilistic filter.

In some embodiments, the compound probabilistic filter 405a stores historic weights of the first probabilistic filter and the second probabilistic filter determined for a number of previous control steps. Further, the compound probabilistic filter 405a updates the weight for weighting the first probabilistic filter at the current control step based on an average of a current weight (e.g., the first weight) and the historic weights of the first probabilistic filter. Likewise, the compound probabilistic filter 405a updates the weight for weighting the second probabilistic filter at the current control step based on an average of a current weight (e.g., the second weight) and the historic weights of the second probabilistic filter.

FIG. 6E shows a schematic for determining the weighted combination using stored historic weights, according to some embodiments of the present disclosure. At block 690a, state estimates determined by each probabilistic filter are received. Next, at block 690b, using collected measurements 690d, stored historic weights 690e and hypothesis of noise covariances of GNSS and camera measurements are compared to determine weights 690f. Alternatively, hypothesis of noise covariance of prior map is also used to determine weights 690f. At block 690c, based on the determined weights 690f, the state estimates are combined as a weighted combination. The historic weights may be stored in the memory 404 of the localization system 400. In an alternate embodiment, the historic weights may be stored in an external memory and the localization system 400 retrieves the historic weights from the external memory.

Comparing the state estimates and determining the weights 690f can be carried out in several ways. For instance, in one embodiment, the weight for each probabilistic filter is determined by a combination of the stored historic weights and a weighted difference of the collected measurements and the received state estimate when inserting the state estimate into the measurement model having the associated hypothesis of noise covariance. In another embodiment, the weight for each probabilistic filter is determined uniquely by a weighted difference of the collected measurements and the received state estimate when inserting the state estimate into the measurement model having the associated hypothesis of noise covariance. In yet another embodiment, the weight is determined based on an average of a current weighted difference of the collected measurements and the received state estimate when inserting the state estimate into the measurement model having the associated hypothesis of noise covariance and the weights determined using a fixed number of previous time steps. For example, one embodiment determines the weight as a moving average using a sliding window of weights determined using previous time steps. Doing in such a manner provides a means to control variation of the weights over consecutive time steps to ensure smooth estimation performance.

FIG. 6F shows a flowchart of a method 600f for how to determine the spline representing the map 105 according to some embodiments. First, the method receives 610f map points representing the map 105. In some embodiment the map points constitute a full global map, e.g., the map points of roads in a city or larger region, in some embodiment the map points are given recursively, e.g., for a lookahead on the road, such that the method 600f is executed iteratively as map points are received.

Next, the method 600f includes determining 620f spline segments, i.e., polynomial segments constituting the full spline. In some embodiments the segments are uniform in space, in other embodiments the segments are nonuniform, e.g., to accommodate different road curvatures. For instance, for curved roads the spline segments need to be shorter in space for a given order of the polynomial to have the same fitting as for a polynomial of the same order for a straight road.

Then, the method 600f includes determining 630f the spline parameters and additionally the associated uncertainty with the spline parameters.

FIG. 6G shows a flowchart of a method for determining 630f the spline parameters according to one embodiment. The determining 630f involves formulating 610g an optimization problem minimizing a measure of total squared total variation error of the regressed road map with respect to the map points as the

$$TV ( p ) = {‖ B ( λ ; 𝒫 ) - d ( λ ) ‖}_{{ℒ}_{2} ( [ 0 , 1 ] )}^{2}$$

L2-norm,
which can be approximated by Riemann summation as

$$TV ( p ) \approx {\sum }_{i = 1}^{N} {( ( α ( λ ) ⊗ {I}_{d} ) p - {d}_{i} )}^{T} ( {Δ}_{i} {I}_{d} ) ( ( α ( λ ) ⊗ {I}_{d} ) p - {d}_{i} ) = {p}^{T} Hp + {f}^{T} p + c$$

$$where$$

$${Δ}_{i} = \{ \begin{matrix}{λ}_{i + 1} - {λ}_{i} & if i = 1 \\ {λ}_{i} - {λ}_{i - 1} & if i = N \\ \frac{1}{2} ( {λ}_{i + 1} - {λ}_{i - 1} ) & otherwise\end{matrix}$$

Using such cost function, the method solves 620g the optimization problem. For instance, in one embodiment the spline is represented by Bezier curves, and for a Bezier curve in d-dimensional space,

$$\begin{matrix}H {=}^{Δ} {A}^{T} N A , & f {=}^{Δ} - 2 {A}^{T} N D , & c {=}^{Δ} {D}^{T} N D , \\ N = diag ( {Δ}_{1} , … , {Δ}_{N} ) ⊗ {I}_{d} , & A = [ \begin{matrix}α ( {λ}_{1} ) \\ ⋮ \\ α ( {λ}_{N} )\end{matrix} ] ⊗ {I}_{d} , & D = [ \begin{matrix}{d}_{1} \\ ⋮ \\ {d}_{N}\end{matrix} ]\end{matrix}$$

with a solution

$$\hat{p} = arg {min}_{p} TV ( p ) = {( {A}^{T} N A )}^{- 1} {A}^{T} N D ,$$

Other embodiments are based on the notion that map points, as mapped by an MMS, sometimes have an associated measure of uncertainty of the map. One embodiment leverages this to formulate a spline in terms of Bezier curves, which enables a covariance matrix of the spline coefficients transformed from the map point uncertainty, Cov[p]=(2H)⁻¹ANN^{τ}A^{τ}(2H)^{-τ}σ², In other words, by having a prior measure of uncertainty of the map points, the spline parameters, i.e., the state of the map, naturally obtains an uncertainty prior.

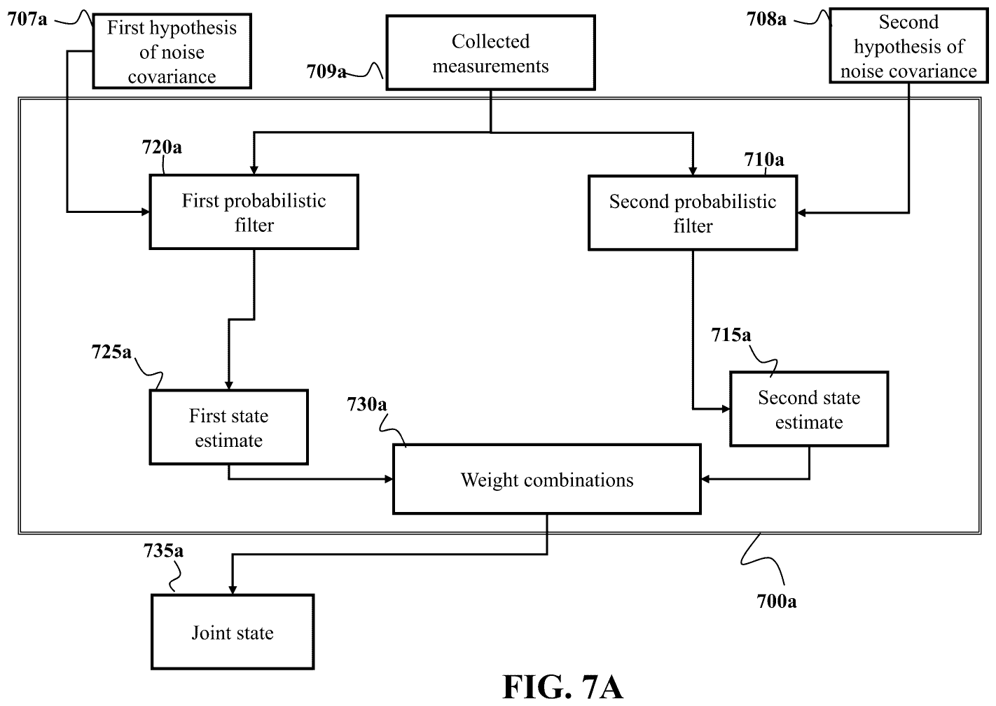

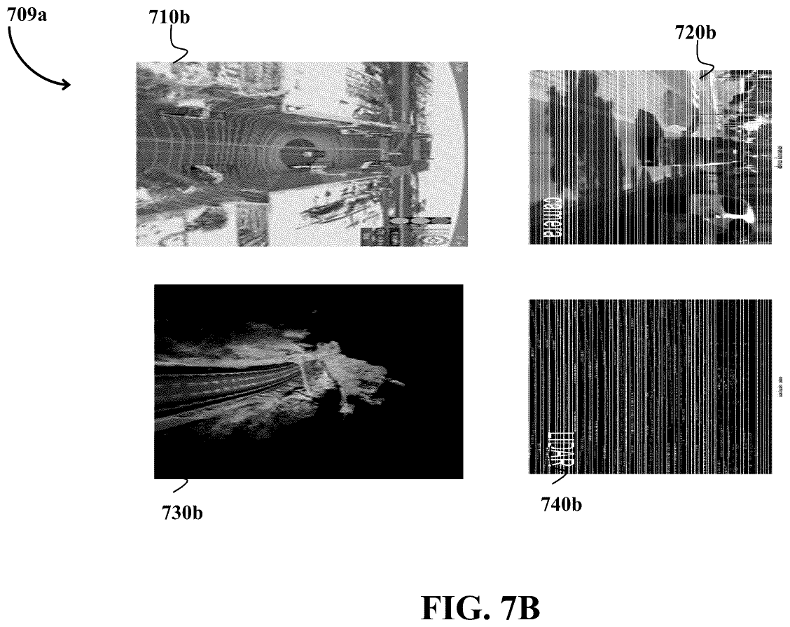

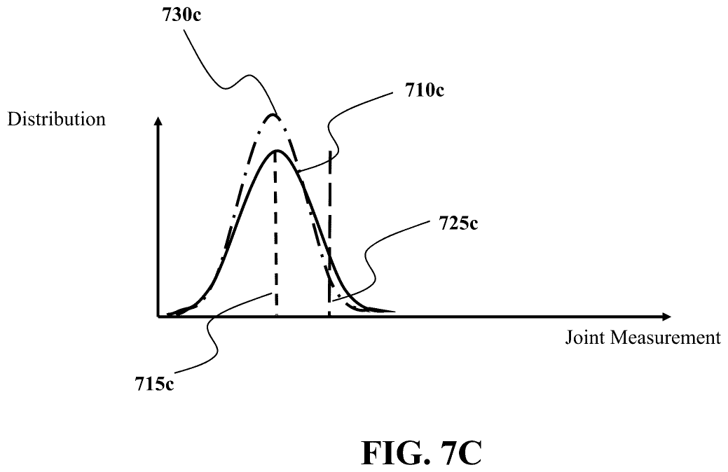

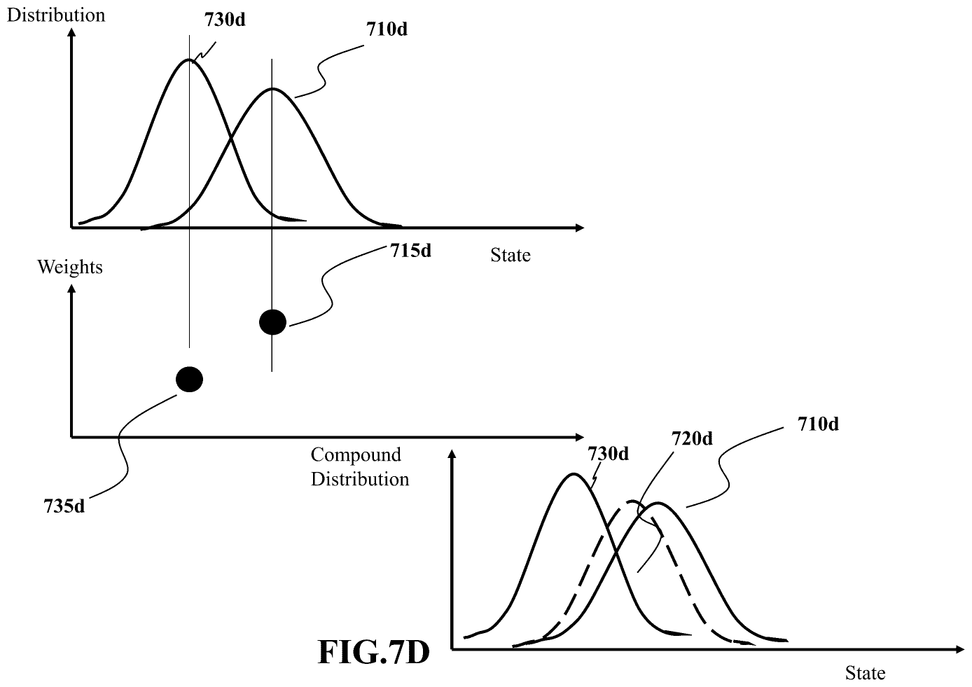

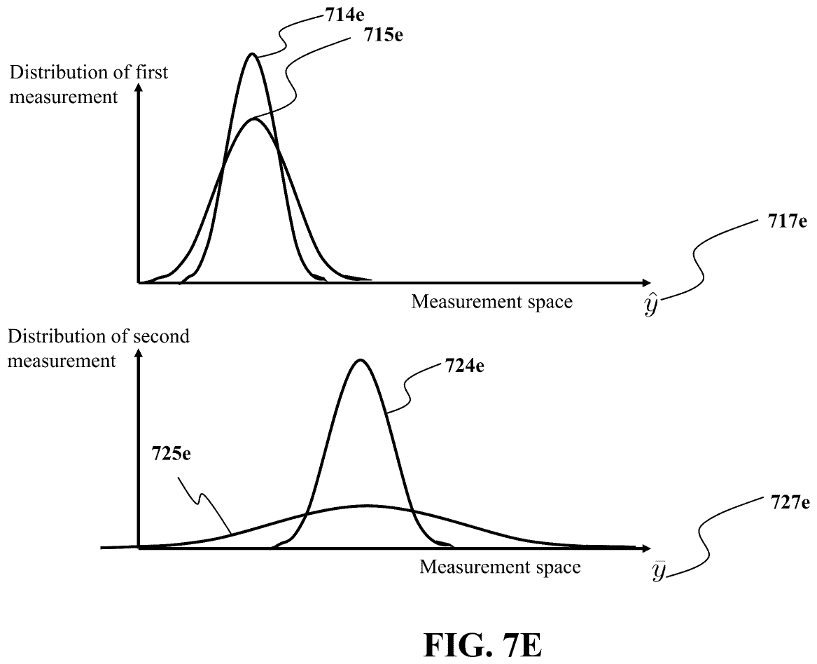

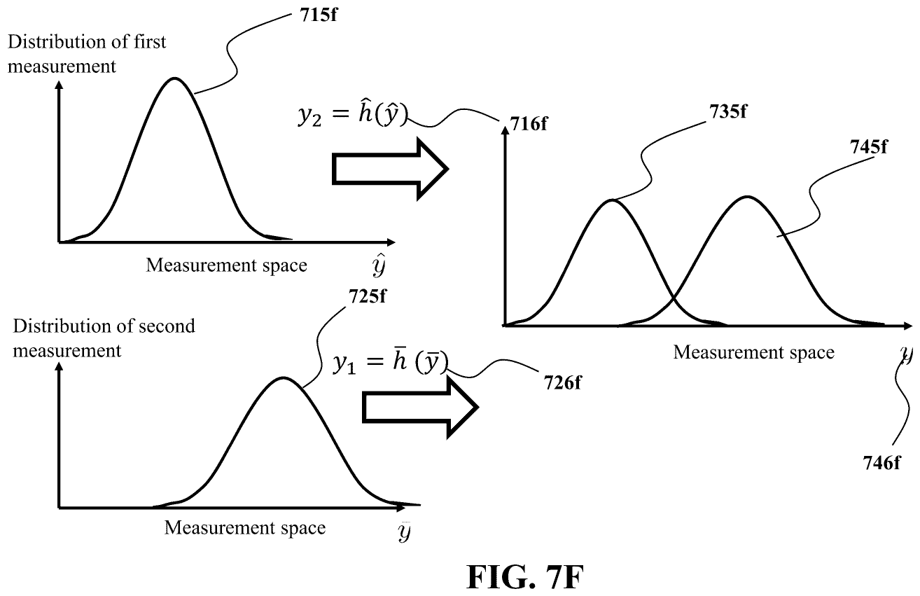

The spline parameters thus determined are then used as coefficients of a polynomial forming the spline representation of the current state of the map 105. FIG. 7A shows a schematic for estimating the state of the vehicle and the state of the map jointly, i.e., estimating a joint state 735a, using the measurements of the plurality of sensors 101-103, according to some embodiments of the present disclosure. In some embodiments, a compound probabilistic filter 700a parametrized on the state of the vehicle 104 and a state of the map 105 is used to estimate the state of the vehicle 104 and the state of the map 105. The compound probabilistic filter 700a estimates the state of the vehicle and the state of the map based on collected measurements 709a. For example, the collected measurements 709a include first measurements from a first sensor and second measurements from a second sensor.

The compound probabilistic filter 700a includes multiple probabilistic filters. For example, the compound probabilistic filter 700a includes a first probabilistic filter 720a and a second probabilistic filter 710a. The first probabilistic filter 720a determines a first state estimate 725a using a first hypothesis of noise covariance 707a of the first measurements and a first hypothesis of noise covariance 707a of the second measurements. Similarly, the second probabilistic filter 710a determines a second state estimate 715a using a second hypothesis of noise covariance 708a of the first measurements and a second hypothesis of noise covariance 708a of the second measurements. In one embodiment, the first hypothesis of the noise covariance 707a of the first measurements is different from the second hypothesis 708a of noise covariance of the first measurements, and the first hypothesis of noise covariance 707a of the second measurements is different from the second hypothesis of noise covariance 708a of the second measurements, or both. In such a case, the first and second noise distributions of either measurement are different distributions in terms of its parameters but represent the same entity. For instance, both distributions represent the measurements of a camera but have different noise values.

Next, using the first state estimate 725a of the first probabilistic filter 720a and the second state estimate 715a from the second probabilistic filter 710a, the joint state 735a of the vehicle 104 and the map 105 is determined as a weighted combination 730a, wherein the weighting 730a of the combinations is determined online, offline, or as a combination thereof. In one embodiment, the joint state 735a of the vehicle 104 and the map 105 is a weighted mean of the first probabilistic filter 720a and the second probabilistic filter 710a. In another embodiment, the state of the vehicle 735a is the output of the probabilistic filter having the highest weight.

In one embodiment, each probabilistic filter is a linear regression Kalman filter that estimates a mean and a covariance of the joint state. In another embodiment, the probabilistic filter is a particle filer, which outputs a sampled representation of a posterior distribution of the joint state. Some embodiments employ a probabilistic filter including various variants of Kalman filter (KF), e.g., extended KFs (EKFs), linear-regression KFs (LRKFs), such as the unscented KF (UKF).

Some embodiments are based on the understanding that if a probabilistic filter using a particular combination of measurement noise values for various sensors gave the best fit at a previous time step, it is likely to also produce a good fit for the next time step. For example, if a GNSS measurement was unreliable in a previous time step due to, e.g., multipath in an urban environment, it is likely to be prone to multipath also in the next time step. However, it also has a chance of producing a reliable measurement if the unreliability of the measurement is not an effect of multipath but due to some other unmodeled disturbance. Some embodiments use this understanding to integrate and weight the multiple probabilistic filters at each time step of control such that the probabilistic filters are given different weightings based on their weights at previous time steps.

Some embodiments are based on the understanding that the computational complexity of the multiple probabilistic filters grows unfavorably with the number of hypotheses of noise values and the number of sensors. For instance, one embodiment understands that using different possible noise values can be interpreted as gridding of a continuous space of possible noise values such that there is an exponential complexity in the number of possible combinations of noise values and therefore the number of probabilistic filters employed in the estimation.

Some embodiments realize that in automotive applications the computational power of automotive-grade electronic control units is limited and using many probabilistic filters is not computationally feasible. One embodiment remedy this by selecting a subset of the probabilistic filters to be used in the estimation. For instance, one embodiment selects probabilistic filters corresponding to values of measurement noises close to those that were well represented the state at the previous time step. Doing in such a manner enables the subset of probabilistic filters chosen at each time step to follow evolution of the sensor quality.

FIG. 7B shows an illustration of different sensor measurements collected 709a according to various embodiments of the present disclosure. For instance, a first measurement of the collected measurements 709a is a camera measurement 710b that together with a computer vision algorithm measures the lane markings of the road, e.g., outputted as a polynomial of a given order, and a second measurement is a lidar measurement 720b that measures a distance to the environment, e.g., road barriers, side walls, and other vehicles. Additionally or alternatively, the measurements 709a are a combination of measurements that provide a measurement of the vehicle and an environment 730b, 740b, e.g., with the environment mapped offline a priori and updated online using a state of the map wherein the state of the map includes parameters of polynomials forming a spline that fits to the map representation points, wherein the prior parameters are optimized according to the corresponding spline's fit with the measurement according to other embodiments. The map is such as the map 105.

Some embodiments use a first hypothesis of a noise covariance of a measurement and a second hypothesis of a noise covariance of said measurement, wherein the first hypothesis is used by one of the probabilistic filters and the second hypothesis is used by another of the probabilistic filters within the compound filters, such as the compound filter 405a.

FIG. 7C shows an illustration of a situation where there is an estimated measurement 715c that is compared by a collected measurement 725c of a sensor. In one probabilistic filter a hypothesis of a distribution 730c is used, where another probabilistic filter uses a hypothesis of a distribution 710c. Consequently, for the scenario in FIG. 7C, the probabilistic filter using the hypothesis of the distribution 730c accurately describes the collected measurement, as the probability at the value of the collected measurement 725c is higher for the distribution 710c than the distribution 730c.

FIG. 7D shows an illustration of how different estimations of the probabilistic filters are assigned different weights and forms a compound distribution, according to various embodiments of the present disclosure. The first probabilistic filter 720a of FIG. 7A estimates a state distribution 730d and the second probabilistic filter 710a estimates a state distribution 710d. Weights 735d and 715d for each probabilistic filter are determined. A compound distribution 720d is determined as a weighted combination of the state distributions 730d and 710d.

FIG. 7E shows an illustration of how different sensors get different weighting and that they are defined on different measurement spaces, according to various embodiments of the present disclosure. For instance, some embodiments use a first hypothesis of distribution 714e, a second hypothesis of distribution 715e for a first measurement defined on a measurement space 717e, and a first hypothesis of distribution 724e, a second hypothesis of distribution 725e for a second measurement defined on a second measurement space 727e. In several embodiments, the distributions—the first hypothesis of distribution 714e and the second hypothesis of distribution 715e for the first measurement space 717e belong to the same measurement space 717e, while the distributions—the second hypothesis of distribution 724e and the second hypothesis of distribution 725e for a second measurement space 727e belong to the same measurement space 727e. Subsequently, 714e and 715e can be combined in different ways with 725e and 724e. For example, the combination 714e and 725e can be used in one probabilistic filter, whereas the combination 714e and 724e can be used in another probabilistic filter. Since the distributions 714e and 715e are defined on the same measurement space, they can be used directly in individual filters for a subsequent measurement update.

One embodiment recognizes that because the first measurement is defined on the measurement space 717e and the second measurement is defined on the second measurement space 727e, they cannot be compared directly.

FIG. 7F shows an illustration how measurements defined on different measurement spaces are transformed to the same measurement space for comparing each other, according to various embodiments of the present disclosure. Some embodiments transform a distribution 715f of a first measurement using a transformation 716f and transform a distribution 725f of a second measurement using a transformation 726f, to result in a distribution 735f of the first measurement, a distribution 745f of the second measurement, wherein the distributions are defined on the same measurement space 746f and can thus be compared and weighted to each other.

Some embodiments employ the different sensors by using a joint measurement model. For instance, referring to FIG. 7F, some embodiments model the joint measurement model as a joint Gaussian distribution having a mean and covariance according to

$$y = {[ {y}_{1} {y}_{2} ]}^{T} = 𝒩 ( {[ \overline{h} ( \overline{y} ) \hat{h} ( \hat{y} ) ]}^{T} ) , [ \begin{matrix}{R}_{1} & {R}_{12} \\ {R}_{21} & {R}_{2}\end{matrix} ] ,$$

wherein covariance elements R₁, R₁₂, and R₂, are measurement noise covariance unique for each probabilistic filter.

In some embodiments, the outputted estimate 735a of the joint state including the state of the vehicle is used to control the vehicle. In one embodiment, a model-predictive controller (MPC) is used for controlling the vehicle based on the outputted estimate 735a of the state of the vehicle and the state of the map, wherein the uncertainty of the state of the map are included in a stochastic MPC formulation.

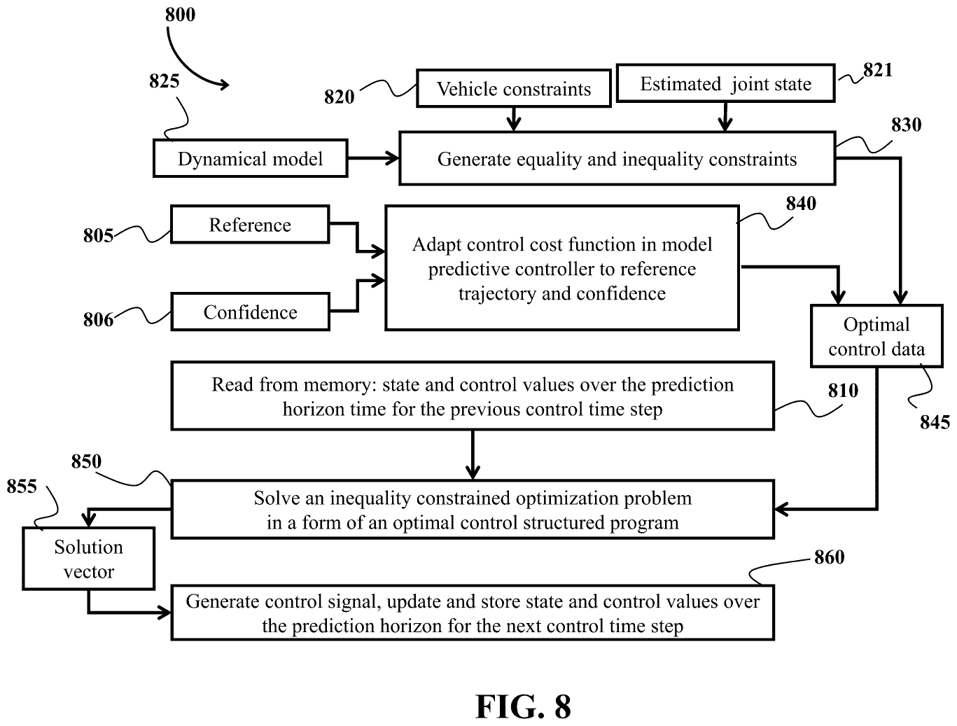

FIG. 8 shows a block diagram of a method 800 for controlling the vehicle 104 based on an estimated joint state 821, according to various embodiments of the present disclosure. Specifically, the method 800 may be implemented by an MPC that computes a control solution, e.g., a solution vector 855 by solving an inequality constrained optimization problem in a form of an optimal control structured program 850 at each control time step. The solution vector 855 includes a sequence of future optimal control inputs over a prediction time horizon of the system. Optimal control data 845 of a control cost function 840, equality and inequality constraints 830 in the optimization problem 850 depends on a dynamical model 825, vehicle constraints 820, the current estimated state of the vehicle and the map 821 and a control command that includes of a reference 805 and a confidence 806.

In some embodiments, the solution of the inequality constrained optimization problem 850 uses state and control values over the prediction time horizon from the previous control time step 810, which can be read from a memory of the MPC. This concept is called warm- or hot-starting of optimization algorithm, which considerably reduces the required computational effort of the MPC. In a similar manner, the corresponding solution vector 855 can be used to update and store a sequence of optimal or suboptimal state and control values for the next control time step 860.

In some embodiments of the present disclosure, the MPC adapts one or multiple terms in the control cost function 840 to the reference 805 and corresponding confidence 806 that are computed by the compound probabilistic filter 405a.

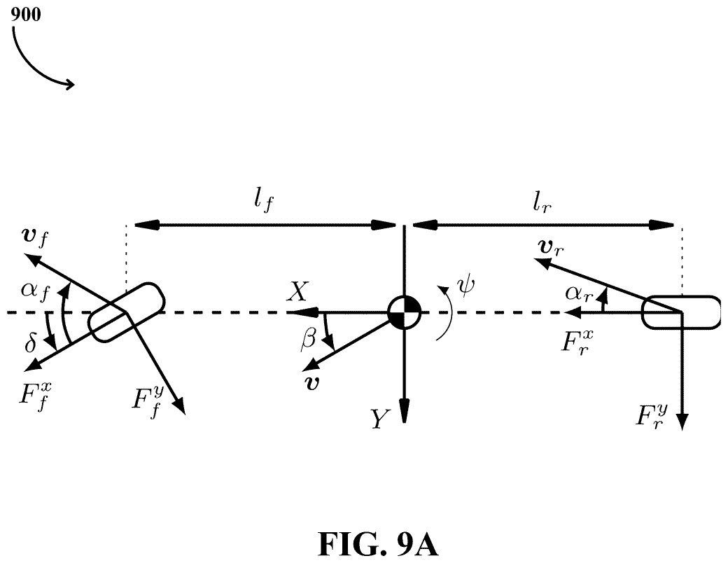

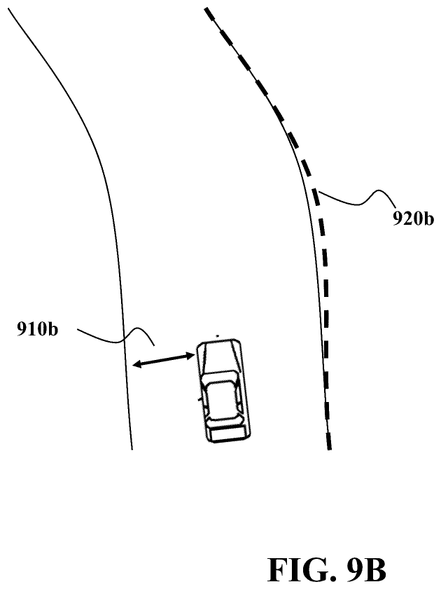

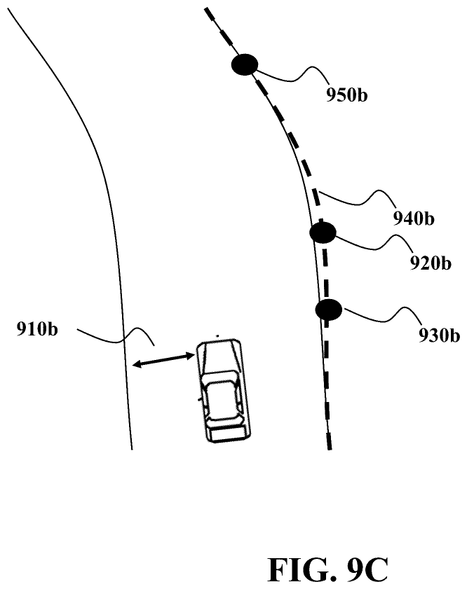

In an embodiment, the prediction model used by the probabilistic filter to predict the current state of the vehicle (e.g., current state) may be a motion model of state transitions of the vehicle subject to the process noise. An example of the motion model is described below in FIG. 9A. In other embodiments, the prediction model used by the probabilistic filter to predict the current state of the map is that of a random walk with zero-mean Gaussian process noise, i.e., γ̅ₖ₊₁=γ̅ₖ+w_{γ}, w_{γ}˜ [symbol] (0,Q_{γ}). Here, γ̅ₖ₊₁ denotes the map parameters at time step k+1.

FIG. 9A shows an illustration of a motion model 900 employed in the compound probabilistic filter 405a, according to some embodiments of the present disclosure. The motion model 900 is a single-track model, i.e., bicycle model, which has been shown to be valid in normal driving scenarios. In some embodiments, a state vector of the vehicle is x=(p^{X}, p^{Y}, v^{X}, v^{Y}, ψ), i.e., the position, velocity, and heading rate of the vehicle. In some other embodiments, the time evolution of the vehicle is modeled by force moment balances as

$$\begin{matrix}m ( {\dot{v}}^{X} - {\dot{v}}^{Y} ψ ) = {F}_{f}^{x} cos ( δ ) + {F}_{r}^{x} - {F}_{f}^{y} sin ( δ ) , \\ m ( {\dot{v}}^{Y} + {\dot{v}}^{X} ψ ) = {F}_{f}^{y} cos ( δ ) + {F}_{r}^{y} + {F}_{f}^{y} sin ( δ ) , \\ I \ddot{ψ} = {l}_{f} ( {F}_{f}^{y} cos ( δ ) + {F}_{f}^{y} sin ( δ ) ) - {l}_{r} {F}_{r}^{y} ,\end{matrix}$$

where m is mass and I is inertia, and F with subscripts are forces acting on the vehicle. The resulting model is nonlinear, and in some embodiments the model is concisely written as

$${x}_{k + 1} = f ( {x}_{k} , {u}_{k} ) + {w}_{k}^{x} , where {w}_{k}^{x} ∼ 𝒩 ( 0 , {Q}^{x} ) ,$$

i.e., zero-mean Gaussian process noise.

In other embodiments, the single-track model is kinematic, i.e., it ignores force moment balances. For instance, in one embodiment, the kinematic single-track model is

$$\dot{z} = [ \begin{matrix}\frac{{v}^{x} cos ( ψ + β )}{cos ( β )} \\ \frac{{v}^{x} sin ( ψ + β )}{cos ( β )} \\ {v}^{x} tan ( {δ}_{f} ) / L\end{matrix} ]$$

wherein z=(p^{X}, p^{Y}, ψ)∈ [symbol] ⁿ^{_{z}} is the state.

Further, the state predicted (e.g., state z) by the motion model 900 is updated using the measurement model. The measurement model used in the compound probabilistic filter 405a models the measurements (such as GNSS measurements and camera measurements). Some embodiments model the GNSS measurements as position measurements preprocessed by a probabilistic filter, e.g., a mixed-integer Kalman filter or a particle filter. Other embodiments model the camera measurements as distances to the lane markings of the road and an approximation of the road ahead, e.g., as illustrated in FIG. 9B, where a camera measures a distance 910b to the lane markings of either lane or the lane markings as a polynomial expression 920b of the road ahead. Some other embodiments leverage a prior map of the road to relate the relative position measurements a camera gives, with global position measurements a GNSS gives. Further embodiments leverage inertial measurement unit including accelerometer and gyro to further enhance the vehicle state estimation. Some embodiments model the measurement model as Gaussian distributed according to yₖ=h(xₖ, uₖ)+eₖ, where eₖ is zero-mean Gaussian distributed with a block-diagonal covariance matrix, wherein elements of a covariance matrix are hypothesized for each of the plurality of probabilistic filters 421a-423a of the compound probabilistic filter 405a. Some embodiments are based on the recognition that typically the first two moments (e.g., mean and variance) describe a distribution well, even though the underlying distribution is not Gaussian. In some embodiments, this recognition is utilized in the determining the covariance of the vehicle state.

Some embodiments recognize that to include a polynomial approximation, i.e., a continuous representation, into the measurement model, discrete values are needed. Hence, such embodiments sample the polynomial function 920b at points—a point 930b, a point 940b, and a point 950b, as shown in FIG. 9C, which can be included into the measurement model for updating the joint state 735a.

Some embodiments update parameters of probabilistic distribution, i.e., mean and covariance using the measurement model. For instance, one embodiment updates the parameters of probabilistic distribution using the Kalman filter (KF). Another embodiment acknowledges that the motion model and the measurement model is nonlinear for some states of the vehicle. To this end, some embodiments employ nonlinear KFs, such as linear-regression KF, to update the parameter of probabilistic distribution. Linear-regression KFs are filters that determine the first and second moment by having the moment integrals including

$${m}^{o} = {\int }_{{ℝ}^{I}} g ( i ) 𝒩 ( i \vert {m}^{i} , {\sum }^{ii} ) di and {\sum }^{oo} = {\int }_{{ℝ}^{I}} ( g ( i ) - {m}^{o} ) {( g ( i ) - {m}^{o} )}^{T} 𝒩 ( i \vert {m}^{i} , {\sum }^{ii} ) di$$

evaluated at a set of integration points

$$\overline{𝒫} = {\{ ( {w}^{\overline{( i )}} , {\overline{ξ}}^{( i )} ) \}}_{i = 1}^{K ( I )} .$$

Some embodiments approximate the posterior density for each probabilistic filter as the Gaussian approximation p(x̅ₖ|y_{0:k})≈ [symbol] (\overline{\hat{x}}_{k|k},P_{k|k}). Given an assumed Gaussian filtering posterior at time step k, distribution at time step k+1 is subsequently approximated as a Gaussian,

$$p ( {\overline{x}}_{k + 1} \vert {\overline{x}}_{k} , {y}_{0 : k} ) \approx 𝒩 ( {\overline{x}}_{k + 1} \vert {\hat{\overline{x}}}_{k + 1 \vert k} , {P}_{k + 1 \vert k} ) ,$$

by direct evaluation of the associated moment integrals,

$$\begin{matrix}{\hat{\overline{x}}}_{k + 1 \vert k} = \int \overline{f} ( {x}_{k} ) p ( {\overline{x}}_{k} \vert {y}_{0 : k} ) d {\overline{x}}_{k} \\ {P}_{k + 1 \vert k} = \int ( \overline{f} ( {\overline{x}}_{k} ) - {\hat{\overline{x}}}_{k + 1 \vert k} ) {( ★ )}^{T} p ( {\overline{x}}_{k} \vert {y}_{0 : k} ) d {\overline{x}}_{k} + {Q}_{k}\end{matrix}$$

Some embodiments assume the process noise enters additively, which considerably simplifies computations.

Some other embodiments leverage LRKFs for determining the associated moment integrals, wherein a set of integration points are used. For instance, some embodiments use integration points according to an unscented transform, other embodiments leverage a spherical cubature rule. However, any set of integration schemes can be used.

In some embodiments, the compound probabilistic filter 405a is implemented according to an interacting multiple model (IMM) framework. Using IMM enables a systematic way to incorporate a first measurement and second measurement using different combinations of hypothesis of the noise covariances of the measurements. At each time step k, the IMM assigns a weight qₖ to each model reflecting the probability of explaining the measurements.

Some embodiments define the prediction model according to

$$\begin{matrix}{\overline{x}}_{k + 1} = \overline{f} ( {\overline{x}}_{k} ; {u}_{k} ) + {w}_{k} , {w}_{k} \sim 𝒩 ( 0 , {Q}_{k} ) , \\ {y}_{k} = h ( {\overline{x}}_{k} ; {u}_{k} ) + {e}_{k} ( {θ}_{k} ) , {e}_{k} \sim 𝒩 ( 0 , {R}_{k}^{{θ}_{k}} ) ,\end{matrix}$$

where the model parameter θₖ ∈[1,m]⊂ [symbol] evolves according to a finite state Markov chain with transition probability Π∈[0,1]^{m×m}

In some embodiments, for each possible θₖ∈[1,m]⊂ [symbol] , different hypotheses of measurement noise are created according to

$${\{ {R}^{{θ}_{k}} ∈ {ℝ}^{{n}_{e} \times {n}_{e}} \vert {R}^{{θ}_{k}} = {( {R}^{{θ}_{k}} )}^{T} , {R}^{{θ}_{k}} ≻ 0 \}}_{{θ}_{k} = 1}^{m} .$$

At each time step of estimation, the IMM uses a transition matrix to mix the different m models,

$$\begin{matrix}{\overline{q}}_{k}^{i} = {\sum }_{l = 1}^{m} {\prod }_{ij} {q}_{k - 1}^{j} , \\ {\hat{\overline{x}}}_{k + 1 \vert k - 1} = {\sum }_{l = 1}^{m} {\prod }_{ij} \frac{{q}_{k - 1}^{j}}{{\overline{q}}_{k}^{i}} {\hat{\overline{x}}}_{k - 1 \vert k - 1}^{j} , \\ {P}_{k - 1 \vert k - 1}^{i} = {\sum }_{l = 1}^{m} {\prod }_{ij} \frac{{q}_{k - 1}^{j}}{{\overline{q}}_{k}^{i}} ( {P}_{k - 1 \vert k - 1}^{j} + ( {\hat{\overline{x}}}_{k - 1 \vert k - 1}^{j} - {\hat{\overline{x}}}_{k - 1 \vert k - 1}^{i} ) {( ★ )}^{T} ) .\end{matrix}$$

After such mixing, some embodiments run m probabilistic filters to determine the vehicle state estimate. Subsequently, the posterior distribution is determined according to

$$\begin{matrix}p ( {\overline{x}}_{k} \vert {y}_{0 : k} ) = {\sum }_{j = 1}^{m} p ( {\overline{x}}_{k}^{j} \vert {y}_{0 : k} ) = \frac{{\sum }_{l = 1}^{m} p ( {y}_{k} \vert {\overline{x}}_{k}^{j} ) p ( {\overline{x}}_{k} \vert {y}_{0 : k - 1} )}{p ( {y}_{k} \vert {y}_{0 : k - 1} )} \\ \approx {\sum }_{j = 1}^{m} {q}_{k}^{i} 𝒩 ( {\overline{x}}_{k}^{i} \vert {\hat{\overline{x}}}_{k \vert k - 1}^{j} , {P}_{k \vert k - 1}^{j} )\end{matrix}$$

that is, a weighted combination of each of the probabilistic filters, wherein the weighting is done according to its fit with the measurement normalized with the hypothesized noise covariance,

$${q}_{k}^{j} ∝ p ( {y}_{k} \vert {\overline{x}}_{k}^{j} ) = 𝒩 ( {y}_{k} \vert {\hat{y}}_{k \vert k - 1 ′}^{j} ′ {P}_{k \vert k - 1}^{yy , j} ) {\overline{q}}_{k}^{j} , ∀ j ∈ [ 1 , m ]$$

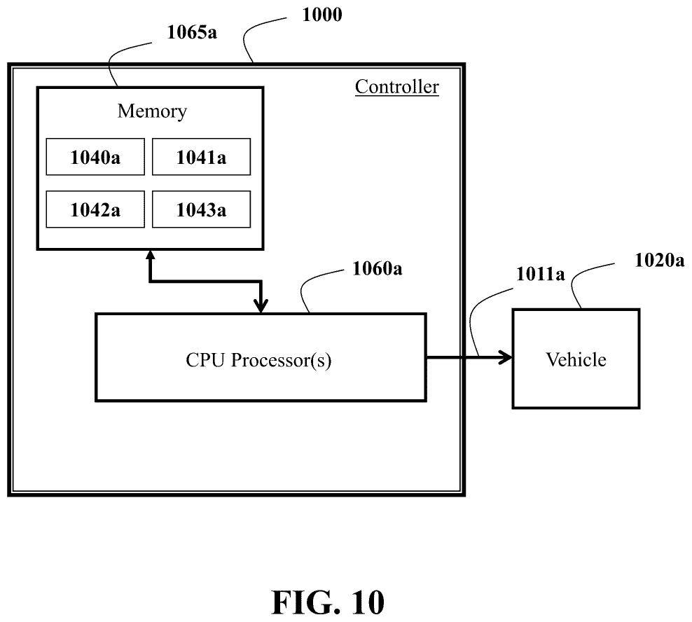

Some embodiments provide a controller for controlling the movement of the vehicle based on a state of the vehicle tracked using the GNSS measurements. Such a controller is explained in detail in FIG. 10 below.

FIG. 10 shows a block diagram of a controller 1000 for controlling the movement of a vehicle 1020a based on a joint state 1011a tracked using the GNSS and camera measurements, according to some embodiments of the present disclosure. The controller 1000 is implemented by the system 100, and the vehicle 1020a is equivalent to the vehicle 104. The controller 1000 is communicatively coupled to the vehicle 1020a. The controller 1000 includes a computer, e.g., in the form of a single central processing unit (CPU) or multiple CPU processors 1060a connected to a memory 1065a for storing a motion model 1040a, a measurement model 1041a, constraints 1042a and hypothesis of noise covariances 1043a of measurements of the vehicle 1020a and additionally different hypothesis of the map prior uncertainty. The processor(s) 1060a can be a single core microprocessor, a multi-core processor, a computing cluster, a network of multiple connected processors, or any number of other configurations. The memory 1065a can include random access memory (RAM), read only memory (ROM), flash memory, or any other suitable memory systems.

The controller 1000 executes the steps of the method described in FIG. 6A, FIG. 6B, FIG. 6C, FIG. 6D, FIG. 6E, FIG. 6F, FIG. 6G, FIG. 6H, and FIG. 7A to estimate the state of the vehicle 1020a. Based on the estimated joint state 1020a, the controller 1000 generates control inputs. The controller 1000 controls the vehicle 1020a based on control inputs corresponding to the joint state 1011a.

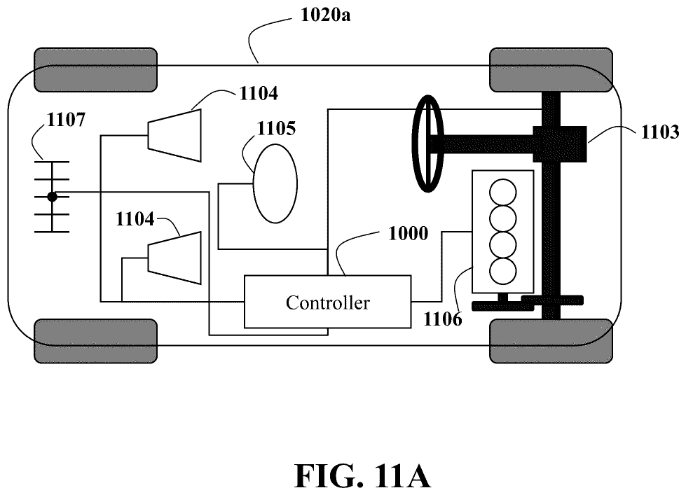

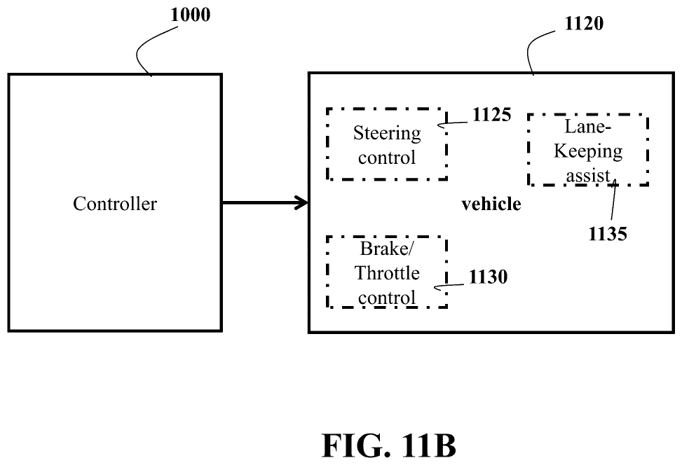

FIG. 11A shows a schematic of the vehicle 1020a including the controller 1000, according to some embodiments of the present disclosure. As used herein, the vehicle 1020a can be any type of wheeled vehicle, such as a passenger car, bus, or a rover. Also, the vehicle 1020a can be an autonomous or semi-autonomous vehicle. For example, some embodiments control the motion of the vehicle 1020a. Examples of the motion include lateral motion of the vehicle controlled by a steering system 1103 of the vehicle 1020a. In one embodiment, the steering system 1103 is controlled by the controller 1000. Additionally, or alternatively, the steering system 1103 can be controlled by a driver of the vehicle 1020a.

The vehicle can also include an engine 1106, which can be controlled by the controller 1000 or by other components of the vehicle 1020a. The vehicle 1002a can also include one or more sensors 1104 to sense the surrounding environment. Examples of the sensors 1104 include distance range finders, radars, lidars, and cameras. The vehicle 1020a can also include one or more sensors 1105 to sense its current motion quantities and internal status. Examples of the sensors 1105 include global positioning system (GPS), accelerometers, inertial measurement units, gyroscopes, shaft rotational sensors, torque sensors, deflection sensors, pressure sensors, and flow sensors. The sensors provide information to the controller 1000. The vehicle can be equipped with a transceiver 1107 enabling communication capabilities of the controller 1000 through wired or wireless communication channels.

FIG. 11B shows a schematic of interaction between the controller 1000 and controllers 1120 of the vehicle 1020a, according to some embodiments of the present disclosure. For example, in some embodiments, the controllers 1120 of the vehicle 1020a are a steering controller 1125 and a brake/throttle controllers 1130 that control rotation and acceleration of the vehicle 1020a. In such a case, the controller 1000 outputs control inputs to the controllers 1125 and 1130 to control the state of the vehicle 1020a. The controllers 1120 can also include high-level controllers, e.g., a lane-keeping assist controller 1135 that further process the control inputs of the controller 1000. In both cases, the controllers 1120 use the outputs of the controller 1000 to control at least one actuator of the vehicle, such as the steering wheel and/or the brakes of the vehicle 1020a, in order to control the motion of the vehicle 1020a.

Some embodiments are based on the understanding that the precision of a sensor can vary with time, both smoothly and abruptly. Other embodiments recognize that probabilistic filters, such as KFs and LRKFs, in its standard formulation needs a priori set noise covariances of the measurements used to update the state estimate, wherein the noise covariances has effect of normalizing and weighing together the importance of each measurement. Some other embodiments are based on the realization that KFs that adapt the noise, e.g., using variational Bayes methods for noise adaptation, do not have convergence guarantees and does perform well when making small changes to the a priori set noise covariances. However, e.g., for the case of outliers in GPS measurements, such methods are prone to errors because the outliers tend to happen from one time step to another and noise adaptation methods are well known to have issues with correctly adapting such large changes to the noise covariances in real time. E.g., variational Bayes methods for noise estimation is dependent on tuning factors, for example the forgetting factor, which determines the rate at which changes in the parameter estimates can occur. Such forgetting factor is often designed assuming slowly changing parameters. Hence, fast variations, as is the case for e.g. GNSS measurement reliability, is not well handled in such approaches. This is in contrast to the method disclosed in the current disclosure, which converge quickly because the probability for each filter is determined using the likelihood having the hypothesis of measurement noise covariance incorporated into the likelihood.

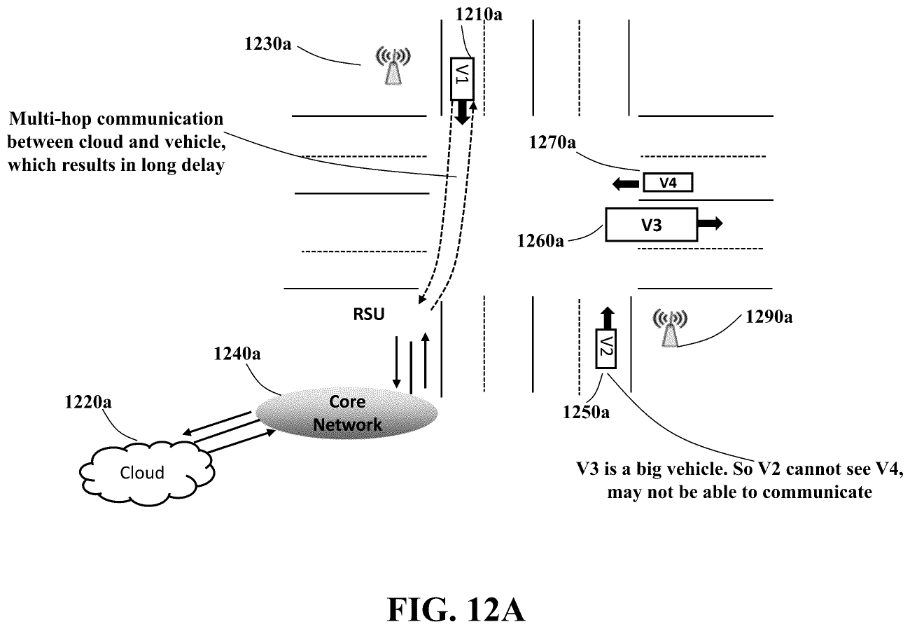

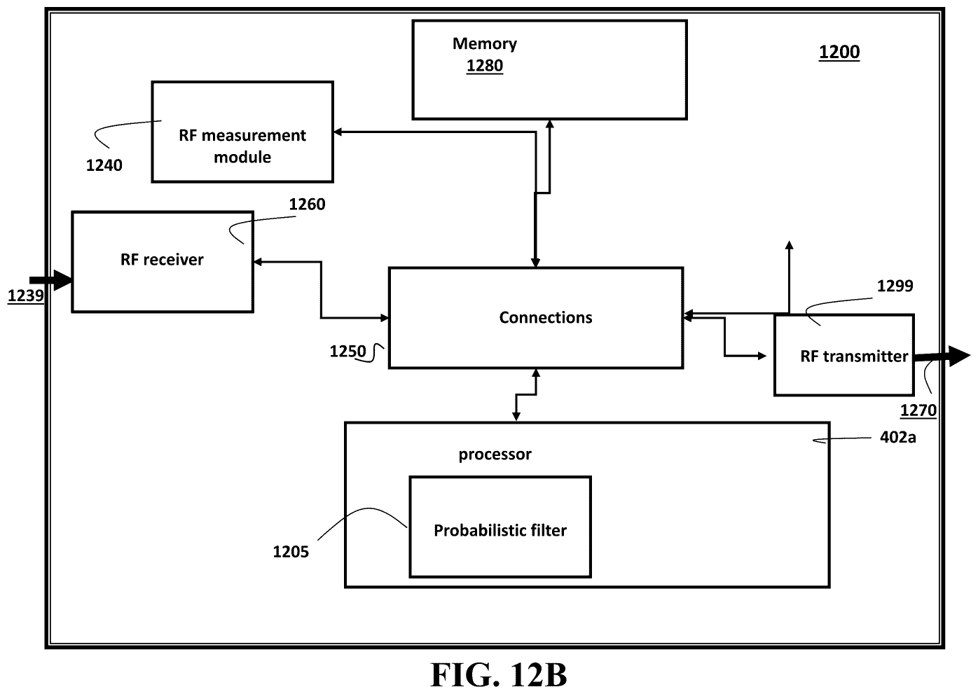

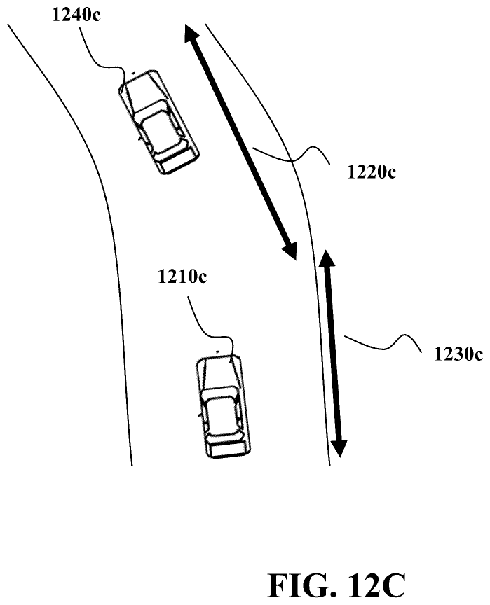

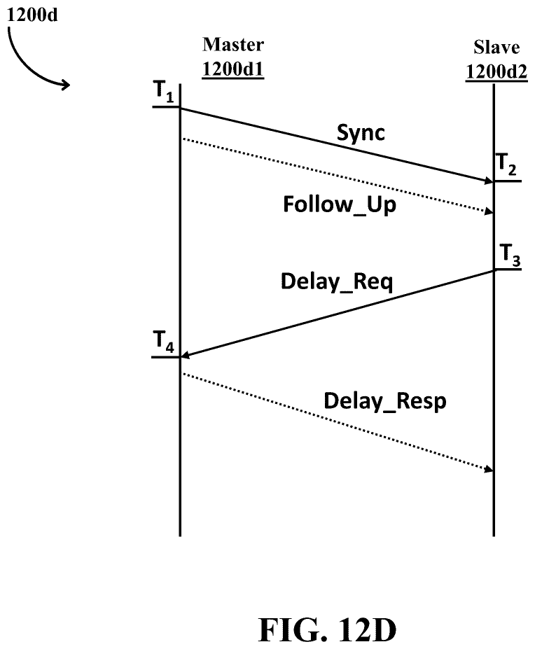

FIG. 12A shows a traffic scenario illustrating a scenario according to some embodiments. Some embodiments are based on recognition that road-side units (RSUs) are used to communicate information about the state of the map to other RSUs, which can be communicated to other vehicles. For example, the information about the state of the map estimated for a first vehicle at a first location can be shared with a second vehicle at a second location, such that the second vehicle has information about the state of the map of the first location, despite not having visited the first location.

To establish communication among vehicles and the RSUs, information transfer between RSUs and vehicles needs to go through core infrastructure network as shown in FIG. 12A, where the communication between vehicle V1 1210a and cloud 1220a needs to go through RSU 1230a and core network 1240a, and communication between vehicle V1 and V2 1250a needs to go from RSU 1230a to RSU 1290a.

Other embodiments recognize that the various RSUs can be used to upload information about parts of the map to vehicles not having seen such particular part of the map previously.

FIG. 12B shows a remote server 1200 for tracking a map using unsynchronized cooperation of information received from one or several RSUs transmitted over radio frequency (RF) channel 1239 according to some embodiments. The remote server 1200 includes a transmitter 1299 that transmits 1270 its belief of the state of the map to one or several RSUs and an RF receiver 1260 for receiving 1239 the first and second moment of the state of the map.

The server 1200 includes a memory 1280 that stores instructions to execute a probabilistic filter 1205 according to some embodiments of the disclosure. The probabilistic filter 1205 is equivalent to the compound probabilistic filter 405a.

The remote server 1200 includes an RF measurement module 1240 that is operatively connected 1250 to the RF receiver 1260 that receives information 1239 transmitted over an RF channel from multiple vehicles. In some embodiments, the information includes a first moment and a second moment of maps observed from multiple vehicles.

Some embodiments recognize that some vehicles have measured the same road segment corresponding to the same spline segment, wherein the estimates of that part of the state of the map may have different mean and covariance. One embodiment determines the first and second moments of the state of the map using a distributed estimation scheme. For instance, one embodiment employs a consensus filter 1205.

In various embodiments, the remote server 1200 uses the first and second moment of similar parts of the map to update that segment of the map.

In other embodiments, the server 1200 includes the RF transmitter 1299 for transmitting 1270 the updated first and second moment, i.e., mean and covariance, that corresponds to a map segment. For example, referring to FIG. 12C, the mean and covariance of a map segment 1230c measured from a vehicle 1210c is transmitted to a vehicle 1240c, which is located in a map segment 1220c.

Some embodiments implement the probabilistic filter 1205 as a consensus Kalman filter, wherein the estimates are combined by one of several consensus protocols defined by a set of weights

$$\{ {w}_{ij} ∈ ℝ \vert i = 1 , … , N , j = 1 , … , N , {\sum }_{i} {w}_{ij} = 1 \} .$$

For example, some embodiments use one of the three protocols

$${w}_{ij} {=}^{Δ} {N}^{- 1} , ∀ i \neq j ,$$

$${w}_{ij} {=}^{Δ} {( {max}_{j ∈ {u}_{6}^{1}} \vert {u}_{j}^{1} \vert )}^{- 1} , ∀ i \neq j ,$$

$${w}_{ij} {=}^{Δ} {( 1 + max ( \vert {u}_{i}^{1} \vert , \vert {u}_{j}^{1} \vert ) )}^{- 1} , ∀ i \neq j .$$

One embodiment implements the consensus filter on information form with an information vector γ_{k|k} and information matrix Γ_{k|k} relating to the state mean estimate as

$${\hat{x}}_{k \vert k}^{i} = {( {Γ}_{k \vert k}^{ii} )}^{- 1} {γ}_{k \vert k}^{i}$$

and covariance as

$${P}_{k \vert k}^{ii} = {( {Γ}_{k \vert k}^{ii} )}^{- 1} .$$

In one embodiment the consensus filter is iterated at each time step, and the consensus protocols are implemented by having the nodes iterate their information vectors (and information matrices) with their neighbors over several steps according to

$${\hat{γ}}_{k \vert k}^{i , ( n + 1 )} = {\sum }_{j ∈ {u}_{i}^{1}} {w}_{ij} {\hat{γ}}_{k \vert k}^{j , ( n0} , {Γ}_{k \vert k}^{ii , ( n + 1 )} = {\sum }_{j ∈ {u}_{i}^{1}} {w}_{ij} {Γ}_{k \vert k}^{jj , ( n )} ,$$

for some iterations over n.

Other embodiments implement the filter 1205 as a fused Kalman filter, wherein the weights are determined based on a relative uncertainty of the estimates,

$${w}_{ij} = \frac{Trace [ {( {Γ}_{k \vert k}^{( n ) , i} )}^{- 1} ]}{{\sum }_{j ∈ {u}_{i}} Trace [ {( {Γ}_{k \vert k}^{( n ) , j} )}^{- 1} ]} .$$

Yet other embodiments employ weighted Kalman filters to propagate the mean estimate, by fusing a set of weight matrices

$${\{ {W}_{ij} \}}_{i = 1 , j = 1}^{i = N , j = N}$$

subject to the constraints

$${W}_{ij} = 0 if j ∉ {U}_{i}^{1} , {\sum }_{j ∈ {u}_{i}^{1}} {W}_{ij} = I .$$

In some embodiments, the weights are used to fuse the estimates as a weighted combination of estimates, wherein the weights are optimizing the weighted posterior covariance of the estimation error.

In other embodiments, there are multiple vehicles transmitting their estimates of the state of the map various RSUs. The transmitted estimate includes include the first moment and the second moment of the probabilistic distribution of the state of the map. Such information sending can be beneficial when the remote server, e.g. located in the RSU or in the cloud, does not have additional sensing capabilities. In such cases, the remote server can use the information received from multiple vehicles to either merge such information and therefore improve the estimation of the state of each vehicle and transmit the first and second moment to the vehicles, or to directly transmit information to other vehicles in the vicinity of the RSU.

In some embodiments, the probabilistic system of a vehicle transmits its probabilistic distribution of the state of the map and receives the first and second moment of the state of the map from other vehicles in response to the transmission.

In some embodiments, the remote server 1200 forms an augmented state based on the state of the multiple vehicles information about the map. The augmented state is a union of states of map states from multiple vehicles. For example, the augmented state includes a state of the map from multiple vehicles, where a vehicle has measured a subset of such map.

Some embodiments are based on recognition that using remote servers in communication with vehicles necessitates using different clocks for different devices, and synchronization among such clocks is necessary.

The clock of the vehicle can be synchronized to the clock of the GNSS in communication with GNSS receiver of the vehicle. However, some embodiments are based on recognition that individual synchronization of the clock of the vehicle to a clock of the GNSS does not guarantee the synchronization of the vehicles in the vehicular communication networks due to different clock offsets errors that different vehicles might have. In addition, the GNSS synchronization can be negatively affected by multipath of the satellite signals in the urban environment.

Different standards provide protocols for mutual synchronization of the clocks. For example, IEEE has been developing precision time protocol (PTP) based synchronization standards. However, those protocols require information exchange between synchronizing devices, which in the context of versatile vehicular communication network can be impractical.

Some embodiments are based on realization that vehicular communication network has special requirements on participating vehicles. Unlike node in other networks, a vehicle in a vehicular communication network periodically announces its presence. For example, in IEEE Dedicated Short Range Communications (DSRC) for Wireless Access in Vehicular Environments (WAVE), a vehicle is required to transmit a heartbeat message every 100 ms to announce its presence to neighboring vehicles. The attributes of the heartbeat messages include one or combination of temporary ID, time, latitude, longitude, elevation, positional accuracy, speed and transmission, heading, acceleration, steering wheel angle, brake system status, and vehicle size.

Some embodiments are based on realization that this heartbeat message includes necessary synchronization data and therefore, can be used for synchronization. This approach reduces network traffic and mitigates the interference. With synchronization data transmitted automatically, vehicle can achieve silent synchronization without message exchange executed in conventional synchronization methods.

For example, some embodiments are based on realization that a clock of the vehicle can be synchronized to clocks of other vehicles based on trilateration of information received in multiple heartbeat messages under assumption that the clock offset of the vehicle and location of the vehicle are unknown. This is because the trilateration of the vehicle can be performed with two kinds of methods. One method uses distances that the light travels between the transmission and receipt time of the heartbeat message that is a function of the unknown clock offset. Another method uses distances between locations of the multiple vehicles and the time of transmitting the heartbeat messages and the unknown location of the vehicle at a particular time. By comparing these two kinds of distances it is possible to concurrently determine the unknown clock offset and unknown location of the vehicle at a particular time.

FIG. 12D illustrates a use case 1200d related to synchronization message exchange in IEEE Precision Time Protocol (PTP) based synchronization. Such a synchronization requires at least two message exchanges between a master 1200d1 and a slave 1200d2. The master 1200d1 first sends a Sync message to the slave 1200d2 at time T₁. The slave 1200d2 receives Sync message at time T₂. Even Sync message contains the timestamp T₁, for more precise synchronization, the master 1200d1 may send a Follow_Up message that contains the precise timestamp T₁ to the slave 1200d2. After processing Sync message and Follow_Up message received from the master 1200d1, the slave 1200d2 sends a Delay_Req message to master at time T₃. Once the master 1200d1 receives the Delay_Req message at time T₄, it sends back a Delay_Resp message that contains timestamp T₄ to the slave 1200d2. Using four timestamps T₁, T₂, T₃ and T₄, the slave 1200d2 computes message propagation time and clock offset, and therefore, synchronizes its clock to master's clock. For example, for symmetric link, the propagation time tₚ and clock offset tₒ can be computed as

$${t}_{p} = \frac{( {T}_{4} - {T}_{1} ) - ( {T}_{3} - {T}_{2} )}{2} \qquad ( 1 )$$

$$and$$

$${t}_{o} = \frac{( {T}_{2} - {T}_{1} ) + ( {T}_{3} - {T}_{4} )}{2} \qquad ( 2 )$$

In some embodiments, the parameters of probabilistic distribution of the state of the vehicle together with the GNSS measurements are transmitted to the remote server.

### Exemplar Embodiments

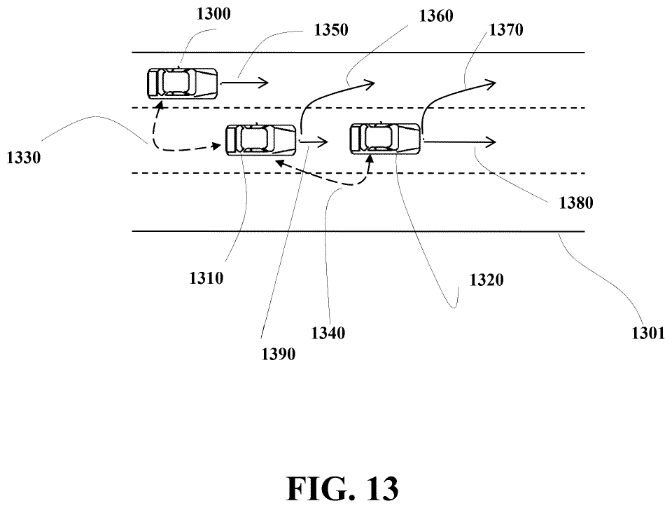

FIG. 13 shows an example of a vehicle-to-vehicle (V2V) communication and planning based on state estimation according to one embodiment. As used herein, each vehicle can be any type of moving transportation system, including a passenger car, a mobile robot, or a rover. For example, the vehicle can be an autonomous or semi-autonomous vehicle.

In this example, multiple vehicles—a vehicle 1300, a vehicle 1310, and a vehicle 1320, are moving on a given freeway 1301. Each vehicle can make many motions. For example, the vehicles can stay on the same path—such as a path 1350, a path 1390, a path 1380, or can change paths (or lanes) such a lane 1360, or a lane 1370. Each vehicle has its own sensing capabilities, e.g., Lidars, cameras, GNSS, etc. Each vehicle has the possibility to transmit and receive 1330, 1340 information with its neighboring vehicles and/or can exchange information indirectly through other vehicles via a remote server. For example, the vehicle 1300 and the vehicle 1320 can exchange information through the vehicle 1310. With this type of communication network, the information can be transmitted over a large portion of the freeway or highway 1301.

Some embodiments are configured to address the following scenario. For example, the vehicle 1320 wants to change its path and chooses option 1370 in its path planning. However, at the same time vehicle 1310 also chooses to change its lane and wants to follow option 1360. In this case, the two vehicles might collide, or at best the vehicle 1310 will have to execute an emergency brake to avoid colliding with the vehicle 1320. This is where the present disclosure can help. To that end, some embodiments enable the vehicles to transmit not only what the vehicles sense at the present time instant t, but also, additionally or alternatively, transmit what the vehicles are planning to do at time T+δₜ.

In the example of FIG. 13, the vehicle 1320 informs of its plan to change lane to the vehicle 1310 after planning and committing to execute its plan. Thus, the vehicle 1310 knows that in δₜ time interval the vehicle 1320 is planning to make a move to its left 1370. Accordingly, the vehicles 1310 can select the motion 1390 instead of 1360, i.e., staying on the same lane.

Additionally or alternatively, the motion of the vehicles can be jointly controlled by the remote server 1200 based on state estimations determined cooperatively. For example, in some embodiments, the multiple vehicles determined for joint state estimation are the vehicles that form and potentially can form a platoon of vehicles jointly controlled with shared control objective.

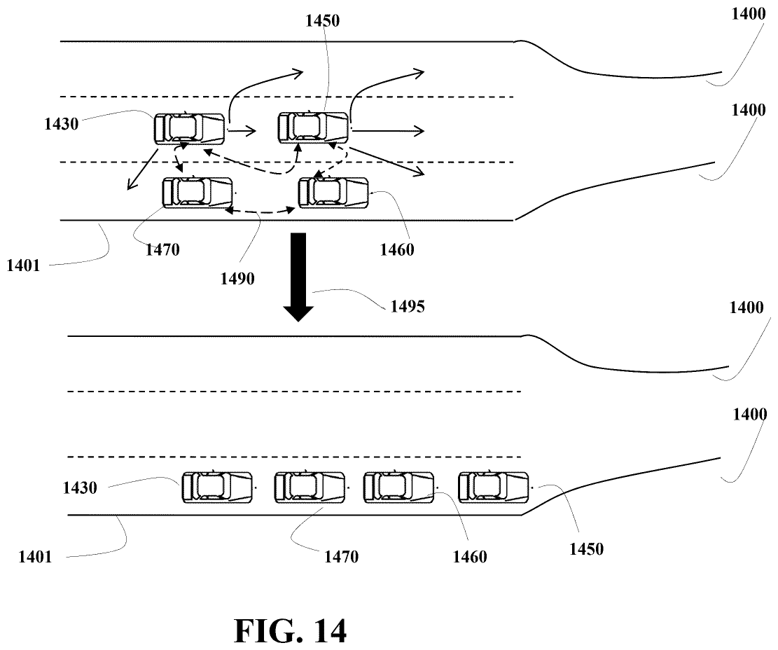

FIG. 14 is a schematic of a multi-vehicle platoon shaping for accident-avoidance scenario according to one embodiment. For example, consider a group of vehicles 1430, 1470, 1450, 1460, moving on a freeway 1401. Consider now that suddenly, there is a rerouting 1400 of the road ahead of the vehicle platoon. This rerouting renders the zone 1400 unsafe for the vehicles to move according to the nominal plan. The vehicles 1420, 1460 sense the problem for example with a camera, and communicate this information to the vehicles 1430, 1470. The platoon then executes a distributed optimization algorithm, e.g., formation keeping multi-agent algorithm, which selects the best shape of the platoon to maneuver according to the rerouting 1400 and to keep the vehicle flow uninterrupted. In this illustrative example, the best shape of the platoon is to align and form a line 1495, avoiding potential collisions because of the rerouting 1400.

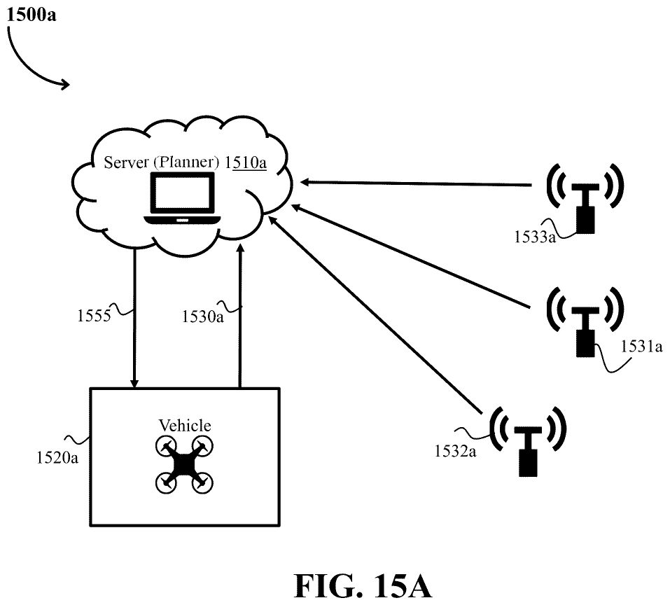

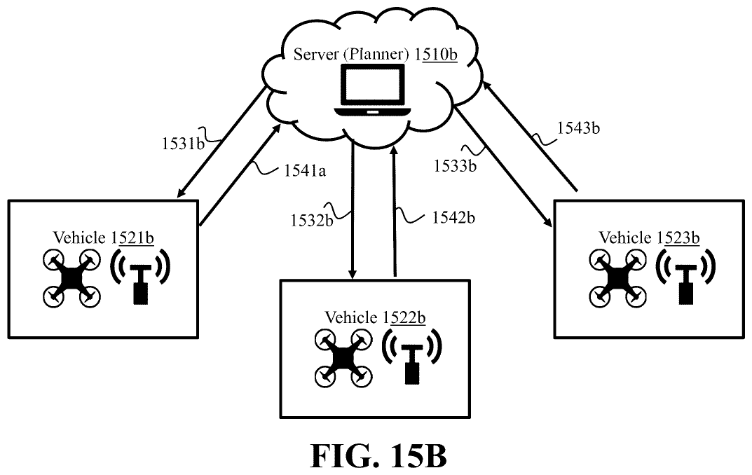

FIG. 15A illustrates an embodiment 1500a where an unmanned aerial vehicle (UAV) is controlled using the system 100 implemented on a server 1510a, according to some embodiments of the present disclosure. The server 1510a executes the steps of the methods FIG. 6A, FIG. 6B, FIG. 6C, FIG. 6D, FIG. 6E, FIG. 6F, FIG. 6G, FIG. 6H, and FIG. 7A described earlier. A vehicle 1520a equivalent to the vehicle 104 is a UAV, executes the operations performed by the system 100. The vehicle 1520a may transmit data 1530a of its own state and/or environmental data back to the server 1510a. In some embodiments, a motion plan 1555 based on joint tracking of the vehicle 1520a and a map state as generated by the system 100 is updated continuously as additional information is gathered on the disturbance and the environment. The information on the disturbance and the environment may be gathered by the vehicle 1520a itself, or by any third-party sensors 1531a, 1532a, 1533a. The sensors 1531a, 1532a, 1533a may be physical sensors, such as a LiDAR measuring wind speeds, or non-physical sensors, such as meteorological forecasts of the wind speeds or ocean currents, depending on the vehicle 1520a considered.

FIG. 15B illustrates another embodiment where the steps of the system 100 is implemented on a server 1510b, according to some embodiments of the present disclosure. The communication is the same as in FIG. 15A, i.e., motion plans 1531b, 1532b, and 1533b are transmitted to vehicles 1521b, 1522b, and 1523b, respectively. In contrast to the embodiment described in FIG. 15A, the vehicles 1521b, 1522b, and 1523b include sensory equipment (onboard sensors) whereby the disturbance can be measured. As such, communications 1541b, 1542b, and 1543b to the server 1510b include measurements on the disturbance. In this embodiment, there is no need for any additional external sensing, but some embodiments combine the external sensors 1531a, 1532a, 1533a with the onboard sensing. In other embodiments, the server 1510b is run physically on the vehicle as a component of its larger control system.

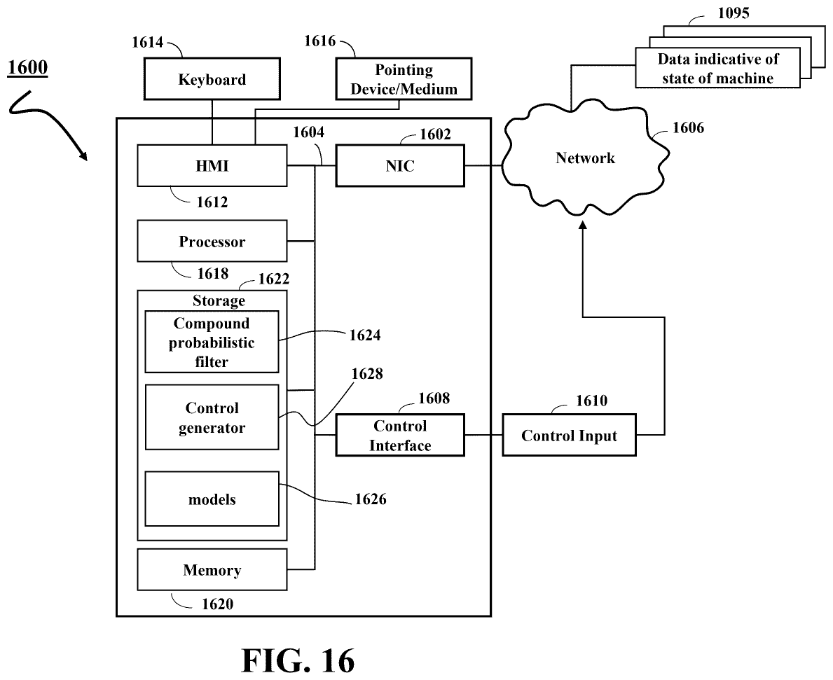

FIG. 16 shows a block diagram of a system 1600 for direct and indirect control of mixed-autonomy vehicles in accordance with some embodiments. The system 1600 can be arranged on a remote server as part of RSU to control the passing mixed-autonomy vehicles including autonomous, semiautonomous, and/or manually driven vehicles. The system 1600 can have a number of interfaces connecting the system 1600 with other machines and devices. A network interface controller (NIC) 1602 includes a receiver adapted to connect the system 1600 through the bus 1604 to a network 1606 connecting the system 1600 with the mixed-automata vehicles to receive a traffic state of a group of mixed-autonomy vehicles traveling in the same direction, wherein the group of mixed-autonomy vehicles includes controlled vehicles willing to participate in a platoon formation and at least one uncontrolled vehicle, and wherein the traffic state is indicative of a state of each vehicle in the group and the controlled vehicle. For example, in one embodiment the traffic state includes current headways, current speeds, and current acceleration of the mixed-automata vehicles. In some embodiments, the mixed-automata vehicles include all uncontrolled vehicles within a predetermined range from flanking controlled vehicles in the platoon.

The NIC 1602 also includes a transmitter adapted to transmit the control commands to the controlled vehicles via the network 1606. To that end, the system 1600 includes an output interface, e.g., a control interface 1608, configured to submit the control commands 1610 to the controlled vehicles in the group of mixed-autonomy vehicles through the network 1606. In such a manner, the system 1600 can be arranged on a remote server in direct or indirect wireless communication with the mixed-automata vehicles.

The system 1600 can also include other types of input and output interfaces. For example, the system 1600 can include a human machine interface 1612. The human machine interface 1612 can connect the controller to a keyboard 1614 and pointing device 1616, wherein the pointing device 1616 can include a mouse, trackball, touchpad, joystick, pointing stick, stylus, or touchscreen, among others.

The system 1600 includes a processor 1618 configured to execute stored instructions, as well as a memory 1620 that stores instructions that are executable by the processor. The processor 1618 can be a single core processor, a multi-core processor, a computing cluster, or any number of other configurations. The memory 1620 can include random access memory (RAM), read only memory (ROM), flash memory, or any other suitable memory machines. The processor 1618 can be connected through the bus 1604 to one or more input and output devices.

The processor 1618 is operatively connected to a memory storage 1622 storing the instruction as well as processing data used by the instructions. The storage 1622 can form a part of or be operatively connected to the memory 1620. For example, the memory can be configured to store a compound probabilistic filter 1624 including a plurality of probabilistic filters (equivalent to the compound probabilistic filter 405a) trained to track the augmented state of mixed-automata vehicles, transform the traffic state into target headways for the mixed-autonomy vehicles; and store a one or multiple models 1626 configured to explain the motion of the vehicles. For example, the models 1626 can include motion models, measurement models, traffic models, and the like.

The processor 1618 is configured to determine control commands for the controlled vehicles that indirectly control the uncontrolled vehicles as well. To that end, the processor is configured to execute a control generator 1628 to determine control commands based on the state of the vehicles. In some embodiments, the control generator 1628 uses a deep reinforcement learning (DRL) controller trained to generate control command from the augmented state for individual and/or a platoon of vehicles.

The description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine-readable medium. A processor(s) may perform the necessary tasks.

Various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Typically, the functionality of the program modules may be combined or distributed as desired in various embodiments.

Embodiments of the present disclosure may be embodied as a method, of which an example has been provided. The acts performed as part of the method may be ordered in any suitable way. Accordingly, embodiments may be constructed in which acts are performed in an order different than illustrated, which may include performing some acts concurrently, even though shown as sequential acts in illustrative embodiments.

Further, embodiments of the present disclosure and the functional operations described in this specification can be implemented in digital electronic circuitry, in tangibly embodied computer software or firmware, in computer hardware, including the structures disclosed in this specification and their structural equivalents, or in combinations of one or more of them. Further some embodiments of the present disclosure can be implemented as one or more computer programs, i.e., one or more modules of computer program instructions encoded on a tangible non transitory program carrier for execution by, or to control the operation of, data processing apparatus. Further still, program instructions can be encoded on an artificially generated propagated signal, e.g., a machine-generated electrical, optical, or electromagnetic signal, which is generated to encode information for transmission to suitable receiver apparatus for execution by a data processing apparatus. The computer storage medium can be a machine-readable storage device, a machine-readable storage substrate, a random or serial access memory device, or a combination of one or more of them.

According to embodiments of the present disclosure the term “data processing apparatus” can encompass all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code.

A computer program can be deployed to be executed on one computer or on multiple computers that are located at one site or distributed across multiple sites and interconnected by a communication network. Computers suitable for the execution of a computer program include, by way of example, can be based on general or special purpose microprocessors or both, and any other kind of central processing unit. Generally, a central processing unit will receive instructions and data from a read only memory or a random access memory or both. The essential elements of a computer are a central processing unit for performing or executing instructions and one or more memory devices for storing instructions and data.

Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Although the present disclosure has been described with reference to certain preferred embodiments, it is to be understood that various other adaptations and modifications can be made within the spirit and scope of the present disclosure. Therefore, it is the aspect of the append claims to cover all such variations and modifications as come within the true spirit and scope of the present disclosure.

Claimed is:

1. A system for joint localization of a vehicle moving in an environment and estimation of a map of the environment by fusing measurements of different sensors including measurements of a Global Navigation Satellite System (GNSS) indicative of a location of the vehicle with respect to GNSS satellites and measurements of a camera indicative of a location of the vehicle with respect to the map of the environment, comprising:
at least one processor; and
at least one memory having instructions stored thereon that, when executed by the at least one processor, causes the system to:
collect a sequence of measurements including the GNSS measurements and the camera measurements indicative of locations of the vehicle at different control steps;
execute iteratively, a plurality of probabilistic filters parameterized on a state of a location of the vehicle and a state of the map, wherein each of the probabilistic filters is configured to jointly track a current state of the location of the vehicle represented by coordinates of the vehicle and a current state of the map represented by coefficients of polynomial forming a spline representation of the map using a prediction model subject to prediction noise and a measurement model fusing the GNSS measurements subject to GNSS measurement noise and the camera measurements subject to camera measurement noise, wherein different probabilistic filters use different GNSS measurement noises, different camera measurement noises, or both;
determine the location of the vehicle based on a first weighted combination of the current states of the location tracked by the plurality of probabilistic filters; and
update the map of the environment based on a second weighted combination of the current states of the map tracked by the plurality of probabilistic filters, wherein weights of the first weighted combination differ from weights of the second weighted combination.

2. The system of claim 1, further comprising:
a controller configured to control the vehicle based on the determined location of the vehicle and the updated map of the environment.

3. The system of claim 1, further comprising:
a transmitter configured to transmit the updated map of the environment over at least one of a wired communication channel or a wireless communication channel.

4. The system of claim 1, wherein the plurality of probabilistic filters have identical measurement models except for the measurement noise distribution.

5. The system of claim 1, wherein the at least one processor, causes the system to:
execute a first probabilistic filter to predict a first current state of the vehicle and a state of the map based on an internal state of a first probabilistic filter of the plurality of probabilistic filters;
execute a second probabilistic filter to predict a second current state of the vehicle and the state of the map based on an internal state of the second probabilistic filter; and
update the internal state of the first probabilistic filter and the internal state of the second probabilistic filter based on a combination of the predicted first current state and predicted second current state.

6. The system of claim 1, wherein the at least one processor causes the system to:
receive map points representing the map;
determine spline segments corresponding to the received map points; and
determine spline parameters corresponding to the spline representation for the current state of the map based on the determined spline segments and solving of an optimization problem minimizing a measure of a total squared total variation error of a regressed map with respect to the map points.

7. The system of claim 6, wherein the spline parameters are subjected to a parametrization process for enforcing a spline continuity implicitly.

8. The system of claim 1, wherein each of the plurality of probabilistic filters is a nonlinear Kalman filter with the process noise and the measurement noise defined by corresponding Gaussian probabilistic distributions, such that a mean of the Gaussian probabilistic distributions is the estimation of a predicted current state transformed into a measurement space and different measurement noise covariances yield the Gaussian probabilistic distributions of the measurement noise.

9. The system of claim 8, wherein the estimation of the predicted current state transformed into the measurement space is common for the plurality of probabilistic filters.

10. The system of claim 8, wherein the estimation of the predicted current state transformed into the measurement space is different for different probabilistic filters of the plurality of probabilistic filters.

11. The system of claim 1, wherein the plurality of probabilistic filters form a compound probabilistic filter, the compound probabilistic filter configured to estimate likelihoods of correlation of different measurement noises based on values of gains of corresponding Kalman filters used for updating the predicted current state based on the current measurement.

12. The system of claim 11, wherein the gains are Kalman gains.

13. The system of claim 1, wherein the vehicle is an unmanned aerial vehicle (UAV).

14. A controller for controlling a movement of a vehicle based on joint localization of the vehicle moving in an environment and estimation of a map of the environment by fusing measurements of different sensors including measurements of a Global Navigation Satellite System (GNSS) indicative of a location of the vehicle with respect to GNSS satellites and measurements of a camera indicative of a location of the vehicle with respect to the map of the environment, the controller comprising:
at least one processor; and
at least one memory having instructions stored thereon that, when executed by the at least one processor, causes the controller to:
collect a sequence of measurements including the GNSS measurements and the camera measurements indicative of locations of the vehicle at different control steps;
execute a plurality of probabilistic filters parameterized on a state of a location of the vehicle and a state of the map, wherein each of the probabilistic filters is configured to jointly track a current state of the location of the vehicle represented by coordinates of the vehicle and a current state of the map represented by coefficients of polynomial forming a spline fitting representation of the map using a prediction model subject to prediction noise and a measurement model fusing the GNSS measurements subject to GNSS measurement noise and the camera measurements subject to camera measurement noise, wherein different probabilistic filters use different GNSS measurement noises, different camera measurement noises, or both;
determine the location of the vehicle based on a first weighted combination of the current states of the location tracked by the plurality of probabilistic filters; and
update the map of the environment based on a second weighted combination of the current states of the map tracked by the plurality of probabilistic filters, wherein weights of the first weighted combination differ from weights of the second weighted combination.

15. The controller of claim 14, wherein the at least processor is configured to control the vehicle based on the determined location of the vehicle and the updated map of the environment.

16. The controller of claim 14, further comprising:
a transmitter configured to transmit the updated map of the environment over at least one of a wired communication channel or a wireless communication channel.

17. The controller of claim 14, wherein each of the plurality of probabilistic filters is a nonlinear Kalman filter with the process noise and the measurement noise defined by corresponding Gaussian probabilistic distributions, such that a mean of the Gaussian probabilistic distributions is the estimation of a predicted current state transformed into a measurement space and different measurement noise covariances yield the Gaussian probabilistic distributions of the measurement noise.

18. A method for performing joint localization of a vehicle moving in an environment and estimation of a map of the environment by fusing measurements of different sensors including measurements of a Global Navigation Satellite System (GNSS) indicative of a location of the vehicle with respect to GNSS satellites and measurements of a camera indicative of a location of the vehicle with respect to the map of the environment, the method comprising:
collecting a sequence of measurements including the GNSS measurements and the camera measurements indicative of locations of the vehicle at different control steps;
executing a plurality of probabilistic filters parameterized on a state of a location of the vehicle and a state of the map, wherein each of the probabilistic filters is configured to jointly track a current state of the location of the vehicle represented by coordinates of the vehicle and a current state of the map represented by coefficients of polynomial forming a spline fitting representation of the map using a prediction model subject to prediction noise and a measurement model fusing the GNSS measurements subject to GNSS measurement noise and the camera measurements subject to camera measurement noise, wherein different probabilistic filters use different GNSS measurement noises, different camera measurement noises, or both;
determining the location of the vehicle based on a first weighted combination of the current states of the location tracked by the plurality of probabilistic filters; and
updating the map of the environment based on a second weighted combination of the current states of the map tracked by the plurality of probabilistic filters, wherein weights of the first weighted combination differ from weights of the second weighted combination.

19. The method of claim 18 further comprising:
executing a first probabilistic filter to predict a first current state of the vehicle and a state of the map based on an internal state of a first probabilistic filter of the plurality of probabilistic filters;
executing a second probabilistic filter to predict a second current state of the vehicle and the state of the map based on an internal state of the second probabilistic filter; and
updating the internal state of the first probabilistic filter and the internal state of the second probabilistic filter based on a combination of the predicted first current state and predicted second current state.

20. A non-transitory computer-readable storage medium embodied thereon a program executable by a processor for performing a method for joint localization of a vehicle moving in an environment and estimation of a map of the environment by fusing measurements of different sensors including measurements of a Global Navigation Satellite System (GNSS) indicative of a location of the vehicle with respect to GNSS satellites and measurements of a camera indicative of a location of the vehicle with respect to the map of the environment, the method comprising:
collecting a sequence of measurements including the GNSS measurements and the camera measurements indicative of locations of the vehicle at different control steps;
executing a plurality of probabilistic filters parameterized on a state of a location of the vehicle and a state of the map, wherein each of the probabilistic filters is configured to jointly track a current state of the location of the vehicle represented by coordinates of the vehicle and a current state of the map represented by coefficients of polynomial forming a spline fitting representation of the map using a prediction model subject to prediction noise and a measurement model fusing the GNSS measurements subject to GNSS measurement noise and the camera measurements subject to camera measurement noise, wherein different probabilistic filters use different GNSS measurement noises, different camera measurement noises, or both;
determining the location of the vehicle based on a first weighted combination of the current states of the location tracked by the plurality of probabilistic filters; and
updating the map of the environment based on a second weighted combination of the current states of the map tracked by the plurality of probabilistic filters, wherein weights of the first weighted combination differ from weights of the second weighted combination.
